(19) United States
(12) Patent Application Publication
(10) Pub. No.: US 2026/0169275 A1
(43) Pub. Date: Jun. 18, 2026

(54) SYSTEMS AND METHODS FOR FOCUS CORRECTION

(71) Applicant: Ultima Genomics, Inc., Fremont, CA (US)

(72) Inventors: Osip SCHWARTZ, Lafayette, CA (US); Rongwen LU, Fremont, CA (US); Gene POLOVY, Redwood City, CA (US); Amy E. FRANTZ, Cherry Hill, NJ (US); Michael FRIEDMANN, Mountain View, CA (US); Mark PRATT, Bozeman, MT (US); Gilad ALMOGY, Palo Alto, CA (US)

(21) Appl. No.: 19/400,960

(22) Filed: Nov. 25, 2025

Related U.S. Application Data
(63) Continuation of application No. PCT/US2024/031786, filed on May 30, 2024.
(60) Provisional application No. 63/469,771, filed on May 30, 2023.

(51) Int. Cl. G02B 21/00; G02B 7/38; H04N 23/55; H04N 23/56; H04N 23/67

(52) U.S. Cl. CPC G02B 21/006; G02B 7/38; G02B 21/0076; H04N 23/55; H04N 23/56; H04N 23/675

(57) ABSTRACT

Described herein are focus detection systems for use in sample scanning systems. A focus detection system may detect the position of a sample relative to an object plane of the system and determine what, if any, correction should be made. The focus detection system may detect height differences, tilt angle differences, or both between the sample and the object plane. Also described herein are methods of correcting focus errors in a scanning system to account for height differences, tilt angle differences, or both between the sample and the object plane. Focus corrections may be systematic focus corrections to correct for systematic focus errors that are time independent. Focus corrections may be dynamic focus corrections to correct for dynamic focus errors that vary with time or scanning position.

### CROSS-REFERENCE TO RELATED APPLICATIONS

This application is a Continuation of International Patent Application PCT/US2024/031786 filed 30 May 2024, which claims benefit of priority to U.S. Provisional Patent Application 63/469,771 filed 30 May 2023, each of which is incorporated herein by reference in its entirety.

### BACKGROUND

Biological sample processing has various applications in the fields of molecular biology and medicine (e.g., diagnosis). For example, nucleic acid (e.g., genome) sequencing may provide information that may be used to diagnose a certain condition in a subject and in some cases to determine a subject-specific treatment plan. Sequencing is widely used for molecular biology applications, including nucleic acid vector designs, gene therapy, vaccine design, industrial strain design, and diagnostic verification. Biological sample processing may involve a fluidics system and/or a detection system.

High performance detection systems used for optical inspection and genome sequencing are designed to maximize imaging throughput, signal-to-noise ratio (SNR), image resolution, and image contrast. In genome sequencing, specifically, high-resolution imaging beneficially enables higher densities of clonally-amplified nucleic acid molecules on a surface, which in turn may enable higher-throughput sequencing in terms of the number of bases called per sequencing reaction cycle.

In general, attempting to increase imaging throughput while simultaneously trying to improve the ability to resolve small image features at higher magnification reduces the number of photons available for imaging (e.g., by decreasing the practicable field of view). Although this problem may be addressed, for example, by integrating detection over longer periods of time to acquire an acceptable image (e.g., to acquire an image that has a sufficient signal-to-noise ratio to resolve the features of interest), this approach may have an adverse effect on image data acquisition rates and imaging throughput. Thus, there is a need in the field for improved imaging systems and in particular such systems suitable for genome sequencing.

Furthermore, collection of acceptable images depends on the ability to maintain focus while imaging. Thus, there is a need for systems and methods for detecting and correcting focus errors in imaging systems.

### SUMMARY

Various aspects of the present disclosure provide optical systems and methods for improving or maintaining focus while imaging. The optical systems and methods may be implemented for surface scanning to maintain focus while scanning a surface.

In an aspect, the disclosure provides an optical system for scanning a surface, the optical system comprising: an objective lens in optical communication with the surface a focus illumination source positioned to emit a focus light along a focus light path through the objective lens to a focus region on the surface; the surface positioned to reflect the focus light as a reflected light along a reflected light path through the objective lens; and a focus detector in optical communication with a region of the surface, wherein the focus detector is positioned in the reflected light path to receive the reflected light; wherein the optical system is configured to rotate the surface about a rotational axis normal to the surface such that the region in optical communication with the focus detector moves across the surface while the surface is rotating; wherein the focus detector is configured to determine a z-distance of the surface at the region relative to an object plane of the optical system, a tilt angle of the surface at the region relative to the object plane, or both the z-distance and the tilt angle using the focus detector; and wherein the optical system is configured to generate a map of the surface comprising z-distance variations, tilt angle variations, or both.

In some embodiments, the focus detector is positioned i) in an infinite conjugate plane of the optical system for determining the tilt angle of the surface, and ii) in a conjugate plane for determining the z-distance of the surface. In some embodiments, the focus detector is positioned such that the location at which the reflected light encounters the focus detector is displaced by at least 1.5 μm per 100 μRad change in the tilt angle, at least 2 μm per 100 μRad change in the tilt angle, or at least 2.5 μm per 100 μRad change in the tilt angle.

In some embodiments, a location at which the reflected light encounters the focus detector is a function of the tilt angle of the surface relative to an object plane of the optical system. In some embodiments, the focus detector comprises a wavefront error detector, a camera, a photodiode, or a combination thereof.

In some embodiments, the optical system is configured to adjust the object plane to coincide with the z-distance of the surface at a corresponding region of the surface, the tilt angle of the surface at the corresponding region of the surface, or both as the corresponding region is being imaged. In some embodiments, the surface is configured to move to correct for the z-distance, the tilt angle, or both. In some embodiments, a location at which the reflected light encounters the focus detector is a function of the tilt angle of the surface relative to an object plane of the optical system.

In some embodiments, the optical system further comprises an imaging detector in optical communication with the surface along an imaging light path, wherein the imaging detector is positioned at a plane conjugate to the object plane. In some embodiments, the imaging detector is configured to move relative to the imaging light path to correct for the z-distance, the tilt angle, or both.

In some embodiments, the optical system further comprises a mirror positioned in the imaging light path, wherein the mirror is configured to move relative to the imaging light path to correct for the z-distance, the tilt angle, or both.

In some embodiments, the optical system further comprises focus optics positioned to direct the reflected light from the surface to the focus detector. In some embodiments, the focus optics comprise a mirror, a beam splitter, a prism, or combinations thereof.

In some embodiments, the optical system further comprises: a focus beam splitter, wherein the focus beam splitter is positioned in the reflected light path between the objective lens and the focus detector, and wherein the focus beam splitter is positioned to split the reflected light into the reflected light path directed to the focus detector and a split reflected light path directed to a second focus detector; a focus lens positioned in the split reflected light path between the focus beam splitter and the second focus detector; and the second focus detector positioned in the split reflected light path at a focal plane of the focus lens. In some embodiments, a position at which the split reflected light path encounters the second focus detector is a function of a z-distance between the surface and the object plane at the region of the surface illuminated by the focus light.

In some embodiments, the optical system further comprises: a second focus illumination source positioned to illuminate a second focus region of the surface with a second focus light, or an illumination beam splitter positioned to split the focus light into a first focus light and a second focus light; wherein the first focus light illuminates a region of the surface, and wherein the second focus light follows a second focus light path through the objective lens and illuminates a second region of the surface; the surface positioned to reflect the second focus light as a second reflected light along a second reflected light path through the objective lens; the surface positioned to reflect the focus light as a reflected light along a reflected light path through the objective lens and reflect the second focus light as a second reflected light along a second reflected light path through the objective lens; and the focus detector positioned in the second reflected light path to receive the second reflected light, wherein the focus detector is positioned at a focal plane of the focus lens; wherein: a first location at which the reflected light encounters the focus detector is a function of a first z-distance from the focus region to an object plane of the optical system; a second location at which the second reflected light encounters the focus detector is a function of a second z-distance from the second focus region to the object plane; and a distance between the first location and the second location is a function of the tilt angle.

In some embodiments, the illumination beam splitter is a polarizing beam splitter. In some embodiments, the polarizing beam splitter is a polarizing beam splitter cube, a Wollaston prism, or a birefringent wedge. In some embodiments, the illumination beam splitter is a non-polarizing beam splitter, a prism, a diffraction grating, or an electro-optical element.

In some embodiments, the focus light path and the second focus light path are angled relative to one another.

In some embodiments, the optical system further comprises: a focus lens positioned in the reflected light path and the second reflected light path between the objective lens and a focus detector; the focus detector positioned at a focal plane of the focus lens, wherein the focus detector is a quadrant detector comprising a first quadrant, a second quadrant, a third quadrant, and a fourth quadrant; and a cylindrical optical element positioned in the focus light path between the objective lens and the focus illumination source or in the reflected light path between the objective lens and the focus lens; wherein relative intensities of the reflected light detected by the first quadrant, the second quadrant, the third quadrant, and the fourth quadrant are functions of a z-distance between the surface and an object plane of the optical system at the focus region.

In some embodiments, the optical system further comprises a rotational stage positioned to support the surface and rotate the surface about a rotational axis normal to the surface.

In some embodiments, the optical system further comprises an excitation light source positioned to illuminate the surface with excitation light.

In some embodiments, the optical system further comprises an imaging detector positioned at a conjugate object plane of the optical system, wherein the imaging detector is configured to image the surface by collecting imaging light following an imaging light path from the surface, through the objective lens, to the imaging detector. In some embodiments, the imaging detector is positioned to image the surface while the surface is rotating. In some embodiments, the imaging detector is configured to move relative to the imaging light path to correct for a focus variation detected by the focus detector. In some embodiments, the focus variation is the tilt angle, the z-distance, or both.

In some embodiments, the optical system further comprises a mirror positioned in the imaging light path. In some embodiments, the mirror is configured to move relative to the imaging light path to correct for a focus variation detected by the focus detector.

In another aspect, the disclosure provides a method of detecting a tilt angle of a surface, the method comprising: providing an optical system comprising: an objective lens, a focus illumination source, and a focus detector positioned in an infinite conjugate plane of the optical system; positioning the surface in the optical system in a focus light path; illuminating a focus region of the surface with a focus light emitted by the focus illumination source along the focus light path through the objective lens to the focus region; producing a reflected light by reflecting the focus light off of the focus region of the surface (e.g., reflected at the focus region of the surface or reflected by the focus region of the surface) along a reflected light path through the objective lens to the focus detector; detecting the reflected light with the focus detector; determining a position of the reflected light on the focus detector, wherein the position is a function of the tilt angle of the surface relative to an object plane of the optical system; and determining the tilt angle of the surface relative to an object plane of the optical system based on the position of the reflected light on the focus detector.

In some embodiments, the method further comprises displacing the reflected light on the focus detector by at least 1.5 μm per 100 μRad change in the tilt angle, at least 2 μm per 100 μRad change in the tilt angle, or at least 2.5 μm per 100 μRad change in the tilt angle.

In some embodiments, the optical system further comprises: a focus beam splitter; a focus lens; and a second focus detector positioned at a focal plane of the focus lens; wherein the method further comprises: splitting the reflected light with the focus beam splitter into the reflected light and a split reflected light, wherein the split reflected light is directed along split reflected light path through the focus lens; detecting the split reflected light with the second focus detector; and determining a z-distance of the surface relative to the object plane based on the position of the split reflected light on the second focus detector.

In some embodiments, the position of the split reflected light on the focus detector moves in response to a change in the z-distance of the surface relative to the object plane. In some embodiments, the position of the reflected light on the focus detector moves in response to a change in the tilt angle of the surface relative to the object plane.

In another aspect, the disclosure provides a method of detecting tilt angle of a surface, the method comprising: providing an optical system comprising: an objective lens, a focus illumination source, a focus lens, and a focus detector positioned at a focal plane of the focus lens; positioning the surface in the optical system in a focus light path and a second focus light path; illuminating a focus region of the surface with a focus light emitted by the focus illumination source along the focus light path through the objective lens to the focus region; producing a reflected light by reflecting the focus light off of the focus region of the surface along a reflected light path through the objective lens to the focus detector; detecting the reflected light with the focus detector; determining a first position of the reflected light on the focus detector, wherein the first position is a function of a first z-distance of the surface at the focus region relative to an object plane of the optical system; illuminating a second focus region of the surface with a second focus light along the second focus light path through the objective lens to the second focus region; producing a second reflected light by reflecting the second focus light off of the second focus region (e.g., reflected at the second focus region of the surface or reflected by the second focus region of the surface) of the surface along a reflected light path through the objective lens to the focus detector; detecting the second reflected light with the focus detector; determining a second position of the second reflected light on the focus detector, wherein the second position is a function of a second z-distance of the surface at the second focus region relative to the object plane; and determining the tilt angle of the surface relative to the object plane based on the first position and the second position.

In some embodiments, the second focus light is emitted by a second focus illumination source, or the second focus light is split from the focus light by an illumination beam splitter.

In some embodiments, the method further comprises correcting the tilt angle by adjusting the object plane to coincide with the tilt angle of the surface.

In another aspect, the disclosure provides a method of detecting z-position of a surface, the method comprising: providing an optical system comprising: an objective lens, a focus illumination source, a cylindrical optical element, a focus lens, and a focus detector positioned at a focal plane of the focus lens, wherein the focus detector is a quadrant detector comprising a first quadrant, a second quadrant, a third quadrant, and a fourth quadrant; positioning the surface in the optical system in a focus light path; illuminating a focus region of the surface with a focus light emitted by the focus illumination source along the focus light path through the objective lens to the focus region; producing a reflected light by reflecting the focus light off of the focus region of the surface along a reflected light path through the objective lens to the focus detector; introducing an astigmatism to the focus light or the reflected with the cylindrical optical element; detecting the reflected light with the focus detector; and determining relative intensities of the reflected light on the first quadrant, the second quadrant, the third quadrant, and the fourth quadrant, wherein the relative intensities are a function of a z-distance of the surface relative to an object plane of the optical system.

In some embodiments, relative intensities of the reflected light detected by the first quadrant, the second quadrant, the third quadrant, and the fourth quadrant change in response to a change in a z-distance of the surface relative to an object plane of the optical system.

In some embodiments, the method further comprises correcting the z-distance, the first z-distance, or the second z-distance by adjusting the object plane to coincide with the z-distance, the first z-distance, or the second z-distance of the surface.

In another aspect, the disclosure provides a method of focusing a scanning system on a surface, the method comprising: providing a surface to the scanning system; determining a z-distance of the surface at a region of the surface relative to an object plane of the scanning system, a tilt angle of the surface at the region relative to the object plane, or both the z-distance and the tilt angle; and adjusting the object plane to coincide with the z-distance of the surface from the object plane, the tilt angle of the surface, or both the z-distance and the tilt angle by moving an element positioned an imaging path from the surface to an imaging detector of the scanning system.

In some embodiments, the element is the imaging detector, the surface, a mirror, or a combination thereof.

In some embodiments, the method further comprises bending the element to adjust the object plane to coincide with the z-distance of the surface, the tilt angle of the surface, or both. In some embodiments, the element is a lens or a wedge or comprises an index of refraction gradient.

In some embodiments, the lens is an objective lens.

In some embodiments, the method further comprises moving the element along the imaging path to adjust the object plane to coincide with the z-distance of the surface; tilting the element relative to the imaging path to adjust the object plane to coincide with the tilt angle of the surface; rotating the element relative to the imaging path to adjust the object plane to coincide with the z-distance of the surface, the tilt angle of the surface, or both; translating the element relative to the imaging path to adjust the object plane to coincide with the z-distance of the surface, the tilt angle of the surface, or both; or a combination thereof.

In some embodiments, the method further comprises generating a map of the surface; wherein generating the map comprises determining variations in the z-distance across the surface, variations in the tilt angle across the surface, or both; and where the map comprises z-distance values across the surface, tilt angle values across the surface, or both z-distance values and tilt angle values.

In some embodiments, determining the z-distance, the tilt angle, or both comprises illuminating the region with a focus light emitted from a focus illumination source; wherein, determining the z-distance, the tilt angle, or both further comprises reflecting the focus light off the surface as a reflected light along a reflected light path to a focus detector.

In some embodiments, determining the z-distance, the tilt angle, or both further comprises determining a position of the reflected light on the focus detector, an intensity of the reflected light on the focus detector, or a shape of the reflected light on the focus detector, or a combination thereof, wherein the position, the intensity, the shape, or the combination thereof is a function of the z-distance, the tilt angle, or both.

In some embodiments, the method further comprises imaging the surface with the imaging detector by detecting an imaging light directed from the surface along the imaging path, wherein the imaging further comprises illuminating the region of the surface with an excitation light emitted by an excitation light source. In some embodiments, the imaging light comprises fluorescence emission stimulated by the excitation light.

In some embodiments, the surface is rotating during the imaging.

In another aspect, the disclosure provides a method of scanning a surface, the method comprising: providing a scanning system comprising: an objective lens, an imaging detector, and a focus detector in optical communication with a region of the surface; positioning the surface in the scanning system; rotating the surface about a rotational axis normal to the surface such that the region in optical communication with the focus detector moves across the surface while the surface is rotating; determining a z-distance of the surface at the region relative to an object plane of the scanning system, a tilt angle of the surface at the region relative to the object plane, or both the z-distance and the tilt angle using the focus detector; correlating the z-distance, the tilt angle, or both to a region on the surface; generating a map of z-distance variations, tilt angle variations, or both, corresponding to regions across the surface; and imaging the surface with the imaging detector while the surface is rotating, thereby scanning the surface. In some embodiments, the scanning system comprises the optical system as described elsewhere herein. In some embodiments, the focus detector is a wavefront error detector.

In some embodiments, the method further comprises dynamically adjusting the object plane to coincide with the z-distance of the surface at a corresponding region of the surface, the tilt angle of the surface at the corresponding region of the surface, or both as the corresponding region is being imaged. In some embodiments, dynamically adjusting the object plane comprises moving an element positioned an imaging path from the surface to an imaging detector. In some embodiments, the element is the imaging detector, the surface, a mirror, or any combination thereof. In some embodiments, the method further comprises bending the element to adjust the object plane to coincide with the z-distance of the surface, the tilt angle of the surface, or both.

In some embodiments, the element is a lens, a wedge, or comprises an index of refraction gradient, or a combination thereof. In some embodiments, the method further comprises moving the element along the imaging path to adjust the object plane to coincide with the z-distance of the surface; tilting the element relative to the imaging path to adjust the object plane to coincide with the tilt angle of the surface; rotating the element relative to the imaging path to adjust the object plane to coincide with the z-distance of the surface, the tilt angle of the surface, or both; translating the element relative to the imaging path to adjust the object plane to coincide with the z-distance of the surface, the tilt angle of the surface, or both; or a combination thereof.

In another aspect the disclosure provides a scanning system for scanning a surface, the scanning system comprising: a rotational stage positioned to hold the surface and rotate the surface about a rotational axis normal to the surface; an objective lens positioned to magnify the surface; an imaging detector positioned to image the surface through the objective lens; and imaging optics positioned to direct imaging light along an imaging path from the surface to the imaging detector, wherein the imaging optics comprise an element positioned to distort a wavefront comprising the imaging light.

In some embodiments, the element bends the wavefront, changes a focus of the imaging light, or a combination thereof. In some embodiments, the focus is changed non-uniformly across the wavefront. In some embodiments, a shape of the wavefront after the element matches a shape of the imaging detector.

In some embodiments, the element comprises a bent mirror, a gradient index window, a microlens array, a field flattener, or a combination thereof. In some embodiments, the microlens array comprises a plurality of lenses. In some embodiments, at least two lenses of the plurality of lenses have different focal lengths, or the plurality of lenses has the same focal length.

In another aspect the disclosure provides a method of imaging a surface, the method comprising: providing a scanning system comprising: an objective lens, and an imaging detector, wherein the imaging detector is a line-scan detector comprising a first row of pixels and a second row of pixels; positioning the surface on the scanning system in an imaging light path from the surface to the imaging detector; imaging an elongated region of the surface through the objective lens with the imaging detector, wherein the elongated region comprises a first region positioned at a first radius relative to a rotational axis normal to the surface and a second region positioned at a second radius relative to the rotational axis; rotating the surface about the rotational axis such that the elongated region moves across the surface while the surface is rotating, the first region moves at a first linear velocity relative to the surface, and the second region moves at a second linear velocity relative to the surface; matching a first trigger rate of the first row of pixels to the first linear velocity; matching a second trigger rate of the second row of pixels to the second linear velocity; detecting the first region with the first row of pixels; and detecting the second region with the second row of pixels, thereby imaging the elongated region with the imaging detector.

In some embodiments, the first trigger rate and the second trigger rate are different. In some embodiments, the first radius is longer than the second radius, wherein the first linear velocity is faster than the second linear velocity, and wherein the first trigger rate is faster than the second trigger rate.

In some embodiments, the surface is rotating at a rate of not less than 0.5 revolutions per second and not more than 100 revolutions per second. In some embodiments, the method further comprises reducing a motion blur on the imaging detector.

In another aspect, the disclosure provides a method for focus tracking, comprising: (a) providing a surface, wherein the surface is configured to rotate with respect to an objective lens, and wherein the surface is substantially planar; (b) providing a light beam through the objective lens to illuminate a region of the surface; during rotation of the surface, (c) directing light reflected from the region of the surface to (i) a detector through a lens and (ii) an incident location on a sensor, wherein the reflected light is directed to the sensor in the absence of traveling through the lens; and (d) determining, from the incident location of the reflected light on the sensor, an amount of tilt of the planar surface with respect to the objective lens. In some embodiments, the light beam is emitted from a light source. In some embodiments, the light beam enters the objective lens at an angle parallel to an axis of the objective lens.

In some embodiments, the providing (b) further comprises splitting the light beam into a first light beam and a second light beam, wherein the first light beam illuminates a first region of the surface and the second light beam illuminates a second region of the surface, wherein the first and second regions do not overlap. In some embodiments, the first light beam enters the objective lens at an angle that is rotated X degrees from an axis of the objective lens, wherein X is greater than 0; and the second light beam enters the objective lens at an angle that is rotated Y degrees from an axis of the objective lens, wherein Y is less than 0. In some embodiments, the absolute value of X is the same as the absolute value of Y.

In some embodiments, the directing (c) further comprises directing light reflected from the first region of the surface and light reflected from the second region of the surface to a first incident location and a second incident location, respectively, on the sensor. In some embodiments, the determining (d) further comprises determining an amount of tilt of the surface from the difference between the first incident location and the second incident location.

In another aspect, the disclosure provides a method of surface scanning, comprising: providing a surface, wherein the surface is configured to rotate with respect to an objective lens, and wherein the surface is substantially planar; while rotating the surface, providing a light beam through the objective lens to illuminate the surface, wherein at a first time point the light beam illuminates a first region of the surface and at a second time point the light beam illuminates a second region of the surface; and determining, for each of the first and second time points, i) a respective z-distance of the respective region relative to a focal plane of the objective lens and ii) a respective tilt angle of the respective region relative to the focal plane.

In some embodiments, the determining (c) comprises comparing characteristics of light reflected from the respective region of the surface to reference characteristics. In some embodiments, the method further comprises: (d) repeating the rotating (b) and determining (c) for a plurality of time points. In some embodiments, the method further comprises providing a map of z-distances and tilt angles for the surface.

Another aspect of the present disclosure provides a system comprising one or more computer processors and computer memory coupled thereto. The computer memory comprises machine executable code that, upon execution by the one or more computer processors, implements any of the methods above or elsewhere herein. Another aspect of the present disclosure provides a non-transitory computer readable medium comprising machine executable code that, upon execution by one or more computer processors, implements any of the methods above or elsewhere herein.

Additional aspects and advantages of the present disclosure will become readily apparent to those skilled in this art from the following detailed description, wherein only illustrative instances of the present disclosure are shown and described. As will be realized, the present disclosure is capable of other and different instances, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein) of which:

FIG. 1 provides a non-limiting example of an imaging setup.

FIG. 2 provides a non-limiting schematic of a Confocal Structured Illumination (CoSI) imaging setup.

FIG. 3A and FIG. 3B illustrate multiplexed stations in a sequencing system.

FIG. 4A illustrates a block diagram of an exemplary electronic device.

FIG. 4B provides a non-limiting example of a memory architecture.

FIG. 5 illustrates an example workflow for processing a sample for sequencing.

FIG. 6 provides a non-limiting schematic of a rotating substrate and a calculation of the differences in magnification required to compensate for relative motion between the substrate and an optical detection system.

FIG. 7 shows a non-limiting schematic of a CoSI system.

FIG. 8 illustrates a non-limiting comparison of the resolution achievable by CoSI (upper panels) and wide field (lower panels) imaging.

FIG. 9A shows example resolution achieved by CoSI (top plots) and wide field (lower plots) imaging.

FIG. 9B illustrates example images obtained by CoSI (upper panels) and wide field (lower panels) imaging.

FIG. 10 provides a non-limiting schematic of a system with and without field curvature.

FIG. 11A provides a non-limiting schematic of a microlens array with varying focal lengths and its effect on a light wavefront to minimize the effects of field curvature.

FIG. 11B provides a non-limiting schematic of a microlens array combined with a traditional field flattener.

FIG. 12A provides a non-limiting schematic of a bent mirror interacting with a wavefront.

FIG. 12B provides a non-limiting schematic of a gradient index window.

FIG. 13A provides a non-limiting schematic of a focus detection system.

FIG. 13B provides a non-limiting schematic of a focus and tilt detection system.

FIG. 13C provides a non-limiting schematic of a tilt detection system.

FIG. 14 provides a non-limiting schematic of a focus and tilt detection system.

FIG. 15 illustrates an example workflow for mapping focus variations on a surface.

FIG. 16 illustrates an example workflow for correcting focus variations on a surface.

FIG. 17 provides a non-limiting schematic of an imaging system.

FIG. 18A provides a non-limiting schematic of a multi-clocking detector.

FIG. 18B provides a non-limiting schematic of a multi-clocking detector.

FIG. 18C provides a non-limiting schematic of a multi-clocking detector.

FIG. 19 illustrates an example workflow for multi-clocking a detector.

FIG. 20A provides a non-limiting schematic of a focus detection system.

FIG. 20B provides a non-limiting schematic of a focus detection system.

FIG. 21A provides a non-limiting schematic of a focus detection system.

FIG. 21B provides a non-limiting schematic of a focus detection system.

FIG. 22A provides a non-limiting schematic of a focus detection system.

FIG. 22B provides a non-limiting schematic of a focus detection system.

FIG. 23 shows a plot of an exemplary functional relationship between a defocus distance and an intensity ratio (F).

FIG. 24 shows an example of a substrate height map.

FIG. 25 shows a plot of focus position as a function of substrate revolutions (top) and a plot of focus error as a function of substrate revolutions (bottom) at a rotational frequency of 0.5 revolutions per second.

FIG. 26 shows a plot of radial position as a function of time (top), a plot of focus position as a function of time (middle), and a plot of focus error as a function of time (bottom) at a rotational frequency of 0.5 revolutions per second.

FIG. 27 provides a non-limiting schematic of an imaging light path with a wavefront.

FIG. 28 provides a non-limiting schematic of wedge and its effect on a wavefront.

FIG. 29A shows a plot of wedge angle to correct a tilted wavefront as a function of substrate tilt angle.

FIG. 29B shows a plot of rotation of a 2° wedge about the optical axis needed to correct the tilted wavefront as a function of substrate tilt angle.

FIG. 29C shows a plot of image shift as a function of substrate tilt angle for two edges of an image and the difference between the two edges.

FIG. 29D shows a plot of root mean square (RMS) wavefront error as a function of position across a field of view for substrate tilts of 100 μRad, 200 μRad, 300 μRad, 400 μRad, 500 μRad, and 600 μRad after compensation with the wedge.

FIG. 30 provides a non-limiting schematic of a focus control system.

FIG. 31 shows a plot of beam displacement with substrate tilt as a function of semi-diameter objective beam entrance.

FIG. 32A provides a non-limiting schematic of a scanning system.

FIG. 32B provides a non-limiting schematic of a scanning system.

FIG. 33 provides a non-limiting schematic of a focus detection system.

FIG. 34A provides a non-limiting schematic of a focus detection system.

FIG. 34B provides a non-limiting schematic of a focus detection system.

### DETAILED DESCRIPTION

Described herein are systems and methods for detecting and correcting an image of a surface (e.g., a substrate supporting a sample, a planar sample, or a wafer supporting a sample). The image of a surface may be corrected if the mapped image is in an incorrect location relative to a sensor. The image of a surface may be corrected if the mapped image of the surface is axially displaced or tilted relative to the sensor. The image of a surface may be corrected if the mapped image of the surface is mapped to a curved surface. The image of a surface may be corrected by correcting the focus, correcting the tilt angle, or correcting the field curvature. A scanning system may be configured to measure optical signals (e.g., light) from a sample while the sample is moving relative to the system. As the sample moves, the system may sequentially collect data from different regions of the sample, thereby scanning the sample. The light may be focused onto a detector, which measures the signals from the sample. However, irregularities or movement within the system or errors from external sources (e.g., vibrational noise) may cause the detector to be out-of-focus relative to the sample. The systems and methods described herein may be used to detect a position (e.g., a height, tilt angle, or both) of a sample, determine a displacement of the sample relative to a plane of the system (e.g., an image plane of a detector or an object plane of an objective), and correct the focus. Alternatively or in addition, the systems and methods of the present disclosure may be used to correct field curvature. Identifying and correcting focus errors or field curvature may improve signal detection quality.

### Scanning Systems

A focus system or method of the present disclosure may be incorporated into a scanning system, such as an open substrate processing system. The scanning system may be configured to scan a sample coated onto a substrate, also referred to herein as a “wafer”, a “substrate”, a “planar sample”, or a “planar surface”. The substrate may be an open substrate coated with an analyte (e.g., biological analyte) and a fluid that is exposed to the environment. In some embodiments, the substrate may comprise an array (e.g., a planar array) of individually addressable locations. Each location, or a subset of such locations, may have immobilized thereto an analyte (e.g., a nucleic acid molecule, a protein molecule, a carbohydrate molecule, etc.). For example, an analyte may be immobilized to an individually addressable location via a support, such as a bead. A plurality of analytes immobilized to the substrate may be copies of a template analyte. For example, the plurality of analytes may have sequence homology. In other instances, the plurality of analytes immobilized to the substrate may be different. The plurality of analytes may be of the same type of analyte (e.g., a nucleic acid molecule) or may be a combination of different types of analytes (e.g., nucleic acid molecules, protein molecules, etc.).

Described herein are devices, systems, and methods that use open substrates or open flow cell geometries to process a sample. The term “open substrate,” as used herein, generally refers to a substrate in which any point on an active surface of the substrate is physically accessible from a direction normal to the substrate. A sample processing system may comprise a substrate, and devices and systems that perform one or more operations with or on the substrate. The sample processing system may permit highly efficient dispensing of analytes and reagents onto the substrate. The sample processing system may permit highly efficient imaging of one or more analytes, or signals corresponding thereto, on the substrate. Substrates, detectors, and sample processing hardware that can be used in the sample processing system are described in further detail in U.S. Pat. Pub. Nos. 2020/0326327A1, 2021/0079464A1, and 2021/0354126A1, and International Pat. Pub. No. WO2022/072652A1, each of which is entirely incorporated herein by reference.

### Substrates

An open substrate may be a solid substrate. The substrate may entirely or partially comprise one or more materials (e.g., rubber, glass, silicon, metal, ceramic, plastic, etc.). The substrate may be entirely or partially coated with one or more layers of a metal, an oxide, a photoresist, a surface coating such as an aminosilane or hydrogel, polyacrylic acid, polyacrylamide dextran, polyethylene glycol (PEG), or any combination of any of the preceding materials, or any other appropriate coating. The substrate may comprise multiple layers of the same or different type of material. The substrate may be fully or partially opaque to visible light. A surface of the substrate may be modified to comprise active chemical groups, such as amines, esters, hydroxyls, epoxides, and the like, or a combination thereof, or these may be added as an additional layer or coating to the substrate. The substrate may have the general form of a cylinder, a cylindrical shell or disk, a rectangular prism, or any other geometric form.

The substrate may comprise a planar or substantially planar surface. The surface may be textured or patterned, where the texture or pattern may be regular or irregular. For example, the substrate may comprise grooves, troughs, hills, pillars, wells, cavities (e.g., micro-scale cavities or nano-scale cavities), and/or channels. The substrate may have regular or irregular geometric structures (e.g., wedges, cuboids, cylinders, spheroids, hemispheres, etc.) above or below a reference level of the surface. In some instances, the textures and/or patterns of the substrate may define at least part of an individually addressable location on the substrate.

The substrate may comprise a plurality of individually addressable locations. The locations on the one or more surfaces of the substrate are physically accessible for processing (e.g., placement, extraction, reagent dispensing, seeding, heating, cooling, or agitation). The locations may be digitally accessible (e.g., locations may be located, identified, and/or accessed electronically or digitally for indexing, mapping, sensing, associating with a device (e.g., detector, processor, dispenser, etc.)). In some cases, the locations may be defined by physical features of the substrate (e.g., on a modified surface) to distinguish from each other and from non-individually addressable locations. In some cases, the locations may be defined digitally (e.g., by indexing) and/or via the analytes and/or reagents that are loaded on the substrate (e.g., the locations at which analytes are immobilized on the substrate). Each of the plurality of individually addressable locations, or each of a subset of the locations, may be capable of immobilizing thereto an analyte (e.g., a nucleic acid, a protein, a carbohydrate, etc. from a biological sample) or a reagent (e.g., a nucleic acid, a probe molecule, a barcode molecule, an antibody molecule, a primer molecule, a bead, etc.) directly or indirectly (e.g., via a support, such as a bead).

The substrate may have any number of individually addressable locations, for example, on the order of 1, 10¹, 10², 10³, 10⁴, 10⁵, 10⁶, 10⁷, 10⁸, 10⁹, 10¹⁰, 10¹¹, 10¹², 10¹³ or more locations. A location may have any size. In some cases, a location may have an area of at least and/or at most about 0.1, 0.2, 0.25, 0.3, 0.4, 0.5, 0.6, 0.7, 0.8, 0.9, 1, 1.1, 1.2, 1.25, 1.3, 1.4, 1.5, 1.6, 1.7, 1.75, 1.8, 1.9, 2, 2.25, 2.5, 2.75, 3, 3.25, 3.5, 3.75, 4, 4.25, 4.5, 4.75, 5, 5.5, 6, 7, 8, 9, 10 square microns (μm²), or more. A substrate may comprise more than one type of individually addressable location arranged as an array, randomly, or according to any pattern, on the substrate. In some cases, different types of individually addressable locations may have different chemical, physical, and/or biological properties (e.g., hydrophobicity, charge, color, topography, size, dimensions, geometry, etc.). For example, a first location type may comprise a first surface chemistry, and a second location type may lack the first surface chemistry.

Individually addressable locations may be distributed on the substrate with a pitch determined by the distance between the center of a first location and the center of the closest or neighboring individually addressable location(s). Locations may be spaced with a pitch of at least and/or at most about 0.1, 0.2, 0.25, 0.3, 0.4, 0.5, 0.6, 0.7, 0.8, 0.9, 1, 1.1, 1.2, 1.25, 1.3, 1.4, 1.5, 1.6, 1.7, 1.75, 1.8, 1.9, 2, 2.25, 2.5, 2.75, 3, 3.25, 3.5, 3.75, 4, 4.25, 4.5, 4.75, 5, 5.5, 6, 6.5, 7, 7.5, 8, 8.5, 9, 9.5, or 10 microns (μm). In some cases, the pitch between two locations may be determined as a function of a size of a loading object (e.g., bead). For example, where a bead has a maximum diameter, the pitch may be at least about that maximum diameter.

In some cases, the individually addressable locations may be segregated or indexed, e.g., spatially. Data (e.g., optical signals) corresponding to an indexed location, collected over multiple periods of time, may be linked to the same indexed location. In some cases, sequencing signal data collected from an indexed location, during iterations of sequencing-by-synthesis flows, are linked to the indexed location to generate a sequencing read for an analyte immobilized at the indexed location. In some cases, the individually addressable locations are indexed by physically demarcating part of the surface, depositing a topographical mark, depositing a sample (e.g., a control nucleic acid sample), depositing a reference object (e.g., reference bead that always emits a detectable signal during detection), and the locations may be indexed with reference to such demarcations.

The substrate may be rotatable about an axis, referred to herein as a rotational axis. The rotational axis may or may not be an axis through the center of the substrate. The systems, devices, and apparatus described herein may further comprise an automated or manual rotational unit configured to rotate the substrate. The rotational unit may comprise a motor and/or a rotor. For instance, the substrate may be affixed to a chuck (such as a vacuum chuck). The substrate may be rotated at a rotational speed of at least about 1 revolution per minute (rpm), at least 2 rpm, at least 5 rpm, at least 10 rpm, at least 20 rpm, at least 50 rpm, at least 100 rpm, at least 200 rpm, at least 500 rpm, at least 1,000 rpm, at least 2,000 rpm, at least 5,000 rpm, at least 10,000 rpm, or greater. The substrate may be configured to rotate with different rotational velocities during different operations described herein, for example with higher velocities during reagent dispense and with lower velocities during analyte loading and imaging operations. The substrate may be configured to rotate with a rotational velocity that varies according to a time-dependent function, such as a ramp, sinusoid, pulse, or other function, or combination thereof.

In some cases, the substrate may be movable in any direction. For example, such motion may be non-linear (e.g., in rotation about an axis), linear (e.g., on a rail track), or a hybrid of linear and non-linear motion. In some instances, the systems, devices, and apparatus described herein may further comprise a motion unit configured to move the substrate. The motion unit may comprise any mechanical component, such as a motor, rotor, actuator, linear stage, drum, roller, pulleys, etc., to move the substrate. Analytes or reagents may be immobilized to the substrate during any such motion. Analytes or reagents may be dispensed onto the substrate prior to, during, or subsequent to motion of the substrate.

### Open Substrate Detection Systems

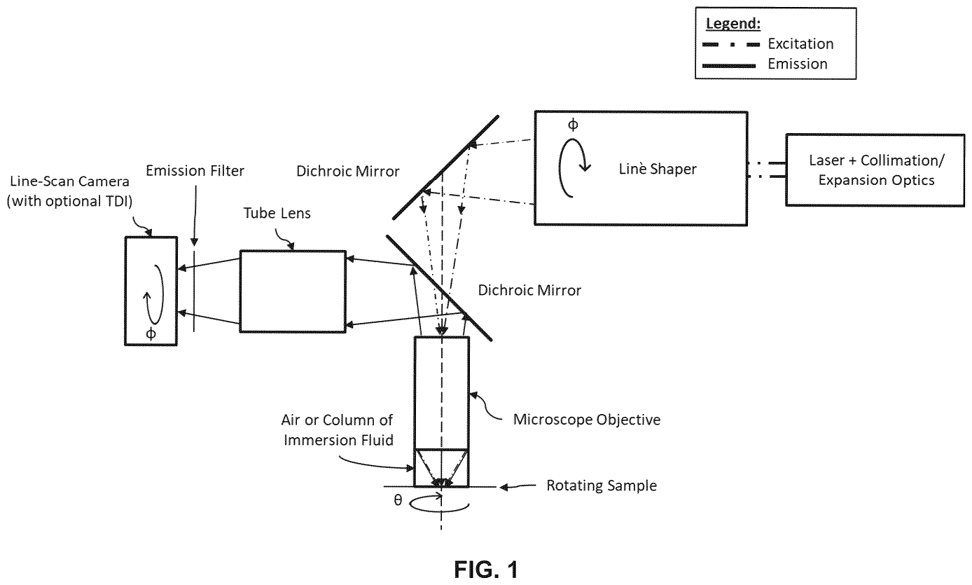

FIG. 1 shows an exemplary optical system that may be used to scan a substrate as disclosed herein, for example a rotating substrate. An optical system comprising a detector may be configured to detect one or more signals from a detection area on the substrate prior to, during, or subsequent to, the dispensing of reagents to generate an output. Signals from multiple individually addressable locations may be detected during a single detection event. Signals from the same individually addressable location may be detected in multiple instances.

The optical system may comprise one or more distinct optical paths. The one or more optical paths may comprise mirrored optical layouts. An optical path may comprise additional optical components not shown in FIG. 1. For example, an optical path may comprise additional splitting, reflecting, focusing, magnifying, filtering, shaping, rotating, polarizing, or other optical elements. An optical path may comprise an excitation path and an emission path. The excitation path and the emission path may each comprise a plurality of optical elements in optical communication with (e.g., transmitting light to and/or receiving light from) a substrate. For example, the excitation path may comprise a plurality of optical elements that are (i) located along the optical path of excitation light and (ii) configured to illuminate the substrate. The emission path may comprise a plurality of optical elements that are along the optical path of emission light output from the substrate. In some cases, the excitation path comprises one or more of an excitation light source, a beam expander element, a line shaper element, a dichroic mirror, and an objective (e.g., an objective lens). In some cases, the emission path may comprise one or more of an objective, a dichroic mirror, a beam splitter, a lens (e.g., a tube lens or a cylindrical lens), and a detector.

The objective in the excitation path may be the same as the objective in the emission path. The objective may be an immersion objective or an air objective. The dichroic in the excitation path may be the same as the dichroic in the emission path. The dichroic may be a short pass dichroic, or the dichroic may be a long pass dichroic. In some cases, the dichroic passes the excitation light and reflects the emission light. In other instances, the dichroic reflects the excitation light and passes the emission light.

The excitation light source may be configured to emit light (e.g., coherent light). The excitation light source may comprise one or more light emitting diodes (LEDs), one or more lasers, one or more single-mode laser sources, one or more multi-mode laser sources, one or more laser diodes, a continuous wave laser or a pulsed laser, or a combination thereof. A beam of light emitted by a laser may be a Gaussian or approximately Gaussian beam, which beam may be manipulated using one or more optical elements (e.g., mirrors, lenses, prisms, waveplates, etc.). For example, a beam may be collimated. In some cases, a beam may be manipulated to provide a laser line (e.g., using one or more Powell lenses or cylindrical lenses). The excitation light source may be coupled to an optical fiber.

The line shaper may be configured to expand excitation light provided by the excitation light source along one axis. The line shaper may comprise one or more lenses (e.g., one or more cylindrical lenses). The one or more cylindrical lenses may be convex cylindrical lenses, concave cylindrical lenses, or any combination thereof. In some instances, the line shaper is positioned in a rotating mount, for example a motorized rotating mount. The rotational mount may be configured to rotate the expanded excitation light source about a central axis without substantial deviation of the central point of the excitation light source. The line shaper element may be configured to rotate about the central axis in response to, concurrent with, or in anticipation of a translation of the substrate with respect to the optical system. For example, the line shaper element may rotate about the central axis such that the axis of the expanded excitation light maintains a defined orientation with respect to the rotational axis of the substrate upon translation of the substrate with respect to the optical axis in a direction that is not directly toward or away from the rotational axis.

The beam expander may comprise one or more lenses. For example, the beam expander may comprise two lenses. The lenses may have different focal lengths. In some cases, the lens closer to the excitation light source may have a shorter focal length than the lens farther from the excitation light source. The beam expander may be configured to expand the excitation light about 2×, about 3×, about 4×, about 5×, about 10×, about 15×, or about 20×. The beam expander may be configured to collimate and/or to focus the excitation light.

Detectors may comprise any combination of cameras (e.g., CCD, CMOS, or line-scan), photodiodes (e.g., avalanche photo diodes), photoresistors, phototransistors, or any other optical detector known in the art. In some cases, the detectors may comprise one or more cameras. For example, the cameras may comprise line-scan cameras, such as time delay and integration (TDI) line-scan cameras. A TDI line-scan camera may comprise two or more vertically arranged rows of pixels. The detector may be configured to rotate with respect to a substrate to correct for tangential velocity blur, as described herein. In some cases, the detector may be configured to rotate in response to, concurrent with, or in anticipation of a translation of a substrate with respect to the optical system. For example, the detector may rotate such that the axis of the imaging field maintains a defined orientation with respect to the rotational axis of a substrate upon translation of the substrate with respect to the optical axis in a direction that is not directly toward or away from the rotational axis. The detector may be configured to rotate concurrently with a rotation of the line shaper element, such that the imaging field maintains a defined orientation with respect to the axis of the expanded excitation light. The detector may be configured to rotate independently of the line shaper element.

Optical systems of this disclosure may further comprise one or more autofocus systems. In some cases, each optical path in the optical system comprises an autofocus system. The autofocus system may comprise an autofocus illumination source configured to direct autofocus light through the objective toward the surface. The autofocus illumination source may comprise an infrared (IR) laser, e.g., a speckle-free IR laser. The autofocus light may pass through one or more of the optical elements in the optical path. The autofocus detector may be a position-sensitive detector. The autofocus light may coincide with the autofocus detector at a discrete position when the surface is in focus for an emission detector (e.g., the camera illustrated in FIG. 1). The autofocus illumination source and the autofocus detector may be configured such that a change in a position of the surface relative to the objective results in a change in position of the autofocus illumination on the autofocus detector. For example, a change in a distance between the surface and the objective or a tilt of the surface relative to the objective may cause a displacement of the autofocus illumination position on the autofocus detector. The autofocus system may send a signal to a focusing system in response to the change in position of the autofocus illumination on the autofocus detector. The focusing system may adjust the position of the surface relative to the objective such that the position of the autofocus illumination on the autofocus detector returns to the discrete position when the surface is in focus on the emission detector.

The optical systems of this disclosure may be aligned such that the excitation light and the emission light pass substantially through the center of the optical elements. For instance, the excitation light may be aligned with respect to the line shaper element such that the position of the excitation light after passing through the line shaper does not change substantially upon rotation of the line shaper. The line shaper may be rotated during alignment and the position of the excitation light source, the line shaper, or both may be adjusted to minimize motion of the position of the excitation light after passing through the line shaper upon rotation of the line shaper. In some cases, a position of the detector is aligned with respect to a rotating mount. For example, the detector is centered within the rotational mount by illuminating the center of the detector, rotating the rotational mount, and adjusting the position of the detector within the mount so that the position of the illumination does not move upon rotation of the rotational mount. In some cases, the position of the excitation light and/or the emission light is aligned at two or more points thereby defining both a position and an angle.

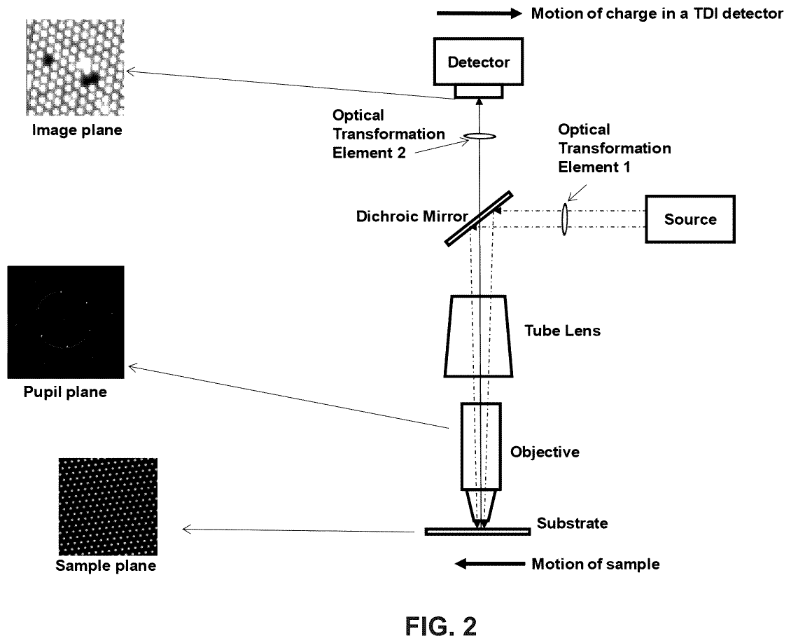

FIG. 2 provides another exemplary optical system that may be used to scan a substrate as disclosed herein. Specifically, FIG. 2 illustrates a compact design for a Confocal Structured Illumination (CoSI) microscope incorporating a TDI camera as the detector. The elimination of scanners and optical relays can significantly reduce the complexity and cost of the system. Relative motion between the sample and the camera sensor, as performed during TDI scanning, is compensated for by the TDI mechanism, which moves integrated charge across the sensor with a speed that matches that of the sample motion. Multi-foci (or structured) illumination patterns are created by the use of optical transformation element 1 (e.g., a micro-lens array or a diffractive optical element) and projected onto the sample plane through the lens and the objective. Optical transformation element 2 performs photon reassignment of light in the emission optical path prior to the detector (e.g., to increase resolution in the image plane). Optical systems and methods comprising the use of multiple optical transformation elements are described further in International Pat. App. No. WO2022/077551, which is entirely incorporated herein by reference.

### High Throughput

An open substrate as described herein may be processed within a modular local sample processing environment. A barrier comprising a fluid barrier may be maintained between a sample processing environment and an exterior environment during certain processing operations, such as reagent dispensing and detecting. Systems and methods comprising a fluid barrier are described further in U.S. Pat. Pub. No. 2021/0354126A1, which is entirely incorporated herein by reference.

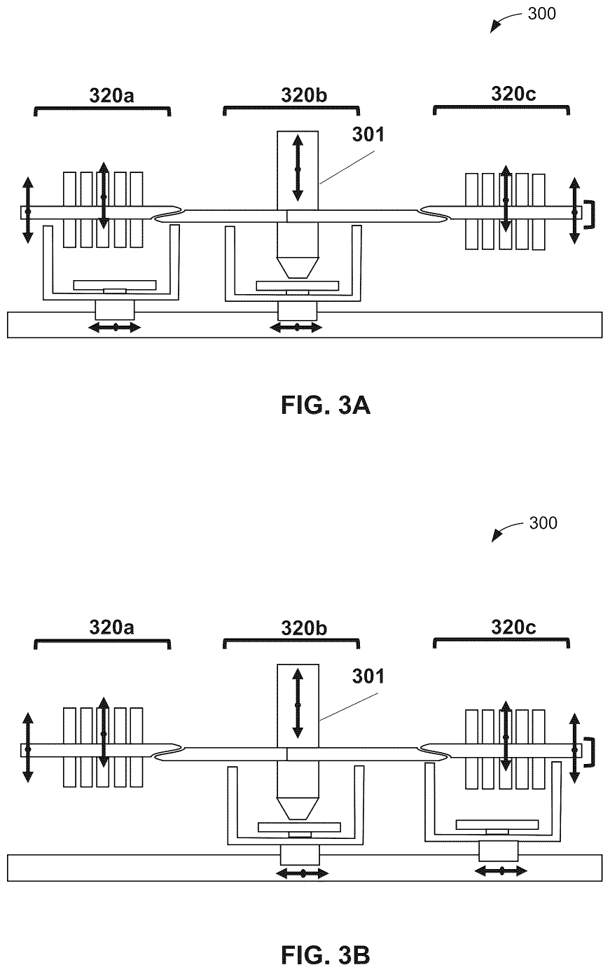

As shown in FIG. 3A and FIG. 3B, a processing system 300 (e.g., for use with open substrates) may comprise different operating stations (e.g., 320a, 302b, 320c). For example, an operating station may comprise a chemical station (e.g., 320a, 320c) configured for reagent dispensing, analyte processing, and/or washing; a sample loading station, a sample storage station, or a detection station (e.g., 320b), such as for detection of a signal or signal change. Any barrier system (e.g., 305a, 305b) of the processing system may be capable of traveling (e.g., along rail or track 307) between different operating stations, thus moving an open substrate from one operating station to another. In some instances, different barrier systems may share the same rail or track or other motion path for travel between the different operating systems (e.g., as illustrated in FIG. 3A and FIG. 3B). In such cases, the different barrier systems may be configured to move independently of each other on the same rail or track or other motion path, or to move in unison. In some instances, a respective different barrier system may move on a dedicated, separate rail or track or other motion path.

The processing system or any element thereof may be environmentally controlled. For instance, operating stations may have different local temperatures, pressures, and/or humidity. For example, a chemical station may comprise first operating conditions, and a detection station may comprise second, different operating conditions.

A barrier system may be configured to maintain a fluid barrier between a sample processing environment and an exterior environment. The barrier system is described in further detail in U.S. Pat. Pub. No. 2021/0354126, which is entirely incorporated herein by reference. A sample environment system may comprise a sample processing environment defined by a chamber and a lid plate, where the lid plate is not in contact with the chamber. While FIG. 3A and FIG. 3B illustrate a processing system 300 comprising three operating stations (e.g., 320a, 320b, 320c) and two barrier systems (e.g., 303a, 303b), it will be appreciated that a processing system may have any number of operating stations and any number of barrier systems.

An operating station 320 may have one or more operating units configured to facilitate an operation with respect to a sample or the sample environment (or local environment(s) thereof). An operating unit may protrude into the sample environment of a barrier system from the external environment. An operating unit may comprise one or more detectors 301 configured to facilitate detection of a signal or signal change from a sample; a fluid dispenser (e.g., 309a, 309b) configured to facilitate reagent or fluid dispensing to a sample; an environmental unit configured to facilitate environment regulation of a sample environment; a light source, heat source, or humidity source; or any one or more sensors.

In some instances, the processing system 300 may comprise a plurality of modular plates (e.g., 303a, 303b, 303c) that may be coupled or otherwise fastened to each other to create an uninterrupted plate 303. In some instances, each modular plate may comprise one or more operating stations (e.g., operating stations are coupled or otherwise fastened to plate 303). In some instances, a modular plate may be detachable from another modular plate or a remainder of the plate 303 without disturbing sample environments of respective barrier systems, such as during an operation by one or more operating units on a barrier system, while another barrier system is subject to another operation at another operating station. Beneficially, detachment of a modular plate may allow access to a sample environment, such as to load or unload a chamber, without disturbing another sample environment (e.g., contained withing another barrier system).

Chambers of the present disclosure may comprise a base and side walls to define an opening that nearly contacts the plate (or lid). The side walls may be a closed continuous surface, or a plurality of adjacent (and/or adjoining) surfaces. For example, the base may comprise or be the substrate. In some instances, the base may be coupled to the substrate. The substrate may be translatable relative to the base. The substrate may be rotatable relative to the base. While examples herein describe relative rotational motion of the substrates and/or detector systems, the substrates and/or detector systems may alternatively or additionally undergo relative non-rotational motion, such as relative linear motion, relative non-linear motion (e.g., curved, arcuate, angled, etc.), and any other types of relative motion. Beneficially, relative motion between the one or more detection units in the detection station and the substrate may significantly increase detection efficiency. Additional details of detector systems, including immersion optic systems, are available in, for example, International Pat. Pub. Nos. WO2019099886, WO20200118172, WO2020186243, each of which is herein incorporated by reference in their entireties.

In some instances, an open substrate (e.g., 330a, 330b) is retained in the same or approximately the same physical location during processing of an analyte and subsequent detection of a signal associated with a processed analyte. The open substrate may transition between different stations by transporting a sample processing environment containing the open substrate (such as the one described with respect to the barrier system) between the different stations. One or more mechanical components or mechanisms, such as a robotic arm, elevator mechanism, actuators, rails, and the like, or other mechanisms may be used to transport the sample processing environment.

FIG. 3A and FIG. 3B illustrate the multiplexing processing system 300. In this illustrative re-stationing scheme, the detection station may be kept active (e.g., not have idle time not operating on a substrate) for all operating cycles by providing alternating different sample environment systems to the detection station for each consecutive operating cycle. Beneficially, use of the detection station is optimized. Based on different processing or equipment needs, an operator may opt to run the two chemistry stations (e.g., 320a, 320c) substantially simultaneously while the detection station (e.g., 320b) is kept idle, as illustrated in FIG. 3A. Beneficially, different operations within the system may be multiplexed with high flexibility and control. For example, one or more processing stations may be operated in parallel with one or more detection stations on different substrates in different modular sample environment systems to reduce or eliminate lag between different sequences of operations (e.g., chemistry first, then detection).

### Focus Errors and Image Aberration

Irregularities in a scanning system (e.g., focus errors or image aberration) may result in poor image quality; for example, when the surface of a substrate (e.g., a planar sample, a planar substrate supporting a sample, or a wafer) is scanned, defects (e.g., unevenness) in the substrate surface, when not corrected, can lead to blurry or aberrated images. An image collected by a detector may be displaced (e.g., out-of-focus or tilted) or aberrated due to field curvature. The surface may map a light field to a displaced, tilted, or aberrated image of the surface detected by the sensor causing the image to be out-of-focus. Aberrations and alignment lead to inaccurate representation of elements within the image (e.g., some elements can be stretched or curved) due to aberrations in a wavefront received by the detector. Irregularities (e.g., focus errors or image aberrations) may be caused by internal sources (e.g., system misalignment or motion or substrate irregularities) or external sources (e.g., vibrations during scanning or thermal changes of the substrate). Irregularities may be static (e.g., systematic or time independent) or dynamic (e.g., time dependent, position dependent), or both.

### Systematic Focus Errors and Image Distortion

Systematic irregularities (e.g., focus errors or image aberration) may be inherent to components or a setup of a scanning system. For example, systematic irregularities may be caused by system misalignment, imperfections in optical elements, imperfections in the detector, or inherent to the optical system. Systematic irregularities may be caused by misalignment of one or more optical elements in a light path. For example, a lens, an objective, a mirror, a beam splitter, a prism, or combinations thereof may be misaligned (e.g., shifted parallel the light path, shifted perpendicular to the light path, tilted, or combinations thereof), resulting in a systematic irregularity. In some embodiments, misalignment may cause focus errors due to errors in the length of a light path between the substrate and the detector. In some embodiments, errors in light path length may be non-uniform across the wavefront of an illumination light beam, resulting in non-uniform focus (e.g., tilt) on the detector. Misalignment may cause an image plane and/or an object plane to be displaced or tilted relative to the substrate, the detector, or both or may introduce aberrations into the wavefront, resulting in image degradation or non-uniform focus across the detector.

Alternatively, or in addition to misalignment, systematic irregularities may be caused by imperfections in one or more optical elements in a light path. For example, a lens, an objective, a mirror, a beam splitter, a prism, or combinations thereof may have an imperfection, resulting in a systematic irregularity. In some embodiments, imperfections may cause focus errors due to aberrations in the light path between the substrate and the detector. In some embodiments, aberrations may be non-uniform across the wavefront, resulting in non-uniform focus on the detector. Imperfections may cause an image plane and/or an object plane to be displaced or tilted relative to the substrate, the detector, or both or may introduce aberrations into the wavefront, resulting in image aberrations or non-uniform focus across the detector. Systematic irregularities may be caused by irregularities in the detector. For example, the detector may be curved relative to the detected wavefront (e.g., the wavefront of light emitted from or reflected by the sample), resulting in focus errors or image aberrations.

### Dynamic Focus Errors and Image Aberrations

Dynamic irregularities (e.g., focus errors or image aberration) may change over time (e.g., during scanning). Dynamic irregularities may be caused by internal sources (e.g., system motion or substrate irregularities) or external sources (e.g., vibrations or thermal changes). In some embodiments, dynamic irregularities may be wafer dependent. Substrate dependent irregularities may vary across the wafer surface, such that the irregularities change over time as the substrate is being scanned. In some embodiments, substrate dependent irregularities may differ between substrates, resulting in irregularities that change for each substrate scanned (e.g., there may be differences in the substrate between a first sequencing run and a second sequencing run). In some embodiments, dynamic irregularities may be random. Random irregularities may result from internal sources, such as vibrations from the scanning system (e.g., the substrate stage) or connected systems (e.g., sample processing systems), or random irregularities may result from external sources, such as external vibrations or thermal changes (e.g., in the surrounding environment).

### Systematic Focus Correction

Systematic focus correction may be used to correct systematic irregularities (e.g., systematic focus errors or systematic image aberration). Systematic focus correction may comprise applying a static change to the optical path of a scanning system that is not adjusted over time or between substrates. In some embodiments, systematic error correction may comprise inserting or adjusting an optical element in a light path (e.g., an imaging light path) between the substrate and the detector. The inserted or adjusted optical element may alter a length of the light path, bend the light path, change a focal length of the light path, or otherwise alter the light path. The inserted or adjusted optical element may alter a shape of the wavefront formed by light following the light path.

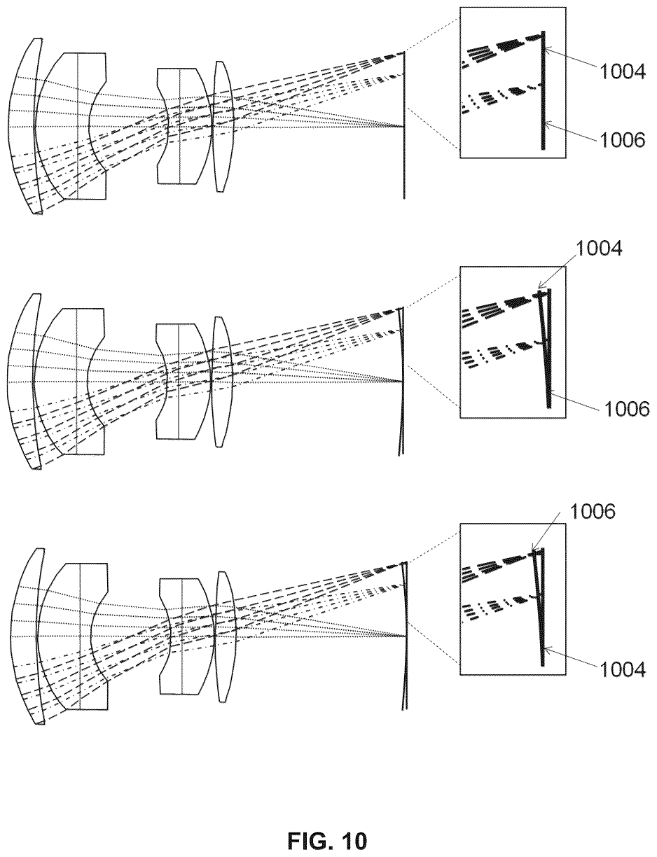

In some embodiments, a systematic focus correction may comprise inserting a field flattener. A field flattener may be used to correct an irregularity resulting from a curvature in the wavefront (indicated as 1006 in FIG. 10) when it encounters the detector (e.g., 1004 in FIG. 10), curvature in the detector, or both. The field flattener may vary the optical path length across the field. A mismatch between the curvature of the wavefront and the curvature of the detector may result in an image with non-uniform focus across the image (e.g., where parts of the image are out-of-focus). In some embodiments, the field flattener may curve a wavefront to match the curvature of a detector. In some embodiments, the field flattener may correct optical aberrations in the light path. In some embodiments, the field flattener may flatten a curved wavefront. A field flattener may comprise a lens. In some embodiments, the lens may comprise a diverging lens (e.g., a concave lens). In some embodiments, the lens may comprise a converging lens (e.g., a convex lens). In some embodiments, the field flattener may be positioned near an object plane or an image plane of the imaging light path (e.g., further or closer to an imaging detector, respectively). In some embodiments, the field flattener may be spatially separated from the detector.

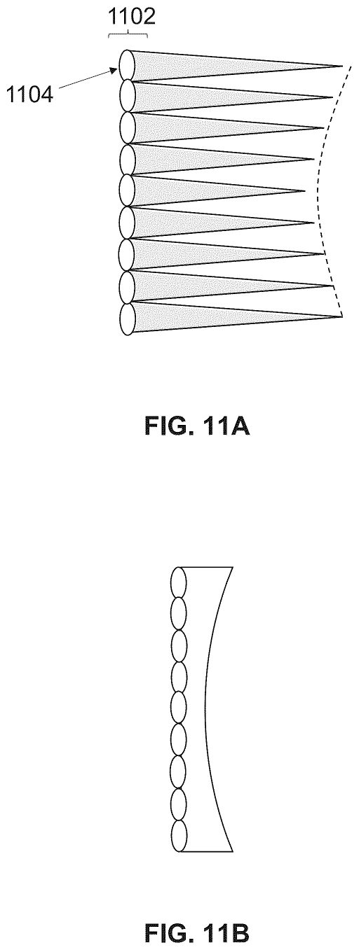

In some embodiments, a systematic focus correction may comprise inserting a plurality of lenses, such as a microlens array (e.g., 1102 as illustrated in FIG. 11A). A microlens array may be used to correct a curvature in the wavefront when it encounters the detector, curvature in the detector, or both. The microlens array comprises a plurality of lenses 1104 (also referred to herein as “lenslets”) having the same or different focal lengths. In some embodiments, a microlens array comprising lenses with different focal lengths may vary the optical path length across the field. A lenslet of a microlens array may be a diverging lens (e.g., a concave lens). In some embodiments, a lenslet of a microlens array may be a converging lens (e.g., a convex lens). A mismatch between the curvature of the wavefront and the curvature of the detector may result in an aberrated image or an image with non-uniform focus across the image (e.g., where parts of the image are out-of-focus). In some embodiments, the microlens array may curve a wavefront to match the curvature of a detector. In some embodiments, the microlens array may correct optical aberrations in the light path. In some embodiments, the microlens array may flatten a curved wavefront. In some embodiments, a systematic focus correction may comprise inserting a microlens array in combination with a field flattener (e.g., as illustrated in FIG. 11B).

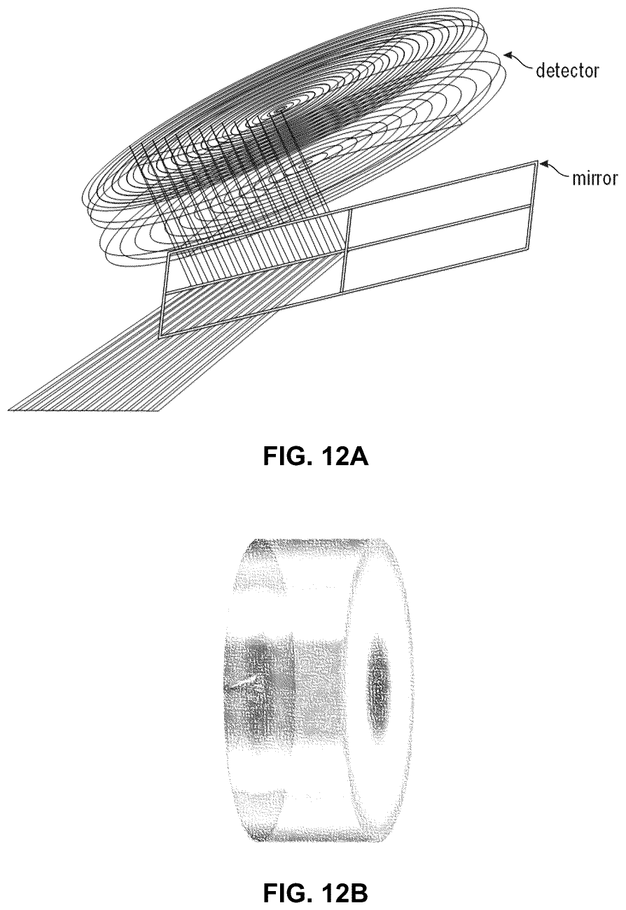

In some embodiments, a systematic focus correction may comprise physically bending an optical element (e.g., a reflective optical element such as a mirror) to distort the wavefront following an encounter with the bent optical element. For example, force may be applied to a mirror to bend the mirror, altering the shape of the wavefront when it reflects off of the bent mirror (e.g., reflected at the bent mirror or reflected by the bent mirror, as illustrated in FIG. 12A). A bent optical element may be used to correct an irregularity resulting from a curvature in the wavefront when it encounters the detector, curvature in the detector, or both. Bending the optical element may comprise producing a concave shape with the optical element. Bending the optical element may comprise producing a convex shape with the optical element. In some embodiments, the bent optical element may curve a wavefront to match the curvature of a detector. In some embodiments, the bent optical element may correct optical aberrations in the light path. In some embodiments, the bent optical element may flatten a curved wavefront.

In some embodiments, a systematic focus correction may comprise an optical element (e.g., a lens, a window, or a beam splitter) with a refractive index gradient. For example, a gradient index window (e.g., as illustrated in FIG. 12B) may be inserted in a light path for systematic focus correction. The light path may pass through the optical element with the refractive index gradient and distort the wavefront. A refractive index gradient may be used to correct an irregularity resulting from a curvature in the wavefront when in encounters the detector, curvature in the detector, or both. In some embodiments, the refractive index gradient may curve a wavefront to match the curvature of a detector. In some embodiments, the refractive index gradient may correct optical aberrations in the light path. In some embodiments, the refractive index gradient may flatten a curved wavefront.

### Focus Detection

Described herein are systems and methods for determining a focus position of a surface (e.g., a relationship between the surface and an object plane of a scanning system). A focus detection system described herein may be configured to identify differences in z-position (also referred to herein as “height”) of a surface relative to an object plane of an optical system (e.g., a scanning system or a focus detection system), differences in tilt angle of the surface relative to the object plane of the optical system, or combinations thereof. The focus detection system may utilize one or more optical sensors (e.g., cameras or photodiodes) to detect a property (e.g., a shape or a position) of a light reflected off of the surface (e.g., reflected at the surface or reflected by the surface). The property may be a function of a position of the surface relative to the object plane at the point where the reflected light was reflected off of the surface (also referred to herein as a “focus region”). In some embodiments, the detected property may be used to determine a position of the surface relative to the object plane at the focus region.

### Focus Detection Systems

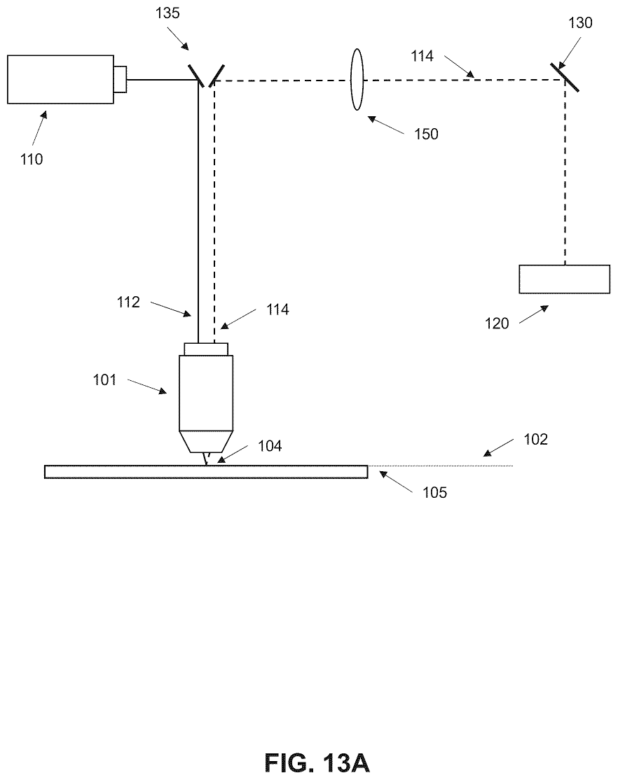

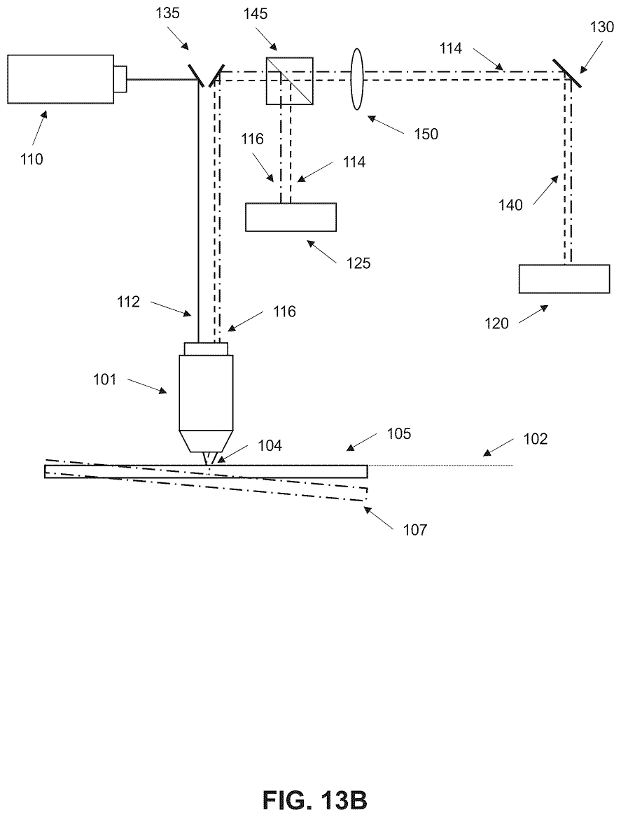

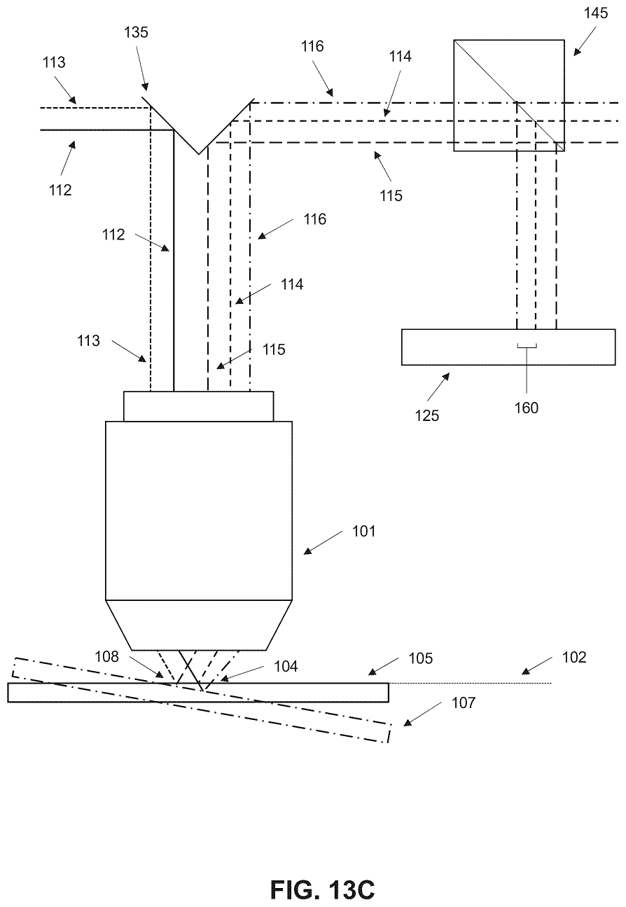

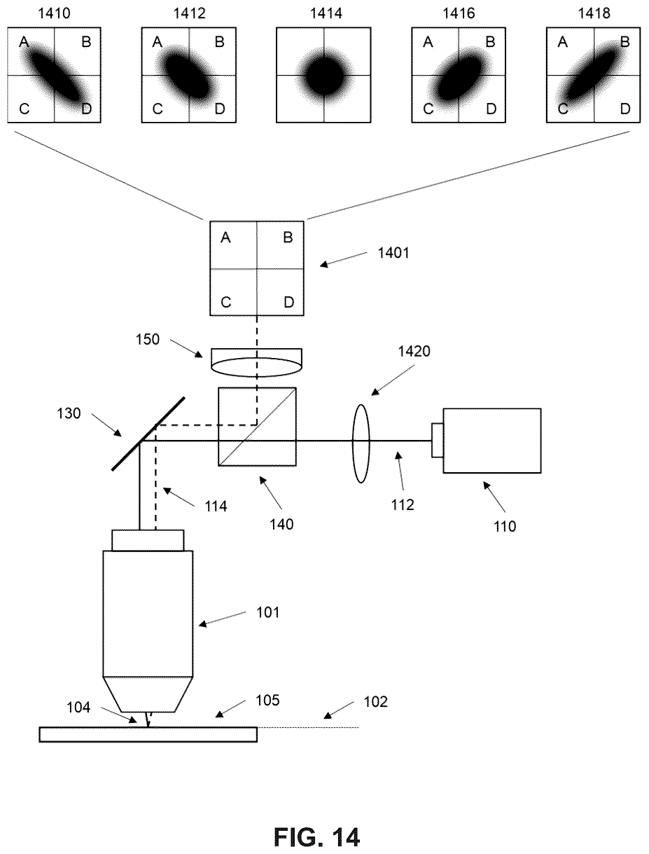

Exemplary focus detection systems are illustrated in FIGS. 13A-14. As illustrated in FIG. 13A, focus detection systems of the present disclosure may include a focus light source (e.g., focus illumination source 110) to illuminate a surface 105 with a focus light transmitted along a focus light path 112. The focus light may illuminate a region of the surface (e.g., focus region 104), and the focus light may be reflected off of the surface (e.g., reflected at the surface or reflected by the surface) as reflected light along a reflected light path 114. The reflected light may be detected (e.g., by focus detector 120) to determine properties of the reflected light (e.g., a shape or position). Properties of the reflected light may be a function of a position (e.g., a z-distance or a tilt angle) of the surface relative to an object plane (e.g., 102) of an optical system, such as the focus detection system or a scanning system including the focus detection system.

A first example of a focus detection system is described with reference to FIG. 13A. The focus detection system illustrated in FIG. 13A focus detector 120 may be positioned to detect a z-position of a surface 105 relative to an object plane 102 of an optical. The z-position may be measured along an axis parallel to the optical axis. The focus detector may detect a position of light reflected off of the surface. The position at which the reflected light encounters the detector may be a function of the z-position (also referred to as “height”) of the surface relative to the object plane.

In some embodiments, focus light emitted by the focus illumination source comprises electromagnetic radiation, such as light. The light may be visible light, infrared light, or ultraviolet light. The focus illumination source 110 may comprise a light emitting diode (LED), such as an infrared LED; or a laser, such as an infrared (IR) laser. For example, the focus illumination source 110 may be a speckle-free infrared (IR) laser. The laser may be a single-mode laser source, a multi-mode laser source, a laser diode, a continuous wave laser, or a pulsed laser. Focus light emitted by the laser may be a Gaussian or approximately Gaussian beam. In some embodiments, focus light may be collimated. In some cases, focus light may be manipulated to provide a laser line (e.g., using one or more Powell lenses or cylindrical lenses). The focus illumination source 110 may be coupled to an optical fiber. In some cases, the focus light may be infrared light (IR, with a wavelength between about 700 nm to 1 mm) or near infrared light (NIR, with a wavelength between about 700 nm to 4 μm).

A light path, such as focus light path 112, may include one or more optical elements (e.g., mirrors, lenses, prisms, waveplates, etc.) that manipulate the light to direct the light along the desired path. Focus light path 112 may include one or more reflective elements that reflect the focus light (and/or the reflected light). In some embodiments, the focus light may be reflected off a reflective element (e.g., mirror 135) at a 90° angle. One or more optical elements, such as lenses, reflective elements, or beam splitters may be included, excluded, or removed to accommodate spatial constraints of a system. In some embodiments, the focus light may be reflected off one or more reflective elements (e.g., in a series, such as mirrors 135, 130) at an angle between about 0° to 180°.

The focus light path 112 may pass through an objective 101. The objective may be an immersion objective or an air objective. An immersion objective can be immersed in water, buffer, aqueous solution, oil, organic solvent, index matching fluid, or other immersion fluid. The objective may be a 10×, 20×, 50×, or 100× objective. Objective 101 may be configured to magnify a sample, such as surface 105 (e.g., a wafer, a planar sample, a substrate supporting a sample). The objective 101 may have an object plane 102 corresponding to a plane at which an object (e.g., surface 105) is in focus on a detector (e.g., focus detector 120) optically coupled to the objective. “Optical coupling” refers to transfer of optical energy or other forms of electromagnetic energy. The objective may direct the focus light (e.g., following focus light path 112) to the surface 105. The focus light may illuminate the surface 105 in the focus region 104. The surface may reflect the focus light, thereby creating reflected light. The reflected light may be directed back through the objective and along a reflected light path 114. As with focus light path, reflected light path 114 may include one or more optical elements to manipulate the reflected light. As shown in FIG. 13A, the reflected light may pass through a focus lens 150.

A lens may comprise one or more lenses. For example, a lens may comprise two lenses. The two lenses may have different focal lengths, or the two lenses may have the same focal lengths. The lens may be configured to expand a light beam passing through the lens (e.g., the reflected light) about 2×, about 3×, about 4×, about 5×, about 10×, about 15×, or about 20×. In some embodiments, the lens may be configured to collimate the emission light. The lens (e.g., focus lens 150) may be configured to focus the reflected light.

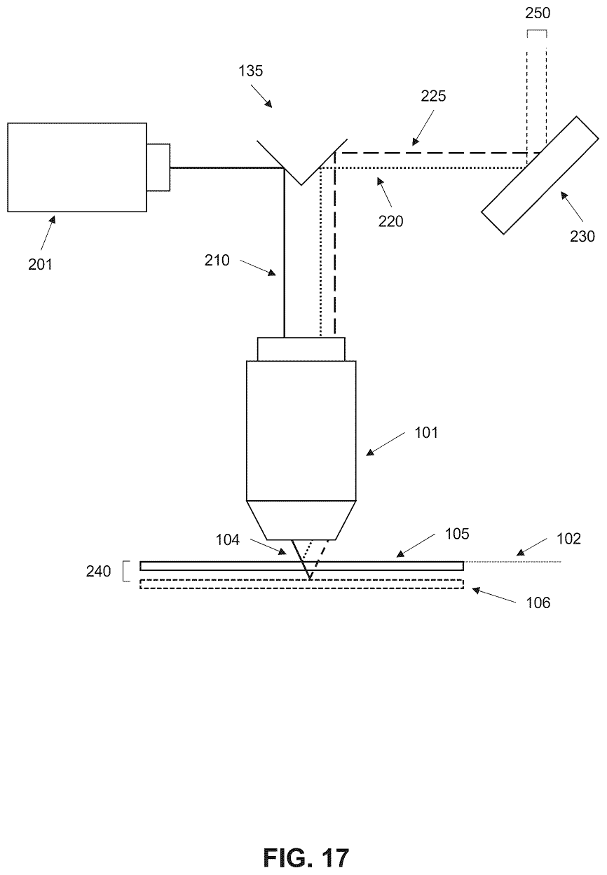

The reflected light may be directed along the reflected light path 114 to focus detector 120. In some embodiments, a detector (e.g., focus detector 120) may comprise any optical detector capable of detecting light. The detector may comprise a camera (e.g., CCD, CMOS, or line-scan), a photodiode (e.g., avalanche photo diode), a photoresistor, a phototransistor, or any other optical detector known in the art. In some embodiments, the detector may be a position-sensitive detector. The focus detector 120 may detect the reflected light and measure properties (e.g., position, intensity, spatial distribution, or a combination thereof) of the reflected light. The measured properties of the reflected light may be indicative of properties of the surface 105 (e.g., substrate height or substrate tilt). In some embodiments, the position of the focus light on the focus detector 120 may be used to quantify the height or tilt angle of the surface 105. The reflected light may coincide with the focus detector 120 at a discrete position when the surface 105 is in focus on an imaging detector (e.g., imaging detector 230 shown in FIG. 17). The focus illumination source 110 and the focus detector 120 may be configured such that a change in a position of the surface 105 relative to the objective 101 results in a change in position of the reflected light following the reflected light path 114 on the focus detector 120. For example, a change in a distance between the surface 105 and the objective 101 or a tilt of the surface 105 relative to the objective 101 may cause a displacement of the reflected light following the reflected light path 114 as detected on the focus detector 120. The autofocus system may send a signal to a focusing system in response to the change in position of the reflected light following the reflected light path 114 on the focus detector 120. The focusing system may adjust the position of the surface 105 relative to the objective 101 such that the position of the reflected light path 114 on the focus detector 120 returns to the discrete position when the surface 105 is in focus on an emission detector (e.g., imaging detector 230 shown in FIG. 17). The autofocus system shown in FIG. 13A may be used for determining the tilt and height profile of a surface 105 of a substrate.

A second example of a focus detection system is described with reference to FIG. 13B. The focus detection system illustrated in FIG. 13B may include a focus detection sensor (e.g., focus detector 120) positioned to detect a z-position of a surface 105 relative to an object plane of an optical system (e.g., object plane 102) and a second focus detector (e.g., second focus detector 125) positioned to detect atilt of a surface 105 relative to an object plane of an optical system (e.g., object plane 102). The z-position may be measured along a z-axis parallel to the optical axis. The focus sensors may detect a position of light reflected off of the surface. The position at which the reflected light encounters the detectors may be a function of the z-position of the surface relative to the object plane, the tilt of the surface relative to the object plane, or both.

As described with respect to FIG. 13A, in FIG. 13B focus light is provided along focus light path 112. The focus light path 112 may pass through an objective 101, and focus light may be directed to illuminate focus region 104 of surface 105. Light reflected from the surface may be directed along reflected light path 114.

In some embodiments, the surface may be tilted with respect to object plane 102, such as tilted substrate 107. The objective may direct the focus light (e.g., following focus light path 112) to the surface of the substrate and encounter a focus region of the surface at the position of the tilted substrate 107. The focus light may illuminate the tilted substrate 107 in the focus region 104 on the tilted substrate. The tilted substrate 107 may reflect the focus light along a different light path than the planar substrate positioned parallel to the object plane 102. The planar substrate has a planar surface 105 that is parallel to the object plane 102. The light reflected by the tilted substrate 107 may follow displaced reflected light path 116, separate from the reflected light path 114. The displaced reflected light path 116 may encounter a focus detector 120 or a second focus detector 125 at a different position than that of reflected light path 114.

As shown in FIG. 13B, reflected light (e.g., the reflected light or the displaced reflected light) may follow a different light path (e.g., the reflected light path 114 or the displaced reflected light path 116), depending on the tilt angle of the surface. Reflected light path 114 and displaced reflected light path 116 may share one or more optical elements. However, displaced reflected light may interact with one or more optical elements at a different angle or position than that of reflected light (e.g., corresponding to the respective positions of the tilted 107 and non-tilted 105 surfaces).

As shown in FIG. 13B, reflected light (e.g., the reflected light or the displaced reflected light) may be split by a focus beam splitter 145. The displaced reflected light (e.g., following the displaced reflected light path 116) may encounter the focus beam splitter 145 at a different angle or position than the reflected light (e.g., following the reflected light path 114). A first portion of the light may be directed along the reflected light path 114 or the displaced reflected light path 116 to the first focus detector 120, and a second portion of the light may be directed to a second focus detector 125. The second focus detector 125 may be positioned in an infinite conjugate plane of the optical system (e.g., at the focal plane of the focusing lens). In some embodiments, the infinite conjugate plane is a position along a light path where the light is collimated. In some cases, second focus detector 125 may comprise a same type of detector as the focus detector 120. In some cases, the second focus detector may comprise a different type of detector from the focus detector. The second focus detector 125 may detect the reflected light or the displaced reflected light and measure properties (e.g., position, intensity, spatial distribution, or a combination thereof) of the reflected light or the displaced reflected light (e.g., indicative of the positioning of the surface 105.

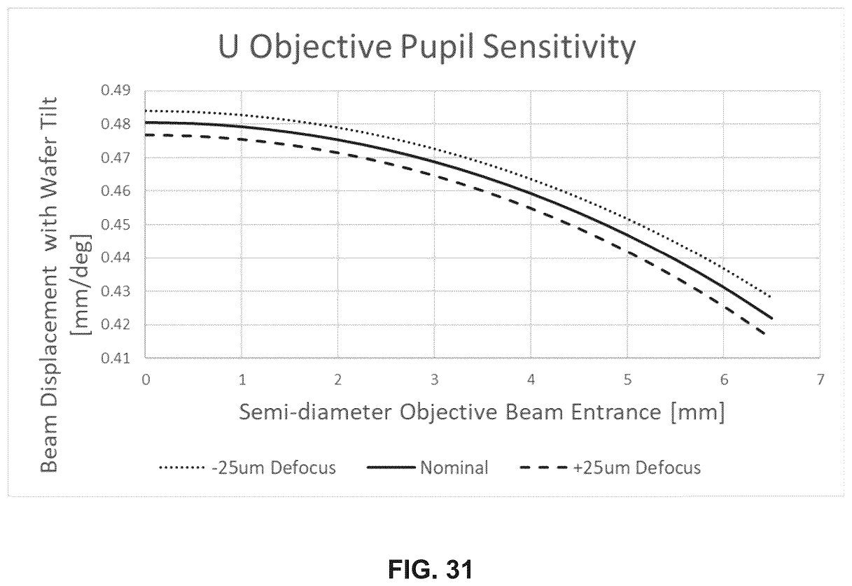

As described with respect to focus detector 120, the reflected light may coincide with the second focus detector 125 at discrete positions, depending on a position of the surface. For example, when the surface 105 is aligned with the object plane 102 (e.g., in focus on imaging detector 230 shown in FIG. 17), the reflected light may encounter the second focus detector 125 at a first position, and when the surface of the tilted substrate 107 is tilted relative to the object plane 102, the reflected light may encounter the second focus detector 125 and a second position. The focus illumination source 110 and the second focus detector 125 may be configured such that a change in a position (e.g., a change in height, a change in tilt angle, or both) of the surface 105 relative to the object plane 102 causes a shift in the position at which the reflected light encounters the second focus detector 125. For example, a change in the position of the surface 105 to the tilted substrate 107 position may cause a displacement of reflected light (e.g., displaced reflected light) from the reflected light path 114 to the displaced reflected light path 116 on the second focus detector 125. The autofocus system may send a signal to a focusing system in response to displacement of reflected light following the displaced reflected light path 116 on the second focus detector 125. In some embodiments, reflected light may be displaced on the second focus detector 125 by a distance of at least about 0.4 mm per degree change in tilt angle, as illustrated in FIG. 31. In some embodiments, the reflected light may be displaced on the second focus detector 125 by a distance of at least about 0.4 mm, at least about 0.42 mm, at least about 0.44 mm, at least about 0.46 mm, or at least about 0.48 mm per degree change in tilt angle. In some embodiments, the reflected light may be displaced on the second focus detector 125 by a distance of at least about at least about 1.5 μm, at least about 2 μm, or at least about 2.5 μm per 100 μRad change in the tilt angle.

The focusing system may adjust the position of the substrate (e.g., tilted substrate 107) relative to the object plane 102 (e.g., by adjusting the position of the substrate or the position of the object plane) such that the position of the displaced reflected light path 116 on the second focus detector 125 returns to the position of the reflected light path 114. The focusing system may adjust the position of the substrate (e.g., tilted substrate 107) relative to the object plane 102 such that the position of the displaced reflected light path 116 on the second focus detector 125 returns to the position when the surface 105 is in focus on an emission detector (e.g., imaging detector 230 shown in FIG. 17). In some embodiments, the autofocus system may adjust the position of the substrate relative to the object plane using a dynamic focus correction method, as described herein.

Focusing lens 150 may be configured to focus the reflected light following the reflected light path 114 or the displaced reflected light path 116. Displaced reflected light following displaced reflected light path 116 that is reflected off of tilted substrate 107 (e.g., reflected at the tilted substrate 107 or reflected by the tilted substrate 107), may encounter the focus lens 150 at a different angle or position than that of reflected light (e.g., following the reflected light path 114) reflected off of the surface 105 positioned parallel to the object plane 102.

The reflected light (e.g., the reflected light or the displaced reflected light) may be split by a beam splitter 140. A portion of the reflected light may be directed along the reflected light path 114 or the displaced reflected light path 116 to a focus detector 120. The focus detector 120 may detect the reflected light (e.g., the reflected light or the displaced reflected light) and measure properties (e.g., position, intensity, spatial distribution, or a combination thereof) of the reflected light. The measured properties of the reflected light (e.g., the reflected light or the displaced reflected light) may be indicative of properties of the surface 105 or the tilted substrate 107 (e.g., substrate height or substrate tilt). In some embodiments, the detector 120 may detect a change in height resulting from a change in tilt angle. As shown in FIG. 13B, tilted substrate 107 may also have a change in height relative to the object plane 102 in addition to a change in tilt angle. In some embodiments, the position of the reflected light (e.g., the reflected light or the displaced reflected light) on the focus detector 120 may be used to quantify the height or tilt angle of the surface (e.g., the surface 105 or the tilted surface of the tilted substrate 107).

The reflected light may coincide with the focus detector 120 at discrete positions, depending on a position of the surface. For example, when the surface 105 is aligned with object plane 102 (e.g., in focus on imaging detector 230 shown in FIG. 17), the reflected light (e.g., following reflected light path 114) may encounter the focus detector 120 at a first position, and when the surface of the tilted substrate 107 is tilted relative to the object plane 102, the reflected light (e.g., following displaced reflected light path 116) may encounter the focus detector 120 at a second position. The focus illumination source 110 and the focus detector 120 may be configured such that a change in a position (e.g., a change in height, a change in tilt angle, or both) of the surface 105 relative to the object plane 102 causes a shift in the position at which the reflected light encounters the focus detector 120. For example, a change in a distance between the surface 105 and the objective 101 or atilt of the surface 105 (e.g., tilting the substrate to the tilted substrate 107 position) relative to the objective 101 may cause a displacement of the reflected light (e.g., to displaced reflected light path 116) on the focus detector 120. The autofocus system may send a signal to a focusing system in response to the displacement of the reflected light (e.g., a change from the reflected light following the reflected light path 114 to displaced reflected light following the displaced reflected light path 116) on the focus detector 120. The focusing system may adjust the position of the substrate (e.g., tilted substrate 107) relative to the object plane 102 (e.g., by adjusting the position of the substrate or the position of the object plane) such that the position of the displaced reflected light path 116 returns to the position of the reflected light path 114. The focusing system may adjust the position of the substrate relative to the object plane 102 such that the position of the reflected light path 114 on the focus detector 120 returns to the position when the substrate is in focus on an emission detector (e.g., imaging detector 230 shown in FIG. 17). The focusing system may adjust the height, tilt, or other spatial orientation of the surface 105 or the tilted substrate 107. The focusing system may adjust the surface 105 or the tilted substrate 107 to be in focus on an imaging detector (e.g., imaging detector 230 shown in FIG. 17).

A third example of a focus detection system is described with reference to FIG. 13C. The focus detection system (e.g., autofocus system) illustrated in FIG. 13C may utilize two light paths (e.g., focus light path 112 and second focus light path 113) to detect a z-position or tilt of a surface at two spatially separated regions on the surface (e.g., focus region 104 and second focus region 108). The two focus light paths may reflect off of the surface (e.g., they may be reflected at the surface or be reflected by the surface) along two reflected light paths (e.g., reflected light path 114 and second reflected light path 115). The focus detection system may include a focus detector (e.g., second focus detector 125) positioned to detect a tilt of a surface 105 relative to an object plane of an optical system (e.g., object plane 102). The focus sensor may detect a position of the two reflected light paths. The position at which the each of the reflected light paths encounters the detector may be a function of the z-position of the surface relative to the object plane. The z-position may be measured along a z-axis parallel to the optical axis. The relative positions of the at which the each of the reflected light paths encounters the detector may be a function of the tilt angle of the surface between the two spatially separated regions.

As shown in FIG. 13C, multiple focus light paths (e.g., focus light path 112 and second focus light path 113) may be generated by multiple illumination sources. For example, focus light path 112 and second focus light path 113 shown in FIG. 13C may be produced by separate illumination sources. Alternatively, multiple focus light paths may be generated by a single illumination source (e.g., focus illumination source 110) and split using a beam splitter, e.g., a polarizing beam splitter. In some embodiments, the polarizing beam splitter may be a polarizing beam splitter cube, a Wollaston prism, or a birefringent wedge. Alternatively, the illumination beam splitter may be a non-polarizing beam splitter. Two light paths may be parallel to each other, as shown in FIG. 13C. Two light paths may be divergent from each other. Two light paths may be convergent on each other.

Focus light paths 112 and 113 may encounter the surface at different locations. For example, focus light path 112 may illuminate the surface at a first focus region 104, and second focus light path 113 may illuminate the surface at a second focus region 108. As described elsewhere, a light path may include one or more optical elements (e.g., mirrors, lenses, prisms, waveplates, etc.) that manipulate the spatial position of the light (e.g., the focus light) and direct the light along the light path.

The focus light paths 112 and 113 may pass through an objective 101. The objective may direct the focus light following each respective focus light path to the surface of the surface 105. Surface 105 may reflect focus light following focus light path 112 at focus region 104 and/or reflect focus light following second focus light path 113 at focus region 108, thereby creating reflected light. The reflected light from focus region 104 may be directed along a reflected light path 114. The reflected light from the second focus region 108 may be directed along a second reflected light path 115.

In some embodiments, the surface may be tilted with respect to object plane 102, such as tilted substrate 107 (e.g., the tilted substrate is not parallel to the object plane). The objective may direct the focus light (e.g., following focus light path 112 or second focus light path 113) to the surface of the surface and encounter a focus region of the surface at the position of the tilted substrate 107. The focus light following focus light path 112 may illuminate the tilted substrate 107 in the focus region 104 on the tilted substrate. The tilted substrate 107 may reflect the focus light along the same or different light path than the planar substrate positioned parallel to the object plane 102, depending on the height of the surface at the focus region 104. The planar substrate has a planar surface 105 that is parallel to the object plane 102. For example, if the height of tilted substrate 107 at focus region 104 is aligned with the object plane 102, the light reflected by the tilted substrate 107 may follow reflected light path 114. In another example, the height of tilted substrate 107 may be below or above the object plane 102 and may displace the reflected light relative to the reflected light from a surface 105 in the object plane 102. The tilted substrate 107 may reflect light that follows displaced reflected light path 116. The focus light following second focus light path 113 may illuminate the tilted substrate 107 at the second focus region 108. The tilted substrate 107 may reflect the focus light in the second focus region 108, thereby creating reflected light. The reflected light from second focus region 108 may be directed along a second reflected light path 115.

Reflected light paths, such as 114, 115, and 116, may include one or more optical elements (e.g., mirrors, lenses, prisms, waveplates, etc.) that manipulate light (e.g., the reflected light or the displaced reflected light) to direct the light along the light path. As shown in FIG. 13C, the reflected light (e.g., the reflected light or the displaced reflected light) may follow a different light path (e.g., the reflected light path 114 or the displaced reflected light path 116), depending on the tilt angle of the surface. The displaced reflected light, reflected off of the tilted substrate 107 (e.g., reflected at a surface of the tilted substrate 107 or reflected by a surface of the tilted substrate 107) may interact with the one or more optical elements at a different angle or position than the reflected light reflected off of the surface 105 that is positioned parallel to the object plane 102. Reflected light (e.g., light following the reflected light paths 114, 115, or 116) may be reflected off one or more reflective elements, such as mirrors 135, 130, or combinations thereof. The displaced reflected light, reflected off of the tilted substrate 107 may encounter the one or more reflective elements at a different angle or position than the reflected light reflected off of the surface 105 positioned parallel to the object plane 102.

As shown in FIG. 13C, the reflected light (e.g., the reflected light or the displaced reflected light) may be split by a focus beam splitter 145. The displaced reflected light, reflected off of the tilted substrate 107, may encounter the focus beam splitter 145 at a different angle or position than the light reflected off of surface 105 positioned parallel to the object plane 102. A portion of the reflected light may be directed (e.g., split) along reflected light path 114, second reflected light path 115, or displaced reflected light path 116 to a second focus detector 125.

As described with respect to FIG. 13B, the reflected light (e.g., reflected from focus light path 112 or second focus light path 113) may coincide with the second focus detector 125 at discrete positions, depending on a position of the surface, and the focus illumination source 110 and the second focus detector 125 may be configured such that a change in a position (e.g., a change in height, a change in tilt angle, or both) of the surface 105 relative to the object plane 102 causes a shift in the position at which the reflected light encounters the second focus detector 125. When the surface 105 is aligned with the object plane 102 (e.g., in focus on imaging detector 230 shown in FIG. 17), the reflected light from the second focus light path 113 (e.g., following reflected light path 115) may encounter the second focus detector 125 at a first position; and when the surface 107 is tilted relative to the object plane 102, the reflected light (e.g., following displaced reflected light path 116) may encounter the second focus detector 125 at a second position. In some embodiments, the reflected light may encounter the detector at the same position if the height of the surface at the second focus region 108 is the same between the two positions (e.g., focus regions 104, 108 on tilted 107 or non-tilted 105 surface, respectively). The autofocus system may send a signal to a focusing system in response to the change in position of the reflected light. The autofocus system may send a signal to a focusing system in response to the value of a displacement of a reflected light path (e.g., reflected light displacement 160 indicating an amount of displacement of reflected light path 114 to displaced reflected light path 116 due to a change in height of the surface at the focus region 104). The focusing system may adjust the position of the tilted substrate 107 relative to the objective 101 such that the reflected light returns to the same value as when the surface 105 is in focus on an emission detector (e.g., imaging detector 230 shown in FIG. 17). The focusing system may adjust the position of the tilted substrate 107 relative to object plane 102 such that the position of the displaced reflected light path 116 on the second focus detector 125 returns to the position of the reflected light path 114 on the second focus detector. The focusing system may adjust the position of the tilted substrate 107 relative to object plane 102 such that the position of the displaced reflected light path 116 on the second focus detector 125 returns to the discrete position when the surface 105 is in focus on an emission detector (e.g., imaging detector 230 shown in FIG. 17).

In some embodiments, a focusing system may use multiple illumination light paths, such as the two illumination light paths illustrated in FIG. 13C. In some embodiments, a focusing system may use more than two illumination light paths. For example, a focusing system may use three, four, five, six, seven, eight, nine, ten, or more illumination light paths. The focusing system may use a series or an array of light paths to generate a line or array of illumination points on the substrate. The multiple light paths may be non-parallel, such that the light paths encounter the objective, the substrate, or both with different angles of incidence. The multiple illumination light paths may be generated by various means. In some embodiments, multiple illumination light paths may be generated by splitting a light path using an optical element (e.g., a prism or a beam splitter). In some embodiments, multiple illumination light paths may be generated using a diffraction grating. In some embodiments, multiple illumination light paths may be generated using electro-optics. The multiple light paths may be generated by any means for splitting a light path into multiple components.

A fourth example of a focus detection system is described with reference to FIG. 14. The astigmatic autofocus detection system illustrated in FIG. 14 may include a quadrant detector (e.g., quadrant detector 1401) positioned to detect a z-position of a surface 105 relative to an object plane of an optical system (e.g., object plane 102). The focus sensors may detect a shape of light reflected off of the surface (e.g., reflected at the surface or reflected by the surface) based on the relative intensities of the signals detected by each of the four quadrants of the quadrant detector. The shape of the reflected light on the quadrant detector may be a function of the z-position of the surface relative to the object plane, the tilt of the surface relative to the object plane, or both.

A light path, such as focus light path 112, may include one or more optical elements, such as cylindrical optics (e.g., cylindrical optics 1420). Cylindrical optics may comprise one or more cylindrical lenses. A cylindrical lens may be plano-cylindrical. A cylindrical lens may be plano-concave or plano-convex. A cylindrical lens may have a positive or negative curvature, and the curvature may vary. The cylindrical optics 1420 may propagate a light path (e.g., focus light path 112) in two perpendicular planes, thereby applying an astigmatic modification to the light path. The propagated light path (e.g., focus light path 112) may be asymmetrical about the optical axis upon passing through the cylindrical optics 1420.

The focus light may be split by placing a beam splitter 140 in the focus light path 112. Light reflected from surface 105 may be split by following the reflected light path 114 through a beam splitter 140. As shown in FIG. 14, the reflected light may pass through a focus lens 150, which may be configured to focus the reflected light following the reflected light path 114, as described elsewhere herein.

The reflected light may be directed along the reflected light path 114 to a quadrant detector 1401. The quadrant detector 1401 may be at an image plane of the focus lens 150. The quadrant detector 1401 may comprise four sensors arranged in a square pattern. In some embodiments, the four sensors may be four separate sensors (e.g., four photodiodes or four camera sensors). In some embodiments, the four sensors may be a single detector divided into four regions (e.g., a camera divided into four quadrants). In some embodiments, the four detectors of the quadrant detector 1401 (A, B, C, and D) measure properties (e.g., position, intensity, spatial distribution, or a combination thereof) of the reflected light independently. In some embodiments, a detector 1401 may be any optical detector capable of detecting light. The quadrant detector 1401 may detect the reflected light and measure properties (e.g., position, intensity, spatial distribution, or a combination thereof) of the reflected light. The measured properties of the reflected light may be indicative of properties of the surface 105 (e.g., substrate height or substrate tilt). In some embodiments, the position of the reflected light on the quadrant detector 1401 may be used to quantify the height or tilt angle of the surface 105. The reflected light may coincide with the quadrant detector 1401 at a discrete position when the surface 105 is in focus on an imaging detector (e.g., imaging detector 230 shown in FIG. 17). The focus illumination source 110 and the quadrant detector 1401 may be configured such that a change in a position of the surface 105 relative to the objective 101 results in a change in shape of the reflected light on the quadrant detector 1401. For example, a change in a distance between the surface 105 and the objective 101 or a tilt of the surface 105 relative to the objective 101 may cause a displacement of the reflected light on the quadrant detector 1401. The autofocus system may send a signal to a focusing system in response to the change in shape of the reflected light on the quadrant detector 1401. The focusing system may adjust the position of the surface 105 relative to the objective 101 such that the position of the reflected light on the quadrant detector 1401 returns to the discrete position when the surface 105 is in focus on an emission detector (e.g., imaging detector 230 shown in FIG. 17). The autofocus system shown in FIG. 14 may be used for determining both the focus and height profile of a surface 105 of a substrate.

At quadrant detector 1401, a shape of the reflected light incident upon the detector may be determined. In some embodiments, the shape of the reflected light on the quadrant detector may be a function of the position of the surface 105 relative to the object plane 102. The reflected light may be quantified on the quadrant detector 1401 as, for example: significantly below focus 1410, below focus 1412, in focus 1414, above focus 1416, or significantly above focus 1418. For example, if the surface 105 is far from the object plane 102, the reflected light following reflected light path 114 may be significantly elongated in quadrant detectors A and D and partially present in quadrant detectors B and C on the quadrant detector 1401, resulting in higher light intensities detected by quadrants A and D than quadrants B and C, and be determined to be significantly below focus (see 1410). In another example, if the surface 105 is below the object plane 102, the reflected light may be elongated in quadrant detectors A and D (e.g., less than in 1410) and partially present in quadrant detectors B and C (e.g., more than in 1410) on the quadrant detector 1401, resulting in higher light intensities detected by quadrants A and D than quadrants B and C, and be quantified as below focus (see 1412). In another example, if the surface 105 is aligned with the object plane 102, the reflected light may be equally distributed in quadrant detectors A, B, C, and D on the quadrant detector 1401, resulting in equal light intensities detected by all four quadrant detectors, and be quantified as in focus (see 1414). In another example, if the surface 105 is above the object plane 102, the reflected light may be elongated in quadrant detectors B and C and partially present in quadrant detectors A and D on the quadrant detector 1401, resulting in lower light intensities detected by quadrants A and D than quadrants B and C, and be quantified as above focus (see 1416). In another example, if the surface 105 is far above the object plane 102, the reflected light following reflected light path 114 may be very elongated in quadrant detectors B and C and partially present in quadrant detectors A and D on the quadrant detector 1401, resulting in lower light intensities detected by quadrants A and D than quadrants B and C, and be quantified as significantly above focus (see 1418).

In some embodiments, the defocus distance may be quantified from an intensity ratio (F) from the intensities measured by each of the four quadrants (A, B, C, and D) on the quadrant detector 1401. The intensity ratio may be calculated as follows:

$$F = \frac{( A + D ) - ( B + C )}{( A + D ) + ( B + C )}$$

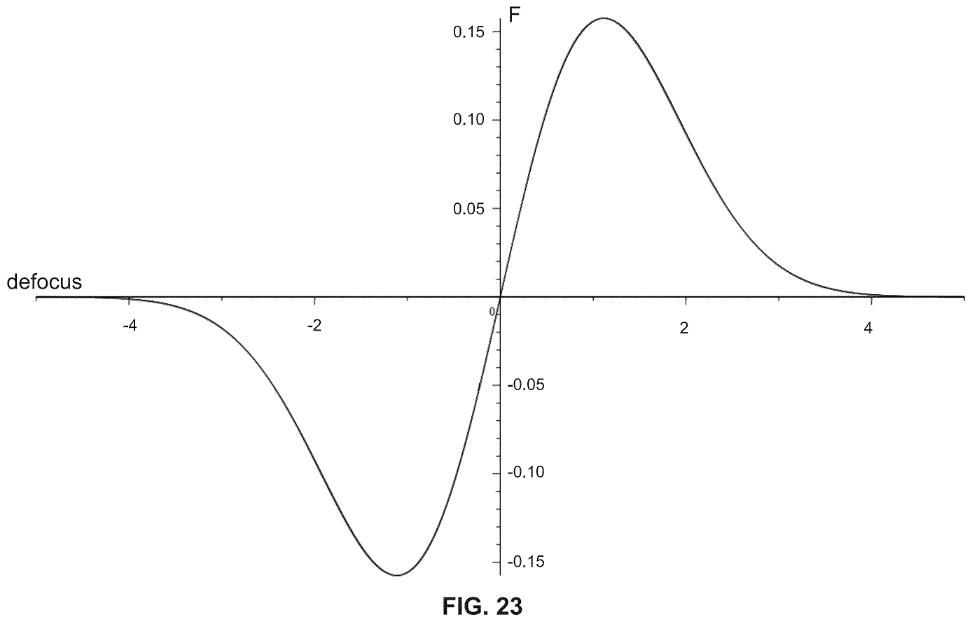

An example of intensity ratio plotted with respect to defocus distance is illustrated in FIG. 23). The position (e.g., the height or the angle tilt) of the surface 105 may be adjusted as described herein based on the determined defocus distance.

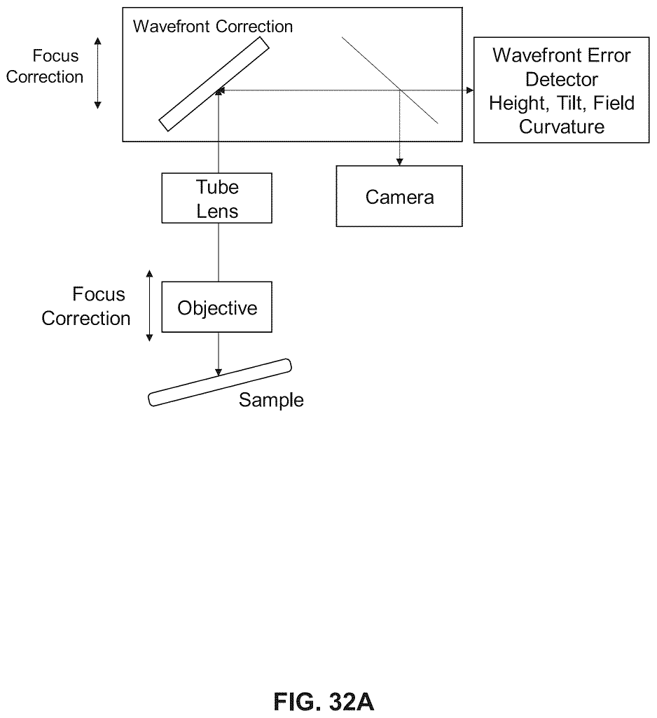

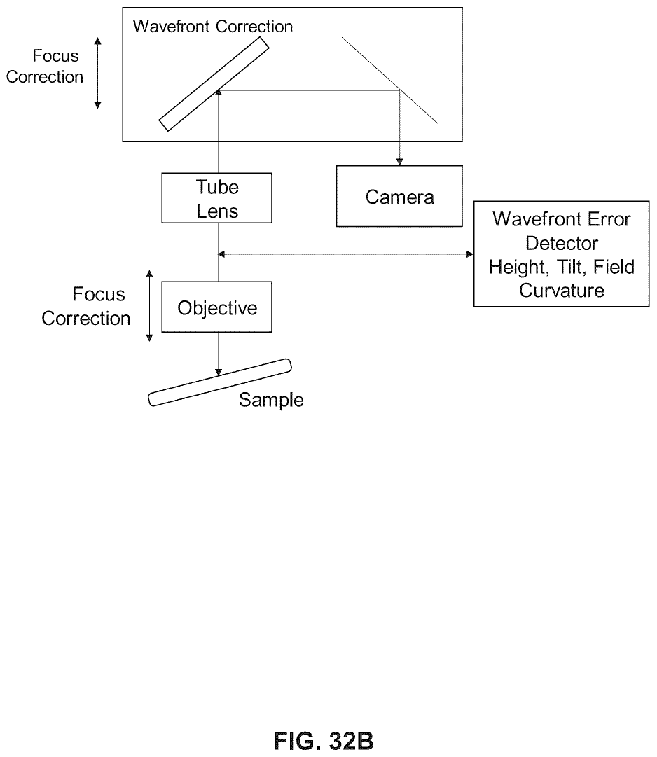

In some embodiments, a focus detection system may comprise a wavefront error detector (WED), as illustrated in FIG. 32A and FIG. 32B. The WED may detect imaging light from a sample (e.g., on a substrate) and measure wavefront irregularities, such as height variations, tilt, or field curvature. A beam splitter may be positioned in an imaging light path to split the imaging light to direct a first portion of the imaging light to an imaging detector and a second portion of the imaging light to the WED. The WED may be positioned after a wavefront correction element, as illustrated in FIG. 32A. The WED positioned after the wavefront correction element may use feedback to identify a wavefront error and determine whether the wavefront error has been corrected, for in-loop measurements. Alternatively or in addition, the WED may be positioned before a wavefront correction element, as illustrated in FIG. 32B, for out-of-loop measurements.

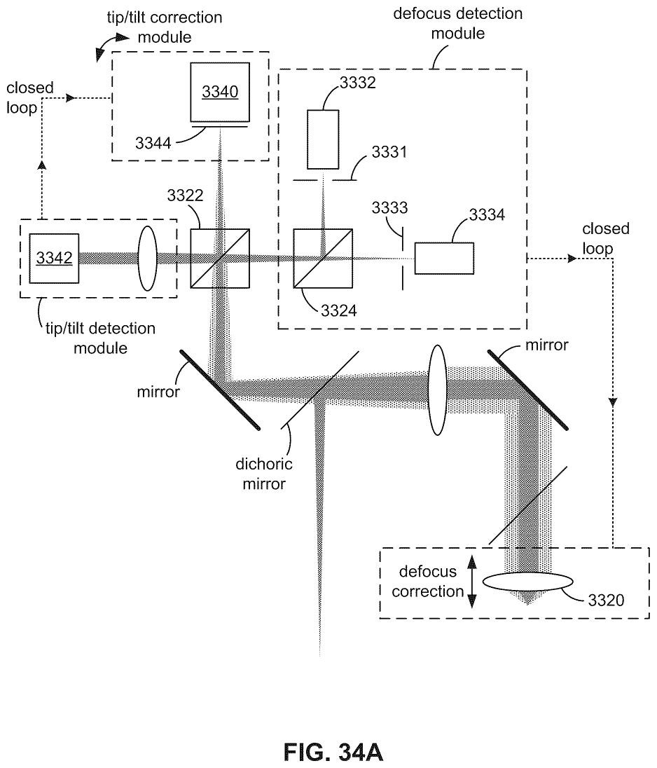

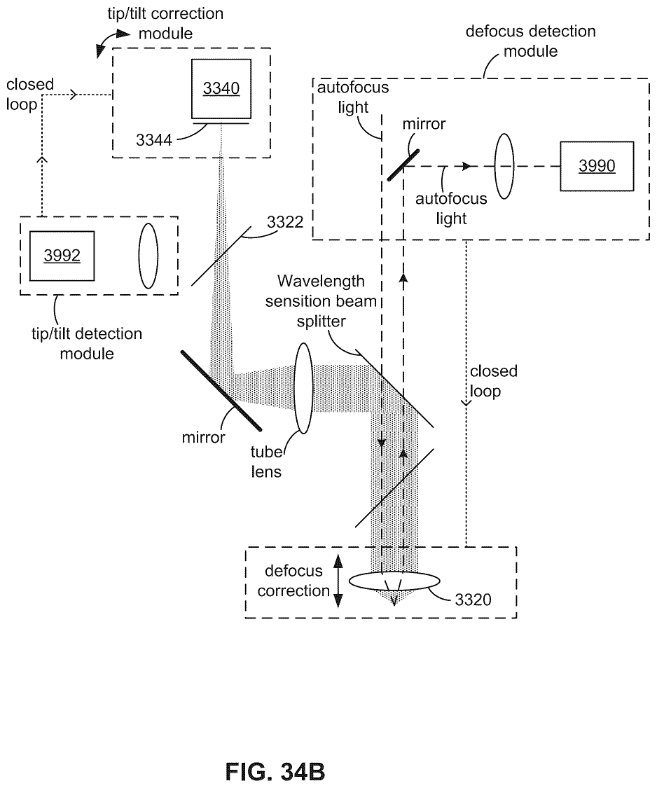

In some embodiments, a focus detection system may comprise one or more closed loops for detecting and correcting for focus errors, for example, as illustrated in FIG. 34A or FIG. 34B. A closed loop may comprise a focus detector (e.g., a quadrant detector or a photodiode) in communication with a focus correction element, such that movement of the focus correction element affects a signal received by the focus detector. The closed loop may detect the focus (e.g., z-position, tilt angle, or both) of a surface using the focus detector and adjust the focus of the surface using the focus correction element. In some embodiments, the focus correction element of the closed loop may be positioned in a focus light path ahead of the focus detector and in an imaging light path between the surface and an imaging detector (e.g., a camera, such as a TDI camera). Movement of the focus correction element in the focus light path may alter a focus illumination light traveling along the focus light path prior to encountering the focus detector. In some embodiments, the focus correction element may be the imaging detector, a mirror, a lens, an objective, the surface, or other optical element.

As shown in FIGS. 34A and 34B, a closed loop may comprise an autofocus detector (e.g., a quadrant detector) configured to detect a tilt angle of the surface and an imaging detector 3340 positioned in a focus light path between the surface and the autofocus detector. The imaging detector 3340 may tilt relative to the imaging light path and the autofocus light path to correct for the tilt angle of the surface. When the imaging detector 3340 is tilted, this may change a reflection angle of the focus light path, affecting detection of the focus illumination by the focus detector. As shown in FIGS. 34A and 34B, a closed loop may comprise an autofocus detector (e.g., a photodiode or a quadrant detector) configured to detect a z-position of the surface, and an objective 3320 positioned in a focus light path between the surface and the autofocus detector. The objective 3320 may move along the axis the imaging light path and the autofocus light path to correct for the z-position of the surface. Changing the z-position of the objective 3320 may affect the focus of the surface and detection of the focus illumination by the focus detector.

### Focus Tracking Methods

In some cases, focus tracking can be performed for any substantially planar, rotatable surface (e.g., a substrate, a wafer, a sample, etc.). For instance, a method for focus tracking may comprise: providing a surface, wherein the surface is configured to rotate with respect to an objective lens, and wherein the surface is substantially planar; providing a light beam through the objective lens to illuminate a region of the surface; during rotation of the surface, directing light reflected from the region of the surface to (i) a detector through a lens and (ii) an incident location on a sensor, wherein the reflected light is directed to the sensor in the absence of traveling through the lens; and determining, from the incident location of the reflected light on the sensor, an amount of tilt of the planar surface with respect to the objective lens.

The light beam may be emitted from a light source (e.g., an illumination source). The light beam may enter the objective lens at an angle that is parallel, or substantially parallel to an axis of the objective lens (e.g., at an angle that is substantially perpendicular to the surface). Determining the amount of tilt may comprise comparing the incident location of the reflected light to a reference incident location (e.g., where the reference incident location corresponds to a reference plane, such as a plane determined from alignment of the optical system).

In some cases, it may be useful to determine an amount of tilt without needing to refer back to a reference plane. In such cases, providing the light beam may further comprise splitting the light beam into a first light beam and a second light beam, wherein the first light beam illuminates a first region of the surface and the second light beam illuminates a second region of the surface, wherein the first and second regions do not overlap. In such cases, the first light beam enters the objective lens at an angle that is rotated X degrees from an axis of the objective lens, wherein X is greater than 0; and the second light beam enters the objective lens at an angle that is rotated Y degrees from the axis of the objective lens, wherein Y is less than 0. In some such cases, the absolute value of X is the same as the absolute value of Y. That is, the first light beam and the second beam will be rotated a same amount, but in opposite directions. In some cases, the first light beam is rotated about a first axis and the second light beam is rotated about a second axis, where the second axis is different from the first axis. In some cases, the absolute value of X is different from the absolute value of Y. For instance, in some cases, both X and Y are greater than 0; or alternatively, both X and Y are less than 0.

In such cases, directing reflected light may further comprise directing light reflected from the first region of the surface and light reflected from the second region of the surface to a first incident location and a second incident location, respectively, on the sensor. In such cases, determining the amount of tilt may further comprise determining an amount of tilt of the surface from the difference between the first incident location and the second incident location.

### Substrate Mapping

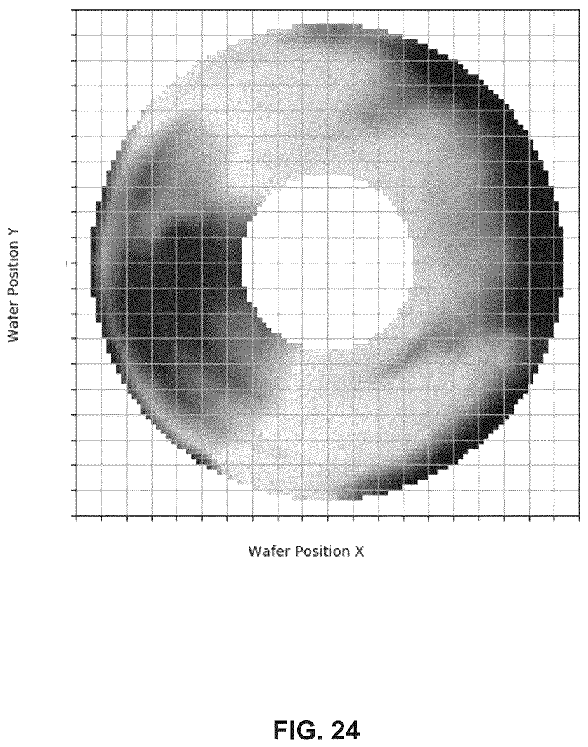

A focus detection system of the present disclosure may be used to map a surface (e.g., a planar sample, a substrate supporting a sample, or a wafer) prior to scanning. Mapping the surface may comprise correlating focus errors (e.g., differences in substrate height, tilt angle, or both relative to an object plane of a scanning system) with spatial locations on the surface. In some embodiments, mapping a surface may comprise positioning the surface in a scanning system, and rotating the surface about a rotational axis (e.g., an axis normal to the substrate surface). During rotation, a focus detection system may detect and measure a height, tilt angle, or both of a focus region on the surface relative to an object plane of the scanning system. The focus detection system may comprise a focus correction or focus detection system as described herein, for example a system illustrated in FIG. 10-FIG. 14. The height, tilt angle, or both measured at a focus region may be associated with a location on the surface. As the surface is rotated, heights, tilt angles, or both are measured at different locations across the surface and compiled into a map of the surface, also referred to as a “substrate map”. An example of a substrate map is shown in FIG. 24, where the color heat map represents height variations measured across a surface. The substrate map may subsequently be used during scanning to anticipate focus errors resulting from the substrate height or tilt angle variations and dynamically correct them (e.g., using a dynamic focus correction method described herein).

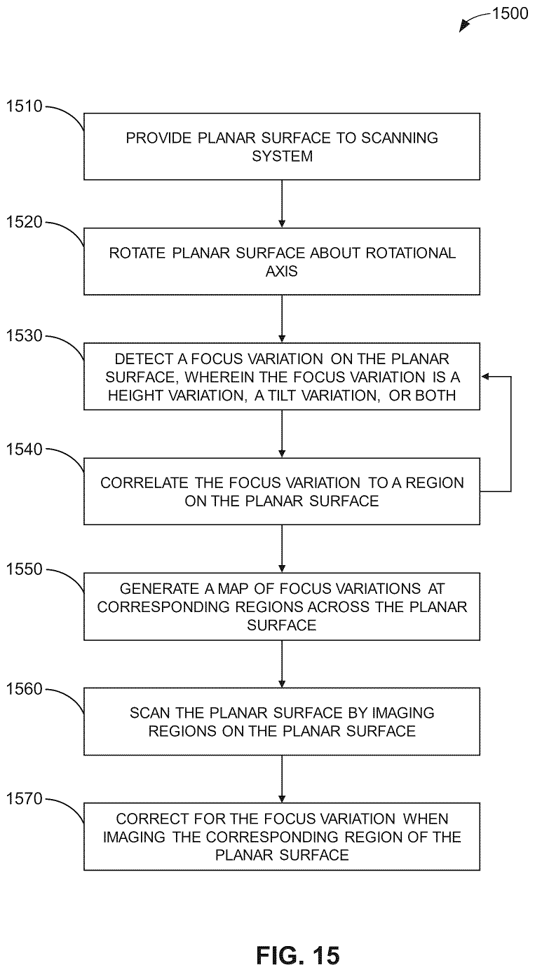

An example of a substrate mapping method 1500 is described with reference to FIG. 15. At step 1510, a surface (e.g., a surface comprising a biological analyte) is provided to a scanning system. The scanning system may be configured to scan an open substrate while the substrate is rotating. While positioned in the scanning system, the surface may be rotated about a rotational axis at step 1520. In some embodiments, the rotational axis is an axis normal to the surface of the surface. In some embodiments, the rotational axis passes through at point at or near the center of the surface. At step 1530, while the surface is rotating, a focus variation is detected on the surface using a focus detection system. The focus detection system may be a focus detection system described herein, such as a focus detection system comprising a height detector, a tilt detector, or both. In some embodiments, the focus detection system is a system illustrated in FIG. 13A, FIG. 13B, FIG. 13C, or FIG. 14. The focus variation is detected for a region or location on the surface at step 1540. Steps 1530 and 1540 are repeated at different regions as the surface is rotating, and the collected focus variations and corresponding regions are compiled at step 1550 to generate a map of focus variations at corresponding regions across the surface. The generated substrate may be used to anticipate focus variations during scanning. The mapped surface is scanned by imaging regions on the surface at step 1560 while the surface is rotating. Imaging may be performed with an imaging detector, such as a camera. In some embodiments, the imaging detector is a line-scan camera. In some embodiments, imaging is performed using an imaging system as illustrated in FIG. 17, FIG. 32A, or FIG. 32B. While scanning, focus variations may be anticipated based on the substrate map, and the focus variations may be corrected for at step 1570 (i.e., during imaging a region of the surface that corresponds to a region of the substrate map). In some embodiments, focus correction may be performed using a dynamic focus correction method, as described herein. The focus may be dynamically corrected by moving an optical element in an imaging light path (e.g., a lens, an objective, a mirror, a beam splitter, a prism, a detector, a sample stage, the surface, or combinations thereof). For example, the focus may be corrected using the dynamic focus correction method illustrated in FIG. 17, FIG. 32A, or FIG. 32B.

In some cases, scanning may be performed for a rotatable surface (e.g., a substrate, a sample, a wafer, etc.). For instance, a method of surface scanning may comprise: providing a surface, wherein the surface is configured to rotate with respect to an objective lens, and wherein the surface is substantially planar; while rotating the surface, providing a light beam through the objective lens to illuminate the surface, wherein at a first time point the light beam illuminates a first region of the surface and at a second time point the light beam illuminates a second region of the surface; and determining, for each of the first and second time points, i) a respective z-distance of the respective region relative to a focal plane of the objective lens and ii) a respective tilt angle of the respective region relative to the focal plane.

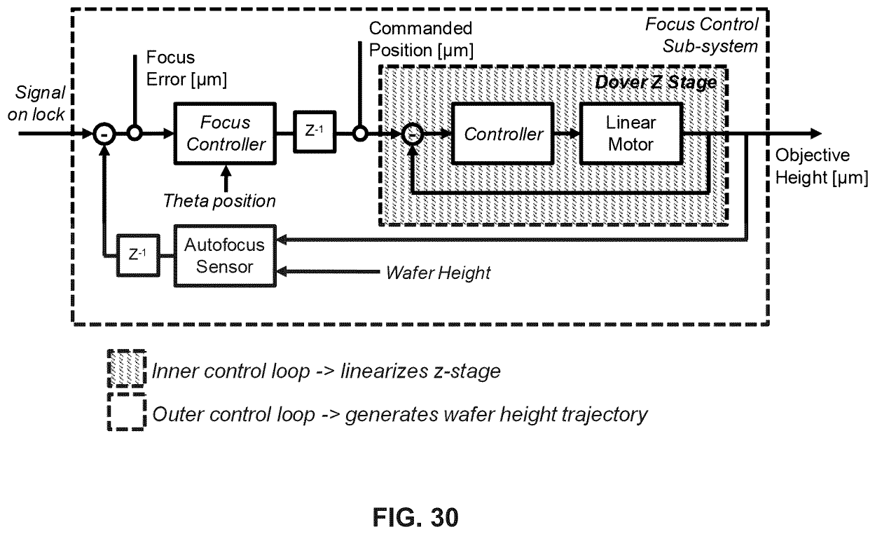

The determining can comprise comparing characteristics of light reflected from the respective region of the surface to reference characteristics. The method can further comprise repeating the rotating and determining for each of a plurality of time points. That is, for each time point, the method may comprise determining i) a respective z-distance and ii) a respective tilt angle of a respective illuminated region relative to the focal plane of the objective lens. The method can further comprise providing a map of z-distances and tilt angles for the surface (e.g., via a UI to a user or to a focus control system, such as that described with respect to FIG. 30). In some cases, the surface is substantially planar. In some cases, the surface is not planar.

### Dynamic Focus Correction

Described herein are methods of dynamically adjusting a focus of an optical system (e.g., a scanning system) to correct or improve the focus of the optical system. In some embodiments, a focus error may be determined using a focus detection system as described herein (e.g., a focus detection system illustrated in FIG. 13A, FIG. 13B, FIG. 13C, or FIG. 14). Dynamic focus correction may correct for focus errors that change over time, such as focus errors that vary across a surface or focus errors resulting from random noise (e.g., errors that are not inherent to components of the optical system or the surface being scanned or imaged). Dynamic focus correction may be used by a scanning system of the present disclosure to maintain focus on a surface. In some embodiments, the dynamic focus correction may be applied to a rotating sample.

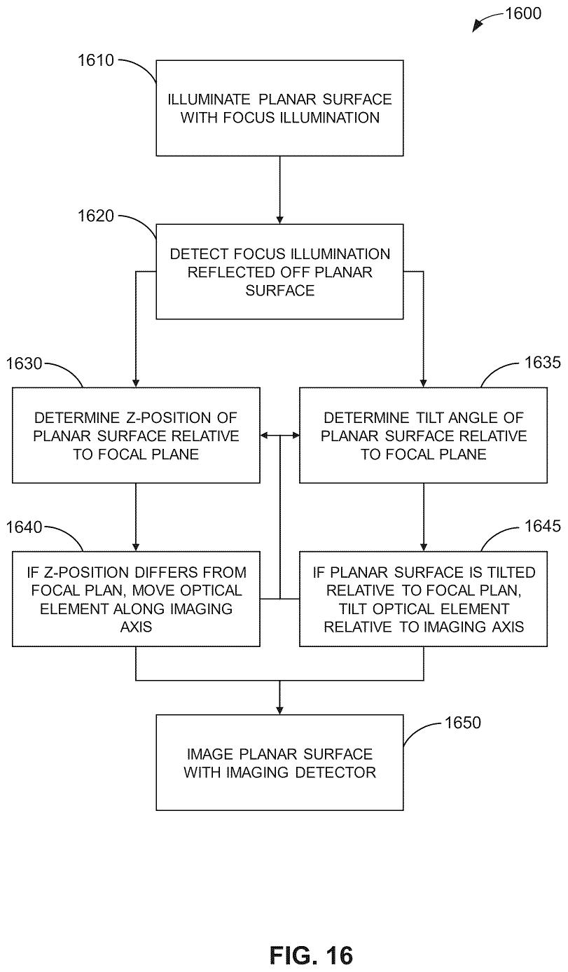

An example of a method of dynamic focus correction for a rotating surface is described with reference to FIG. 16. In method 1600 of FIG. 16, a surface (e.g., a planar sample, a substrate supporting a sample, or a wafer) is illuminated with focus light at step 1610. The focus light may be part of a focus detection system of the present disclosure. The focus detection system may be part of a scanning system, such as a rotational scanning system, as described herein. The focus light may be reflected off of the surface, and the reflected light may be detected by a focus detector at step 1620. The reflected light may be used to determine a position of the surface relative to an object plane of the optical system. At step 1630, the reflected light may be used to determine a z-position of the surface relative to the object plane at a region of the surface that is illuminated by the focus light. If the z-position of the surface differs from the location of the object plane, an optical element may be moved along or in an imaging light path at step 1640 to correct for the z-position difference. The optical element may be the surface itself, a mirror, a lens, a wedge (e.g., a wedge prism), an imaging detector, an objective lens, or other optical element positioned in a light path between the surface and an imaging detector. For example, the objective and/or the surface may be moved up or down to correct for a z-position difference. Alternatively or in addition, the imaging detector, one or more mirror, one or more lenses, or a combination may be moved parallel to the imaging light path to correct for a z-position difference.

At step 1635, the reflected light may be used to determine a tilt angle of the surface relative to the object plane at a region of the surface that is illuminated by the focus light. If the tilt angle of the surface differs from the position of the object plane, an optical element may be tilted relative to an imaging light path at step 1645 to correct for the z-position difference. The optical element may be the surface, a mirror, a lens, a wedge, an imaging detector, an objective lens, or other optical element positioned in a light path between the surface and an imaging detector. For example, the surface, the imaging detector, one or more mirrors, one or more lens, or a combination thereof may be tilted relative to the imaging light path to correct for a tilt angle difference. Once the focus has been corrected (e.g., by correcting for a z-position difference, a tilt angle difference, or both), the surface may be imaged with the imaging detector at step 1650.

An example of an optical system for dynamic focus correction is illustrated with respect to FIG. 17. As illustrated in FIG. 17, a dynamic focus correction system may comprise an imaging detector 230 positioned to compensate for focus errors 240 resulting from changes in z-position and/or tilt angle of a surface 105 relative to an object plane 102 of the optical system. The imaging detector may be configured to move (e.g., shift or tilt) relative to an imaging light path 220 directed from the surface to apply a focus correction 250 to correct for the focus error. In some embodiments, the optical system may be used to implement a motionless focus correction by tilting the detector relative to the imaging light path without shifting the detector relative to the light path.

As shown in FIG. 17, an excitation light source 201 is configured to emit light along an excitation light path 210. An excitation light source 201 may be configured to emit light, for example coherent light such as laser light. The excitation light source 201 may comprise a light emitting diode (LED). The excitation light source 201 may comprise a laser. A laser may be a single-mode laser source, a multi-mode laser source, a laser diode, a continuous wave laser, or a pulsed laser. An excitation light source 201 may emit excitation light. Laser-emitted excitation light may be a Gaussian or approximately Gaussian beam. In some embodiments, an excitation light may be collimated. In some cases, an excitation light may be manipulated to provide a laser line (e.g., using one or more Powell lenses or cylindrical lenses). The excitation light source 201 may be coupled to an optical fiber. The excitation light from the source may comprise visible light, infrared light, or ultraviolet light.

A light path, such as excitation light path 210, may include one or more optical elements (e.g., mirrors, lenses, prisms, waveplates, etc.) that manipulate the light (e.g., the excitation light) to direct the light along the light path. The excitation light path 210 may include one or more reflective elements, such as mirrors 135, that reflect the excitation light. In some embodiments, the excitation light may be reflected off a reflective element at a 90° angle. In some embodiments, the excitation light may be reflected off a reflective element at an angle from about 0° to 45°, from about 45° to 90°, from about 90° to 135°, from about 45° to about 135°, or from about 135° to 180°. In some embodiments, the excitation light may be reflected off a series of reflective elements, such as mirrors 135, to manipulate the spatial position of the focus illumination light following the excitation light path 210.

The excitation light path 210 may pass through an objective 101. In some embodiments, the objective 101 may be an immersion objective or an air objective. In some embodiments, the objective is immersed in water, buffer, aqueous solution, oil, organic solvent, index matching fluid, or other immersion fluid. The objective may be a 10×, 20×, 50×, or 100× objective. The objective 101 may be configured to magnify a sample, such as surface 105. The objective 101 may have an object plane 102 corresponding to a plane at which an object (e.g., surface 105) is in focus on a detector (e.g., imaging detector 230) optically coupled to the objective. The objective may direct the excitation light (e.g., following excitation light path 210) to the surface of the surface 105. The excitation light may illuminate the surface 105 in the focus region 104. Upon illumination, the surface 105 may produce an imaging light directed along an imaging light path 220. In some embodiments, the imaging light may be a fluorescence emission produced upon excitation of a sample on the surface 105 by the excitation light following excitation light path 210.

In some embodiments, a sample (e.g., surface 105, a planar sample, a substrate supporting a sample, or a wafer) may be in a different plane than the object plane 102, such as out-of-focus substrate 106. The objective may direct the excitation light (e.g., following excitation light path 210) to the surface and encounter a focus region of the surface at the position of the out-of-focus substrate 106. The excitation light may illuminate the out-of-focus substrate 106 in the focus region 104 on the out-of-focus substrate. Upon illumination, the out-of-focus substrate 106 may produce an imaging light along a different light path having a different focal position than the surface 105 positioned parallel to the object plane 102. In some embodiments, the imaging light may be a fluorescence emission produced upon excitation of a sample on the out-of-focus substrate 106 by the excitation light following excitation light path 210. The light emitted by the out-of-focus substrate 106 may follow out-of-focus imaging light path 225. The out-of-focus imaging light path 225 may encounter imaging detector 230 at a different position and with a different focus than the imaging light path 220 reflected off of the surface 105 (e.g., reflected at the surface 105 or reflected by the surface 105) positioned parallel to the object plane 102. The out-of-focus imaging light path 225 may encounter imaging detector 230 at a position displaced by focus correction 250 from the imaging light path 220. The out-of-focus substrate 106 may be displaced from the object plane 102 by a focus error 240. The out-of-focus substrate 106 may be vertically displaced from the object plane 102 by a focus error 240.

A light path, such as imaging light path 220 or out-of-focus imaging light path 225, may include one or more optical elements (e.g., mirrors, lenses, prisms, waveplates, etc.) that manipulate the light (e.g., the imaging light directed from the substrate) to direct the light along a light path (e.g., imaging light path 220 or out-of-focus imaging light path 225). As shown in FIG. 17, the imaging light may follow a different light path (e.g., imaging light path 220 or out-of-focus imaging light path 225), depending on the height or other position (e.g., tilt angle) of the surface. The out-of-focus imaging light path 225, directed from the out-of-focus substrate 106, may interact with the one or more optical elements at a different angle or position that the imaging light path 220 directed from the surface 105 position parallel to the object plane 102. The imaging light or the imaging light that is out-of-focus (e.g., following the imaging light path 220 or out-of-focus imaging light path 225) may be reflected off one or more reflective elements, such as mirror 135 or a mirror, or combinations thereof. The out-of-focus imaging light path 225, directed from the out-of-focus substrate 106, may encounter the one or more reflective elements at a different angle or position that the imaging light path 220 directed from of the surface 105 positioned parallel to the object plane 102. In some embodiments, the imaging light or the imaging light that is out-of-focus may be reflected off a mirror 135 at a 90° angle. In some embodiments, the imaging light following the imaging light path 220 or the out-of-focus imaging light path 225 is reflected off a series of mirrors 135 to manipulate the spatial position of the imaging light following the imaging light path 220 or the out-of-focus imaging light path 225. The imaging light following the imaging light path 220 or the out-of-focus imaging light path 225 may be reflected off a mirror 135 at a 90° angle. The imaging light following the imaging light path 220 or the out-of-focus imaging light path 225 may be reflected off a reflective element (e.g., mirror 135) at a 90° angle. In some embodiments, the imaging light following the imaging light path 220 or the out-of-focus imaging light path 225 may be reflected off a reflective element at an angle from about 0° to 45°, from about 45° to 90°, from about 90° to 135°, from about 45° to about 1350, or from about 135° to 180°.

The imaging light may coincide with the imaging detector 230 with a focus that depends on a position of the surface. For example, when the surface 105 is aligned with the object plane 102 (e.g., in focus on imaging detector 230), the imaging light (e.g., following imaging light path 220) may be in focus when it encounters the imaging detector 230 at a first position, producing an in-focus image on the imaging detector. When the surface is below or above the object plane 102, or tilted with respect to the object plane 102, such as out-of-focus substrate 106, the imaging light (e.g., following the out-of-focus imaging light path 225) may be out-of-focus when it encounters the imaging detector 230 at a second position, producing an out-of-focus image on the imaging detector. The excitation light source 201 and the imaging detector 230 may be configured such that if a surface 105 is in the object plane 102, the imaging detector detects imaging light following the imaging light path 220. The excitation light source 201 and the imaging detector 230 may be configured such that a change in position (e.g., a change in height, a change in tilt angle, or both) of the surface 105 relative to the object plane 102 causes a shift in the position at which the imaging light encounters the imaging detector. For example, if the out-of-focus substrate 106 is displaced from the object plane 102 by focus error 240, the imaging detector 230 detects out-of-focus imaging light following the out-of-focus imaging light path 225, producing an out-of-focus image. In some embodiments, the focus error 240 may be detected by a focus detection system of the present disclosure (e.g., focus detection systems illustrated in FIG. 13A, FIG. 13B, FIG. 13C, or FIG. 14) or a focus detection method of the present disclosure (e.g., focus detection method illustrated in FIG. 16). The imaging detector 230 may be repositioned in response to the focus error 240. For example, the imaging detector 230 may be repositioned to correct the focus by an amount corresponding to focus correction 250 to return the focal point of out-of-focus imaging light path 225 back to the focal point of imaging light path 220. In some embodiments, the imaging detector 230 may be moved parallel to an imaging light path (e.g., imaging light path 220 or out-of-focus imaging light path 225) to correct for a focus error. In some embodiments the imaging detector 230 may be moved perpendicular to an imaging light path (e.g., imaging light path 220 or out-of-focus imaging light path 225) to correct for a focus error. In some embodiments the imaging detector 230 may be tilted relative to an imaging light path (e.g., imaging light path 220 or out-of-focus imaging light path 225) to correct for a focus error. In some embodiments, imaging detector 230 may implement a combination of perpendicular movements, parallel movements, or tilt movements to correct for a focus error. In some embodiments, a focus error may be corrected by moving a mirror and/or the objective positioned in the imaging light path, as illustrated in FIG. 32A and FIG. 32B.

In some embodiments, the imaging detector 230 may be positioned such that the imaging light encounters the detector at an angle that is less than 90°, as illustrated in FIG. 17. The imaging detector 230 may be positioned in the imaging light path such that a change in height (e.g., focus error 240) of the surface 105 results in a shift (e.g., focus correction 250) of imaging light following light path 220 on the imaging detector 230. The imaging detector 230 can be angled such that the path length of the focusing light path changes depending on where the focus light encounters the imaging detector. In some embodiments, the angle of the detector 230 may be positioned for motionless focus correction such that, when a change in height of the surface 105 causes a translation of the imaging light on the detector 230, the change in path length due to the tilt angle of the detector corrects for the focus error caused by the change in height of the surface 105. In some cases, this height correction can be combined with tilt correction, as described elsewhere herein.

### Camera Corrections

Imaging a rotating surface, such as using a scanning system of the present disclosure, may present challenges due to image distortions resulting from the movement of the surface. Detectors designed to image moving surfaces, such as line-scan cameras, may be configured to image surfaces moving at a uniform velocity across the surface. However, when imaging a rotating surface using a stationary detector, the linear velocity of a given region of the surface relative to the detector is a function of the radius of the region from the rotational axis of the surface. This radius, and thus the linear velocity, may vary across the field of view of the detector, resulting in image distortions.

Prior optical imaging systems have utilized line-scan cameras, such as time delay and integration (TDI) cameras to achieve high duty cycles and maximum integration times per field point. A TDI camera may use a detection principle similar to a charge coupled device (CCD) camera. Compared to a CCD camera, the TDI camera may shift electric charge, row by row, across a sensor at the same rate as an image traverses the image plane of the camera. In this manner, the TDI camera may allow longer image integration times while reducing artifacts such as blurring that may be otherwise associated with long image exposure times. A TDI camera may perform integration while simultaneously reading out and may therefore have a higher duty cycle than a camera that performs these functions in a serial manner. Use of a TDI camera to extend integration times may be important for high throughput fluorescent samples, which may be limited in signal production by fluorescent lifetimes. For instance, alternative imaging techniques, such as point scanning, may be precluded from use in high throughput systems as it may not be possible to acquire an adequate number of photons from a point in the limited amount of integration time required for high speeds due to limits imposed by fluorescence lifetimes of dye molecules.

### Multi-Clocking Differential Triggering

Typically, when a time delay integration (TDI) sensor scans a curved path, it may only be able to shift charge (commonly referred to as clocking or line triggering) at the correct rate for a single velocity. For instance, the TDI sensor may only be able to clock at the correct rate along an arc located at a particular distance from the rotational axis (center of rotation). Locations closer to the rotational axis may clock too quickly, while locations farther from the rotational axis may clock too slowly. In either case, the mismatch between the rotational speed of the rotating system and the clock rate of the TDI sensor may cause blurring that varies with the distance of a location from the rotational axis. This effect may be referred to as tangential velocity blur. The tangential velocity blur may produce an image distortion of a magnitude a defined by Equation (1):

$$σ = \frac{hw}{2 R} = \frac{A}{2 R}$$

where h, w, and A are the effective height, width, and area, respectively, of the TDI sensor projected to the object plane. These values may be adjusted using one of more optical elements (e.g., lenses, prisms, mirrors, etc.). R is the distance of the center of the field from the rotational axis. The effective height, width, and area of the sensor are the height, width, and area, respectively, that produce signal. In the case of fluorescence imaging, the effective height, width, and area of the sensor may be the height, width, and area, respectively, that correspond to illuminated areas on the sample. Consequently, when imaging rotating systems, TDI systems with relatively smaller image sensors may have to be selected to minimize the tangential velocity blur effect, which may hinder goals to achieve simultaneous high-sensitivity and high-throughput imaging.

To address this problem, provided is a scanning system that is modularized, each sensor module capable of clocking at different rates. This mode of operation by a scanning system may be referred to herein as multi-clocking or differential triggering. Several individual sensor modules, which may or may not be in a single line, can be disposed at differing radii from a rotational axis, and each sensor module may be configured to clock at an independent rate based on its radial position from a rotational axis. For example, a sensor module disposed closer to the rotational axis may be clocked slower than a module disposed farther from the rotational axis. A single sensor may comprise multiple independently-clocking sensor modules. Multiple sensors may comprise multiple independently-clocking sensor modules. For example, a scanning system may comprise a single sensor (e.g., a camera) that comprises a plurality of segments or blocks, each segment or block acting as an independently-clocking sensor module. In another example, the scanning system may comprise multiple sensors, each sensor acting as an independently-clocking sensor module. A scanning system may comprise any number of sensors, such as at least and/or at most 1, 2, 3, 4, 5, 6, 7, 8, 9, 10, 11, 12, 13, 14, 15, 16, 17, 18, 19, 20, 30, 40, 50, 60, 70, 80, 90, 100 or more sensors. A scanning system may comprise any number of sensor modules, such as at least and/or at most 1, 2, 3, 4, 5, 6, 7, 8, 9, 10, 11, 12, 13, 14, 15, 16, 17, 18, 19, 20, 30, 40, 50, 60, 70, 80, 90, 100 or more between any number of sensors. The individual sensor modules may be arranged linearly, or non-linearly, along a radial axis or non-radial axis with respect to a rotational axis.

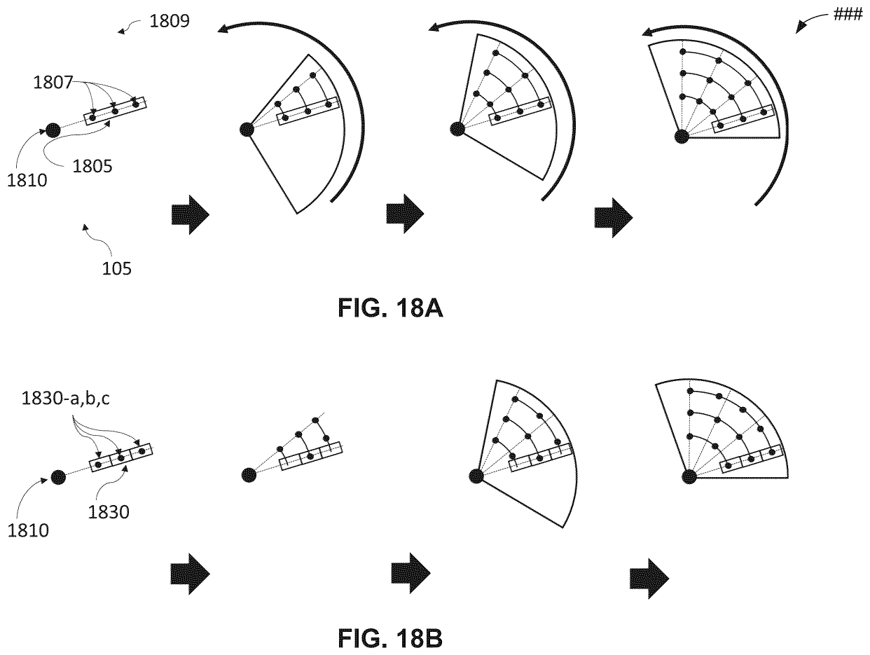

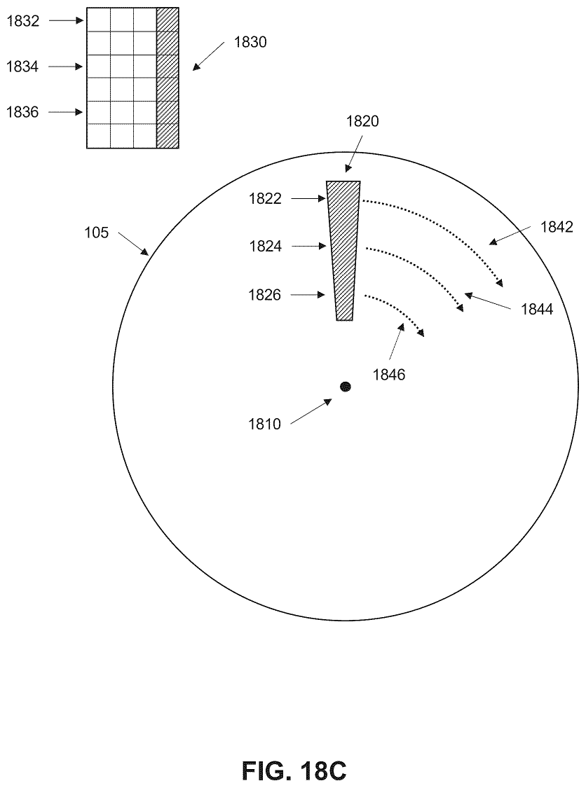

FIG. 18A and FIG. 18B illustrate clocking schematics for a single TDI sensor module and multiple modularized TDI sensor modules, respectively. An object, such as a surface 105, is being rotated around rotational axis 1810 (or center of rotation) in a counterclockwise direction 1809.

In FIG. 18A, a single TDI sensor module 1805 is projected on the object plane. For the purposes of this illustration, the black dots 1807 track three locations on the object plane, each at a different radial distance from the rotational axis, each time the TDI sensor module 1805 is clocked. From left to right, FIG. 18A shows the cumulative progression of the clocking locations such that the rightmost schematic shows the cumulative clocking locations after four clocking events. It can be seen that even though the TDI sensor projection has tracked different length arcs at each of the different radial distances, there is a same number of clocked locations for each arc path (four locations). This means that compared to the middle arc path, the smallest radial distance arc path clocked faster (shorter distance covered between clocking) and the largest radial distance arc path clocked slower (longer distance covered between clocking), resulting in blurring.

In FIG. 18B, multiple modularized TDI sensor modules 1830 (e.g., three sensor modules 1830-a, 1830-b, and 1830-c) are arranged in a line such that each sensor module is placed at a different radial distance from the rotational axis 1810. Each modularized sensor module is configured to clock at an independent rate based on the radial distance of its location. From left to right, FIG. 18B shows the cumulative progression of the clocking locations, with each snapshot illustrated when the middle sensor is clocking. It can be seen that each modularized sensor is clocking at a different rate, such that at the rightmost schematic timepoint, the sensor at the smallest radial distance with the shortest arc path has clocked three times, the sensor at the medium radial distance with the middle arc path has clocked four times, and the sensor at the largest radial distance with the longest arc path has clocked five times. It will be appreciated that the number of triggering has been simplified (e.g., rounded up to whole numbers) for the purposes of clarity in this figure. Compared to the configuration of FIG. 18A, blurring can be reduced at the scanning path of smallest radial distance arc path and the largest radial distance arc path.

A scanning example according to FIG. 18B is further illustrated in FIG. 18C, where an elongated region 1820 corresponding to a field of view of a portion of a rotating surface 105 rotating about a rotational axis 1810 may be imaged by a line-scan detector (e.g., TDI sensor modules 1830). A first sub-region 1822 of the elongated region 1820 may be imaged by a first sensor module 1832 on the TDI sensor modules 1830. A second sub-region 1824 of the elongated region 1820 may be imaged by a second sensor module 1834 on the TDI sensor modules 1830. A third sub-region 1826 of the elongated region 1820 may be imaged by a third sensor module 1836 on the TDI sensor modules 1830. The first sub-region 1822 may be moving at a first linear velocity 1842 relative to the TDI sensor modules 1830. The second sub-region 1824 may be moving at a second linear velocity 1844 relative to the TDI sensor modules 1830. The third sub-region 1826 may be moving at a third linear velocity 1846 relative to the TDI sensor modules 1830.

If the sensor modules of the line-scan detector, including the first sensor module 1832, the second sensor module 1834, and the third sensor module 1836 are triggering at the same rate, at least some of the sensor modules will be triggering out of phase with the motion of the region they are imaging due to the differences in linear velocity of the sub-regions of the elongated region 1820 detected by the TDI sensor modules 1830. For example, if the first sensor module 1832, the second sensor module 1834, and the third sensor module 1836 are triggering at a rate that matches the first linear velocity 1842, the second sensor module 1834 and the third sensor module 1836 will be triggering out of phase with the second linear velocity 1844 and the third linear velocity 1846, respectively. If the first sensor module 1832, the second sensor module 1834, and the third sensor module 1836 are triggering at a rate that matches the second linear velocity 1844, the first sensor module 1832 and the third sensor module 1836 will be triggering out of phase with the first linear velocity 1842 and the third linear velocity 1846, respectively. If the first sensor module 1832, the second sensor module 1834, and the third sensor module 1836 are triggering at a rate that matches the third linear velocity 1846, the first sensor module 1832 and the second sensor module 1834 will be triggering out of phase with the first linear velocity 1842 and the second linear velocity 1844, respectively. As described herein, the individual sensor modules (e.g., the first sensor module 1832, the second sensor module 1834, and the third sensor module 1836) of the TDI sensor modules 1830 may be triggered at different times to match the different linear velocities of the individual sub-regions (e.g., the first sub-region 1822, the second sub-region 1824, and the third sub-region 1826) imaged by each of the individual sensor modules, referred to herein as “multi-clocking”.

A scanning system may provide any total resolution, such as at least 1k, 2k, 3k, 4k, 5k, 6k, 7k, 8k, 9k, 10k, 11k, 12k, 13k, 14k, 15k, 16k, 17k, 18k, 19k, 20k, 21k, 22k, 23k, 24k, 25k, 26k, 27k, 28k, 29k, 30k, 31k, 32k, 33k, 34k, 35k, 36k, 37k, 38k, 39k, 40k, 50k, or 60k or more columns. For example, one or more sensors in the scanning system, comprising any number of independently-triggering sensor modules, may have a total combined resolution of at least 1k, 2k, 3k, 4k, 5k, 6k, 7k, 8k, 9k, 10k, 11k, 12k, 13k, 14k, 15k, 16k, 17k, 18k, 19k, 20k, 21k, 22k, 23k, 24k, 25k, 26k, 27k, 28k, 29k, 30k, 31k, 32k, 33k, 34k, 35k, 36k, 37k, 38k, 39k, 40k, 50k, or 60k or more columns. An individual sensor module may have a smaller resolution than the total resolution of the scanning system, and the respective resolutions of the multiple individual sensor modules may sum up to provide the total resolution of the scanning system. Individual sensor modules in a scanning system may have the same respective resolutions with each other and/or different resolutions. It will be appreciated that a scanning system that provides a combined x resolution may be divided up into any number of individual modules with <x resolution, where the individual resolutions may or may not be the same as each other. In an example, a scanning system has a combined 8k resolution, the scanning system comprising four 2k-resolution sensor modules. In another example, a scanning system has a combined 16k resolution, the scanning system comprising eight 2k-resolution sensor modules. In another example, a scanning system has a combined 16k resolution, the scanning system comprising four 4k-resolution sensor modules. In another example, a scanning system has a combined 16k resolution, the scanning system comprising three 1k resolution sensor modules, one 3k resolution module, and five 2k resolution sensor modules. An individual sensor module may be configured to trigger at any independent frequency, for example, at least and/or at most about 100, 200, 300, 400, 500, 600, 700, 800, 900, 1000, 2000, 3000, 4000, 5000, 6000, 7000, 8000, 9000, 104, 2×10⁴, 3×10⁴, 4×10⁴, 5×10⁴, 6×10⁴, 7×10⁴, 8×10⁴, 9×10⁴, 10⁵, 2×10⁵, 3×10⁵, 4×10⁵, 5×10⁵, 6×10⁵, 7×10⁵, 8×10⁵, 9×10⁵, 10⁶, 2×10⁶, 3×10⁶, 4×10⁶, 5×10⁶ hertz (Hz) or more. Any two individual sensor modules in a scanning system may be configured to trigger at the same and/or different frequencies.

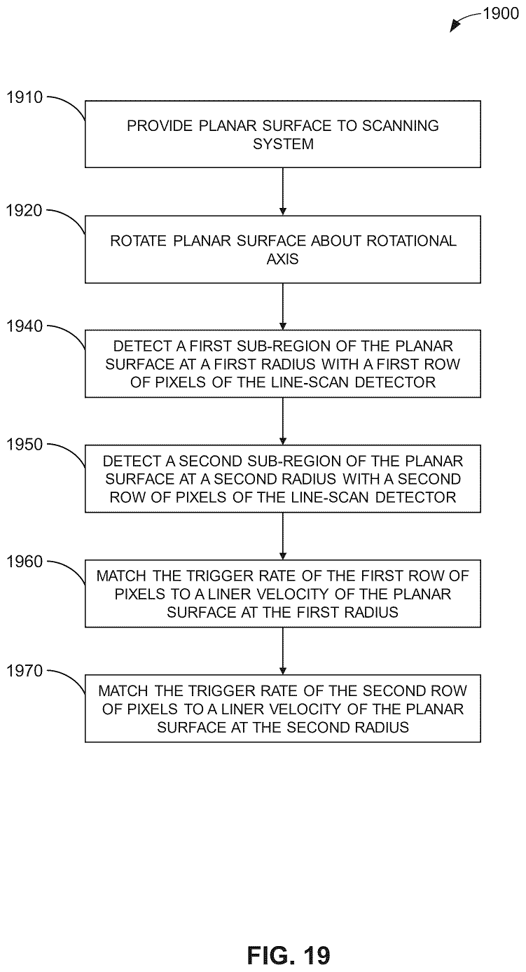

A method of multi-clocking a detector (e.g., a line-scan detector) to match different linear velocities of a rotating surface is described with reference to FIG. 19. As illustrated in method 1900 of FIG. 19, a surface may be provided to a scanning system, such as a rotational scanning system of the present disclosure, at step 1910. The surface may be rotated about a rotational axis at step 1920. In some embodiments, the rotational axis may be normal to the surface such that the surface rotates in the plane of the surface. In some embodiments, the rotational axis may be located at or near the center of the surface (e.g., at or near the center of a circular substrate). While rotating, an elongated region of the surface (e.g., as illustrated in FIG. 18C) may be imaged using a line-scan detector comprising a series of sensor modules (e.g., the three sensor modules illustrated in 1830 in FIG. 18B). A first sub-region of the elongated region on the surface may be detected by a first sensor module of the TDI sensor modules at step 1940. A second sub-region of the elongated region on the surface may be detected by a second sensor module of the line-scan detector at step 1950. At step 1960, the trigger rate of the first sensor module may be matched to a linear velocity of the first sub-region. At step 1970, the trigger rate of the first sensor module may be matched to a linear velocity of the second sub-region. Step 1940, step 1950, step 1960, step 1970, or combinations thereof (e.g., step 1940 and step 1960) may be repeated to match third, fourth, fifth, sixth, seventh, eighth, ninth, tenth, or more sensor module trigger rates to third, fourth, fifth, sixth, seventh, eighth, ninth, tenth, or more linear velocities, respectively. In another example, step 1940 and step 1960 may be repeated for each pixel row of a 24,000-pixel resolution TDI camera to match 24,000 different linear velocities. In another example, step 1940 and step 1960 may be repeated for each sensor module of an 8,000-pixel resolution TDI camera to match 8,000 different linear velocities. A sensor module may comprise one or more pixel rows of a TDI camera. Matching the trigger rate of individual pixel rows of a line-scan detector to the linear velocities of the sub-regions imaged by the corresponding pixel row, referred to as multi-clocking, may reduce motion blur on the detector.

### Computer Systems

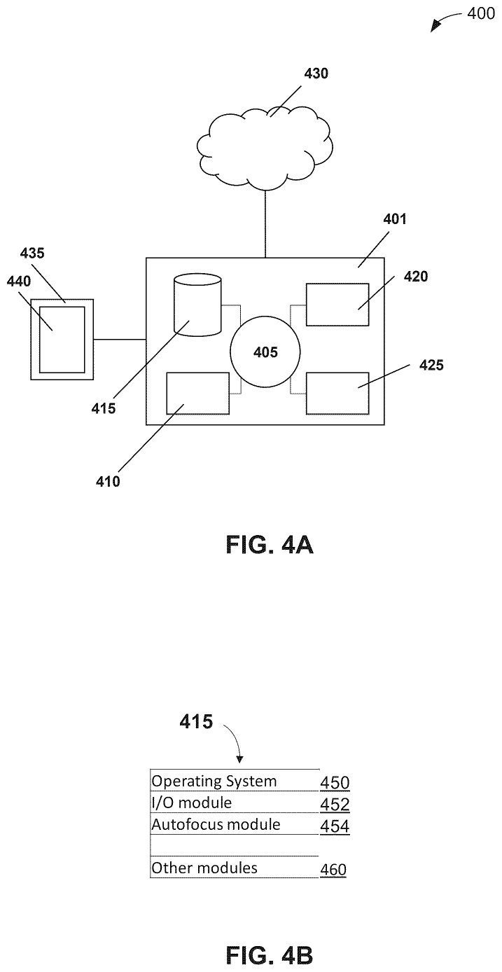

The present disclosure provides computer systems that are programed to implement systems, methods, and devices of the present disclosure. Beneficially, the systems and methods of the present disclosure may facilitate automated imaging of a sample with minimum user intervention, or in some cases, with lack of user intervention, after initiation of the automated process. FIG. 4A is a block diagram of an exemplary computer system 400 that is programmed or otherwise configured for optically inspecting (e.g., detecting) signals from a sample (e.g., an analyte) in accordance with embodiments of the present disclosure. System 400 can be a host computer connected to a network. System 400 can be a client computer or a server. In some implementations, system 400 can comprise or communicate with one or more processors 405, one or more communication interfaces such as input/output interface 440 and network interface 420, memory 415 for storing programs and instructions for execution by the one or more processors, and one or more communication buses for interconnecting these components.

In some implementations, input/output interface 440 (e.g., a user interface) includes a display and input devices such as a keyboard, a mouse, a touchscreen, or a track-pad. For example, the input/output interface 440 may be configured to provide detection results to a user and/or to receive user input, such as user instructions. In some instances, system 400 can communicate with one or more remote computer systems (e.g., through network 430). For instance, system 400 can communicate with a remote computer system of a user.

In some implements, memory 415 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. In some implementations, memory 415 includes one or more storage devices remotely located from the one or more processors 405. In some implementations, memory 415, or alternatively the non-volatile memory device(s) within memory 415, comprises a non-transitory computer readable storage medium. The components of system 400 can be connected in any suitable manner, e.g., via a physical bus or wirelessly.

Methods and systems of the present disclosure can be implemented by way of one or more algorithms. An algorithm can be implemented by way of software upon execution by the one or more processors 405. In some implementations, memory 415 or alternatively the non-transitory computer readable storage medium of memory 415 stores the following programs, modules and data structures, instructions, or a subset thereof (as illustrated in FIG. 4B):

Operating System 450 that includes procedures for handling various basic system services and for performing hardware dependent tasks.

I/O module 452 that includes procedures for handling various basic input and output functions through one or more input and output devices.

Autofocus module 454 that includes instructions and procedures for maintaining focus of an optical system during scanning of a substrate.

Other modules 460 that include instructions for handling other functions and aspects described herein

FIG. 4A is merely illustrative of the structures of system 400. A person skilled in the art would recognize that particular embodiments of system 400 may include more or fewer components than those shown. One or more modules may be divided into sub-modules, and/or one or more functions may be provided by different modules than those shown.

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

The term “analyte,” as used herein, generally refers to an object that is directly or indirectly analyzed during a process (e.g., a chemical process, an imaging process, etc.). An analyte may originate (and/or be derived) from a sample (e.g., a biological sample). For example, an analyte may be or comprise a molecule, a macromolecule (e.g., nucleic acid, carbohydrate, protein, lipid), a cell, a tissue or tissue sample, or any combination thereof. In addition, an analyte may be or comprise a synthetic version or variant of any of the above. Processing an analyte may comprise conducting a chemical reaction, biochemical reaction, enzymatic reaction, hybridization reaction, polymerization reaction, etc. (or a combination thereof) in the presence of or on the analyte. Processing an analyte may comprise physical and/or chemical manipulation of the analyte and detection thereof. An analyte may be indirectly or directly coupled to a substrate.

In a specific example, an analyte may comprise a nucleic acid, where the nucleic acid is derived or obtained from a biological sample (e.g., a cell, a tissue sample, etc.) and where the nucleic acid is immobilized a substrate. Processing such an analyte may comprise performing a sequencing reaction of the analyte and detecting the results of such a reaction (e.g., detecting the incorporation or lack thereof of one or more nucleic acids into a growing primer molecule that is hybridized to a template analyte). Such detection may comprise determining the presence of, amount of, change in, or absence of fluorescence (e.g., a fluorescent label, a Forster resonance energy transfer (FRET) interaction, etc.) or charge (e.g., a chemical charge).

As used herein, a “detector” refers to device capable of detecting or measuring a signal (e.g., a signal derived from analyte processing). In some cases, a detector may be an electronic device that is configured to detect electromagnetic radiation (e.g., radiation incident upon one or more components of the detector). A detector may comprise a single sensor or a plurality of sensors. A detector may detect one or more signals. Detection may comprise continuous area scanning. A continuous area scanning detector may comprise a time delay and integration (TDI) charge coupled device (CCD), Hybrid TDI, or complementary metal oxide semiconductor (CMOS), or pseudo TDI device.

The term “continuous area scanning,” as used herein, generally refers to area scanning in linear or non-linear paths such as rings, spirals, or arcs on a moving (e.g., rotating and/or translation) substrate using an optical imaging system and a detector. Continuous area scanning may comprise the use of an imaging array sensor capable of continuous integration over a scanning area in which the scanning is synchronized (e.g., electronically synchronized) to the image of an object in relative motion. For example, relative motion between the detector units and the substrate may refer to motion by the detector units, motion of the substrate, or both.

Continuous area scanning detectors may scan at the same rate for all image positions and therefore may not be able to operate at the correct scan rate for all imaged points in a curved (or arcuate or non-linear) scan. Therefore, the scan may be corrupted by velocity blur for imaged field points on an object moving at a velocity different than the scan velocity. Continuous rotational area scanning may comprise an optical detection system or method that makes algorithmic, optical, and/or electronic corrections to substantially compensate for this tangential velocity blur, thereby reducing this scanning aberration. In some cases, different sensors of the detector may be separately configured to compensate for differential velocity blur of separate segments of the substrate being scanned. For example, the compensation is accomplished algorithmically by using an image processing algorithm that deconvolves differential velocity blur at various image positions corresponding to different radii on a rotating substrate to compensate for differential velocity blur. In some cases, the camera or scanner may apply or use a blur to compensate for differential velocity blur.

As used herein, the term “scanning” refers to detection of signals (i.e., capturing images) during relative motion of the detector and the object. As used herein, the term “imaging” refers to processing (e.g., analyzing) or using images collected from scanning.

The terms “immersion lens” or “immersion optical lens,” as used herein, refer to an objective that is configured to be immersed or encased in a non-atmospheric environment (e.g., an immersion medium). An immersion lens typically has a higher numerical aperture (NA) than non-immersion lenses of the same magnification. A higher numerical aperture of a lens may be correlated with an increased refractive index of the immersion medium. In some cases, an immersion lens may be enclosed in an immersion jacket (e.g., to encompass immersion media).

The term “open substrate”, as used herein, generally refers to a substantially planar substrate in which a single active surface is physically accessible at any point from a direction normal to the substrate. Substantially planar may refer to planarity at a micrometer level or nanometer level. Alternatively, substantially planar may refer to planarity at less than a nanometer level or greater than a micrometer level (e.g., millimeter level). An open substrate may have a patterned or unpatterned surface. One or more analytes may be coupled to an open substrate (e.g., reparatory for processing the one or more analytes). Different processing operations on substrates (e.g., open substrates), scanning mechanisms, and optical detection systems are described in International Pub. No. WO2019/099886A1 and U.S. Ser. No. 10/852,528B1, each of which is entirely incorporated herein by reference.

The term “field of view”, as used herein, generally refers to the area on the sample or substrate that is optically mapped (or is mappable) to an active area of the detector (e.g., one or more active sensors of the detector). A field of view may be segmented into two or more regions, each of which can be electronically controlled to scan at a different rate. These scanning rates may be adjusted to the mean projected object velocity within each region. The regions may be optically defined using one or more beam splitters or one or more mirrors. The two or more regions may be directed to two or more detectors. The regions may be defined as segments of a single detector or as distinct sensors of a single detector.

As used herein, the term “focal plane” refers to any plane perpendicular to an optical axis of an optical device described herein, specifically to such a perpendicular plane comprising a focal point (e.g., a plane upon where illumination and/or emission light is focused). As used herein, the terms “object plane” or “sample plane” refer to a focal plane in or on the object being imaged. As used herein, the term “image plane” refers to a focal plane incident upon a detector. In general, an image plane is a magnification of the sample or object plane. As used herein, the term “pupil plane” generally refers to a focal plane located inside the objective of an optical device described herein. In particular, a pupil plane represents a fast Fourier transform (FFT) of the sample plane or image plane.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

As used herein, the singular forms “a,” “an,” and “the” include the plural reference unless the context clearly dictates otherwise. When a range of values is provided, it is to be understood that each intervening value between the upper and lower limit of that range, and any other stated or intervening value in that stated range is encompassed within the scope of the present disclosure. Where the stated range includes upper or lower limits, ranges excluding either of those included limits are also included in the present disclosure.

As used herein, the terms “about” and “approximately,” in reference to a number, is used herein to include numbers that fall within a range of 10%, 5%, or 1% in either direction (greater than or less than) the number unless otherwise stated or otherwise evident from the context (except where such number would exceed 100% of a possible value).

### EXAMPLES

The invention is further illustrated by the following non-limiting examples. These examples are provided for illustrative purposes only and not to limit the scope of the claims provided herein.

### Example 1

### Systems and Methods for Sequencing

The optical systems and methods described herein may be used as part of the process of sequencing nucleic acid molecules (e.g., via sequencing by synthesis) on an open substrate. It will be appreciated that these optical systems and methods may be used as part of other types of sequencing systems, and further there will be other applications beyond sequencing that may make use of these optical systems and methods (e.g., high-resolution and/or high-speed imaging).

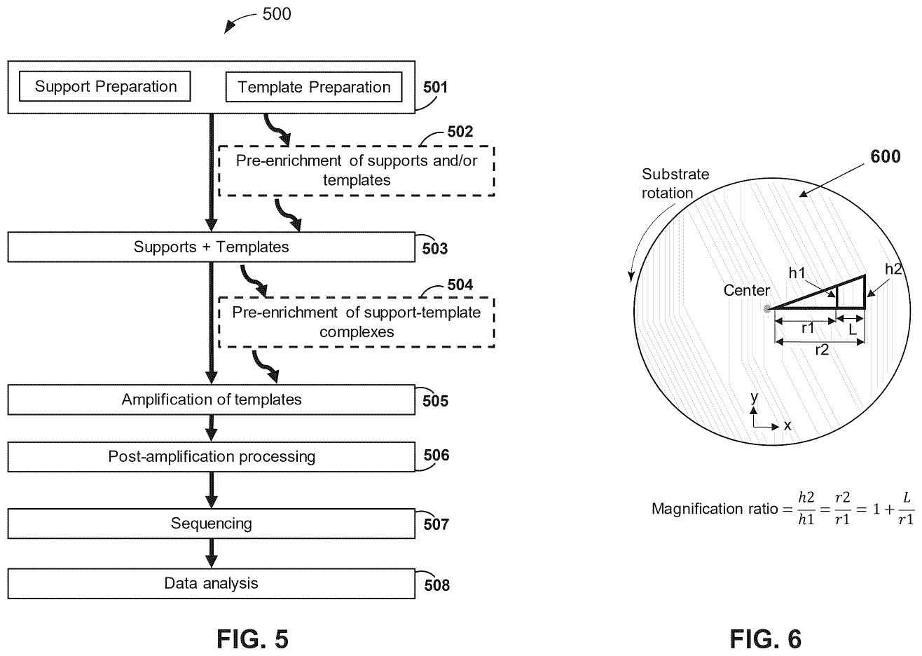

Sequencing by synthesis: FIG. 5 illustrates an example sequencing workflow 500, that may be performed in accordance with aspects of the present disclosure. Supports and/or template nucleic acids may be prepared and/or provided (501) to be compatible with downstream processing (e.g., sequencing operations 507). A support (e.g., bead) may be used to help facilitate sequencing of a template nucleic acid on a substrate. The support may help immobilize a template nucleic acid to a substrate, such as when the template nucleic acid is coupled to the support, and the support is in turn immobilized to the substrate. The support may further function as a binding entity to retain molecules of a colony of the template nucleic acid (e.g., copies comprising identical or substantially identical sequences as the template nucleic acid) together for any downstream processing. This may be particularly useful in distinguishing a colony of copies of the template nucleic acid from other colonies (e.g., on other supports) and generating sequencing signals for a plurality of template nucleic acid sequences simultaneously.

A template nucleic acid may include an insert sequence sourced from a biological sample. The template nucleic acid may further comprise an adapter sequence (e.g., for capturing by a support oligonucleotide), a primer sequence, or any other functional sequence useful for a downstream operation. Optionally, the supports and/or template nucleic acids may be pre-enriched (502). Subsequent to preparation of the supports and template nucleic acids, the two may be attached (503). A template nucleic acid may be coupled to a support via any method(s) that results in a stable association between the template nucleic acid and the support. Once attached, a plurality of support-template complexes may be generated. Optionally, support-template complexes may be pre-enriched (504), wherein a support-template complex is isolated from a mixture comprising support(s) and/or template nucleic acid(s) not attached to each other.

Subsequent to attachment of the template nucleic acid molecule to the support, the template nucleic acids may be subjected to amplification reactions (505) to generate a plurality of amplification products immobilized to the support. For example, such amplification reactions may comprise performing polymerase chain reaction (PCR), including but not limited to emulsion PCR (ePCR or emPCR), isothermal amplification (e.g., recombinase polymerase amplification (RPA)), bridge amplification, template walking, etc. Emulsion PCR methods are described in further detail in U.S. Pat. Pub. No. 2022/0042072A1 and International Pat. Pub. No. WO2022/040557A2, each of which is entirely incorporated by reference herein.

Subsequent to amplification, the supports (e.g., comprising the template nucleic acids) may be subjected to post-amplification processing (506) to enrich for positive supports (e.g., those comprising a template nucleic acid molecule). Example methods of enrichment of amplified supports are described in U.S. Pat. No. 10,900,078, U.S. Pat. Pub. No. 2021/0079464A1, and International Pat. Pub. No. WO2022/040557A2, each of which is entirely incorporated by reference herein.

Subsequent to post-amplification processing, the template nucleic acids may be subject to sequencing (507). The template nucleic acid(s) may be sequenced while attached to the support. Alternatively, the template nucleic acid molecules may be free of the support when sequenced and/or analyzed. In some instances, the template nucleic acids may be sequenced while attached to the support which is immobilized to a substrate. Examples of substrate-based sample processing systems are described elsewhere herein. Labeled nucleotides may comprise a dye, fluorophore, or quantum dot.

It will be appreciated that the combinations of termination states on the nucleotides, label types (e.g., types of dye or other detectable moiety), fraction of labeled nucleotides within a flow, type of nucleotide bases in each flow, type of nucleotide bases in each flow cycle, and/or the order of flows in a flow cycle and/or flow order, can be varied for different SBS methods. In cases where unterminated nucleotides are used, multiple nucleotides may be incorporated on a template in a single sequencing flow. In cases where terminated or reversibly terminated nucleotides are used, typically a single nucleotide may be incorporated on a template in a single sequencing flow. Different types of nucleotide bases may be flowed in any order and/or in any mixture of base types that is useful for sequencing. Various flow-based sequencing systems and methods are described in U.S. Pat. Pub. No. 2022/0170089A1, which is entirely incorporated herein by reference.

Subsequent to sequencing, the sequencing signals collected and/or generated may be subjected to data analysis (508). The sequencing signals may be processed to generate base calls and/or sequencing reads. In some cases, the sequencing reads may be processed to generate diagnostics data of the biological sample, or the subject from which it was derived.

While the sequencing workflow 500 with respect to FIG. 5 has been described with respect to the use of supports to bind template molecules, it will be appreciated that the different supports may be effectively replaced by using spatially distinct locations on one or more surfaces, which do not necessarily have to be the surfaces of individual supports (e.g., beads). For example, a first spatially distinct location on a surface may be capable of directly immobilizing a first colony of a first template nucleic acid and a second spatially distinct location on the same surface (or a different surface) may be capable of directly immobilizing a second colony of a second template nucleic acid to distinguish from the first colony. In some cases, the surface comprising the spatially distinct locations may be a surface of the substrate on which the sample is sequenced, thus streamlining the amplification-sequencing workflow.

### Example 2

### Scanning During Relative, Rotational Motion

When a sensor scans a curved path (e.g., where a rotating substrate is scanned by a stationary camera), frame rate typically will be optimized for the velocity at the center of the sensor's field of view. However, locations on the scanned surface will have a higher velocity, while locations farther from the rotational axis will have a slower velocity; thus, there may be smearing (e.g., decreased resolution) at the edges of the sensor's field of view and hence in the captured frames. One method for reducing this effect is to use relatively small image sensors to minimize the blurring, which may hinder goals to achieve simultaneous high-sensitivity and high-throughput imaging.

Wedged counter scanning: One strategy for compensating for rotational motion without reducing sensor size is to create a magnification gradient across the field-of-view of the camera's image sensor (e.g., “wedged counter scanning”). FIG. 6 illustrates this concept in a top-down view of an object (e.g., a circular substrate 600) to be imaged. During camera exposure time used to acquire an image, the substrate moves a distance h1 at radial position r1 as measured from the center of the substrate (e.g., the innermost edge of the sensor) and a distance of h2 at radial position r2 (e.g., the outermost edge of the sensor). A magnification gradient across the field-of-view of the camera is created (e.g., to reduce smearing across the field-of-view) such that the ratio of the magnification at r2 to that at r1 (magnification ratio, MR) is given by MR=h2/h1=r2/r1=1+(L/r1), where L is the field of view along the x (radial) axis. If L is 1.6 mm and r=60 mm, the ratio of magnification at r2 versus r1 is MR=1.03.

Differential triggering: Another strategy to compensate for rotational motion without modifying overall sensor size is to use a sensor that is modularized. For instance, each sensor module may be configured to scan, or to collect frames (e.g., clock or trigger), at a different rate. Several individual sensor modules, which may or may not be in a single line, can be disposed at differing radii from a rotational axis (e.g., of the sensor and/or of the surface), and each sensor module may be configured to clock at an independent rate based on its radial position from the rotational axis. That is, the trigger rate of each sensor may be correlated to the tangential velocity of the respective portion of the field of view the sensor is scanning. For example, a sensor module disposed closer to the rotational axis may be clocked slower than a module disposed farther from the rotational axis. This method can reduce blurring at both the scanning path of smallest radial distance arc path and the largest radial distance arc path.

### Example 3

### Confocal Structured Illumination (CoSI)

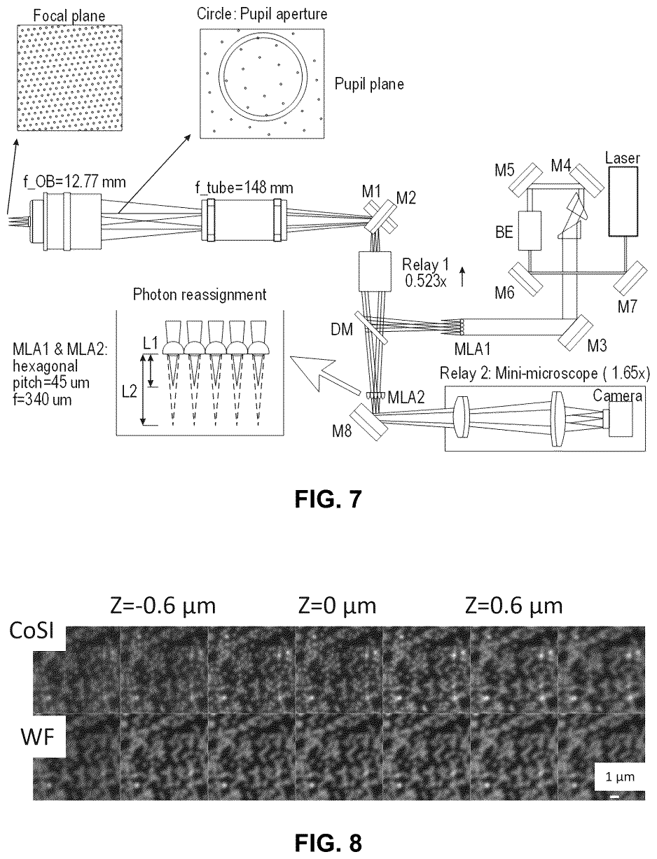

An experimental setup for CoSI is illustrated in FIG. 7 (MLA1=first microlens array; MLA2=second microlens array; M1-M8=mirrors; BE=beam expander; DM=dichroic mirror; tube=tube lens; f_tube=tube lens focal length; OB=objective; f_OB=objective focal length). Off-the-shelf MLAs were used that required the use of two relays (e.g., ‘Relay 1’ and ‘Relay 2’). In alternative schematics, these relays may be eliminated by using matched-magnification MLAs. In FIG. 7, both optical transformation elements (MLA1 and MLA2) comprise hexagonal regular arrangements of micro-lenses, with a pitch of 45 μm and a focal length of 340 μm.

This experimental setup was used to image Bangs beads (Bangs Laboratories, Inc., Fishers, IN) (e.g., fluorescent europium (III) nanoparticles) to compare CoSI imaging with wide field imaging (e.g., an otherwise identical imaging system that lacks the second optical transformation device). FIG. 8 shows example images of 0.4 μm Bangs beads obtained by CoSI (upper panel) and by wide field (WF) imaging (lower panel) at multiple z levels (e.g., distance between the focal plane of the objective and the object). The CoSI images at every z level clearly show improved resolution, even for aggregations of Bangs beads, over widefield imaging.

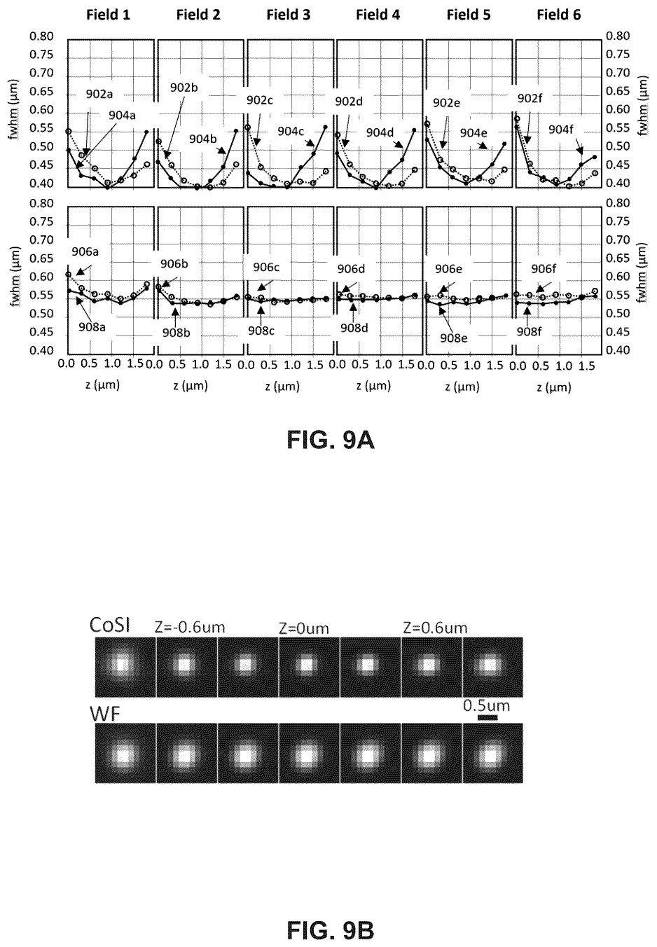

In another example, 0.2 μm Bangs beads were imaged. FIG. 9A, upper panel, provides plots of average bead signal in terms of full-width half-maximum (FWHM) as a function of z-axis offset for CoSI 902 and wide field (WF) 906 imaging systems in the scanning direction. The lower panel of FIG. 9A provides average bead FWHM values in a direction orthogonal to the scanning direction for CoSI 904 and WF 908. Each imaged field was 40 μm, the axial step size was 0.3 μm, and the lateral pixel size was 0.1366 μm. For each data point in the FIG. 9A graphs, the plotted average FWHM was determined from the FWHM of at least 100 Bangs beads. On average, CoSI improves the image resolution from 0.54 μm to 0.4 μm (1.35×) over what was achieved with a wide field imaging modality. FIG. 9B provides example images of individual Bangs beads at different z-axis heights, where z=0 microns is the most ‘in-focus’ image. FIG. 9B, upper panel, provides images obtained with CoSI imaging; FIG. 9B, lower panel, provides images obtained with WF imaging.

### Example 4

### Correcting Systematic Focus Errors

This example describes correcting systematic focus errors using static optical elements. A substrate scanning system is used to image a wafer with an imaging detector. In the images collected by the imaging detector, the focus of the wafer varies across the image such that parts of the image appear in focus and other parts appear out-of-focus. The focus variation observed in the image does not change substantially over time and is independent of the region of the wafer being imaged, so the observed focus variation is determined to be a systematic error. The systematic error is caused by curvature in the detector, curvature in the imaging light wavefront received by the detector, or both. As seen in FIG. 10, the detector and imaging light wavefront can be focused on a flat surface (top), the detector can be curved with respect to a flat imaging light wavefront (middle), or the imaging light wavefront can be curved with respect to a flat detector (bottom). An optical element is inserted into an imaging light path between the wafer and the imaging detector to correct the focus variation in the image. The optical element can be a field flattener. The field flattener corrects focus variations across the image sensor that result in parts of the image being out-of-focus, such as those instances illustrated in FIG. 10 (middle and bottom).

The optical element can be a microlens array. As shown in FIG. 11A, the microlens array is made up of lenslets of differing focal lengths, that bring each portion of the wavefront passing through the microlens into focus at the desired axial position. The focal lengths of the lenslets are selected such that the curvature applied to the wavefront by the microlens array compensates for a curvature of the wavefront, a curvature of the detector, or both.

The optical element can be a microlens array combined with a field flattener, as shown in FIG. 11B. In this instance, the lenslets of the microlens array have the same focal length or differing focal lengths. The field flattener and the lenslets are selected such that the curvature applied to the wavefront by the combined microlens array and field flattener compensates for a curvature of the wavefront, a curvature of the detector, or both.

The optical element can be a bent mirror. As shown in FIG. 12A, a mirror positioned in the imaging light path is bent by applying force to the mirror. The imaging light wavefront is curved upon reflecting off of the bent mirror (e.g., reflected at the bent mirror or reflected by the bent mirror). The mirror is bent such that the curvature applied to the wavefront by the bent mirror compensates for a curvature of the wavefront, a curvature of the detector, or both.

The optical element can be a gradient index window. A gradient index window is made of a transparent material, such as glass, and has an index of refraction that varies across the window. As shown in FIG. 12B, the refractive index gradient, indicated by the color gradient, can be radially symmetric. The imaging light wavefront is curved upon passing through the gradient index window. The index gradient of the gradient index window is selected such that the curvature applied to the wavefront by the gradient index window compensates for a curvature of the wavefront, a curvature of the detector, or both.

### Example 5

### Autofocus Systems for Detecting Substrate Tilt

An autofocus system may be used for detecting (and correcting for) substrate tilt. An exemplary autofocus system uses an infrared light emitting diode (LED) as a focus illumination source 110. The infrared light emitted by the LED follows a focus light path 112 (shown with dark shading) and illuminates a region of a surface 105 (e.g., a planar sample, a substrate supporting a sample, or a wafer). The surface reflects the infrared light, and the reflected light follows a reflected light path 114 (shown with striped shading) to a focus detector 120 positioned to measure the tilt of the substrate. The autofocus system is part of a scanning system for scanning the substrate.

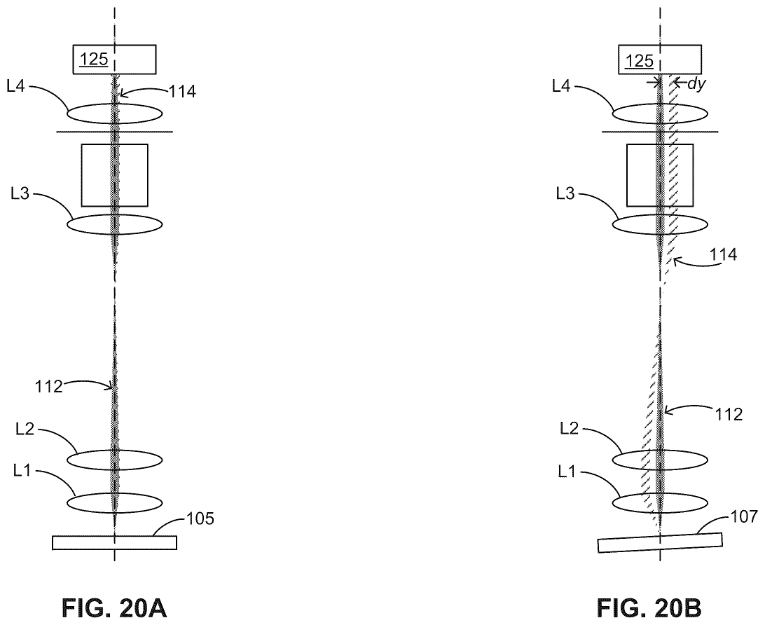

In a first configuration, shown in FIG. 20A and FIG. 20B, a single focus detector 120 is positioned at a focal plane of a lens. The reflected light path 114 passes through a series of lenses (L1, L2, L3, and L4) to the focus detector 125. The position at which the reflected light encounters the focus detector depends on the tilt of the substrate relative to an object plane of the scanning system. In the system illustrated in FIG. 20A, the substrate is parallel to the object plane, and the reflected light encounters the focus detector at a reference position, such as near the center of the sensor. Upon tilting the substrate relative to the object plane, as illustrated in FIG. 20B, the reflected light is shifted laterally (e.g., by distance dy) compared to the reference position in FIG. 20A.

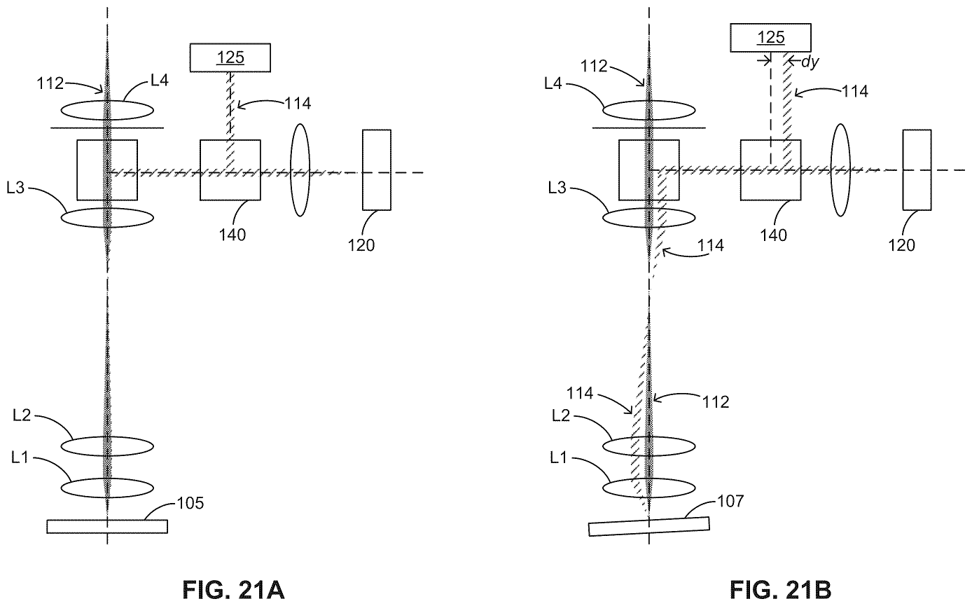

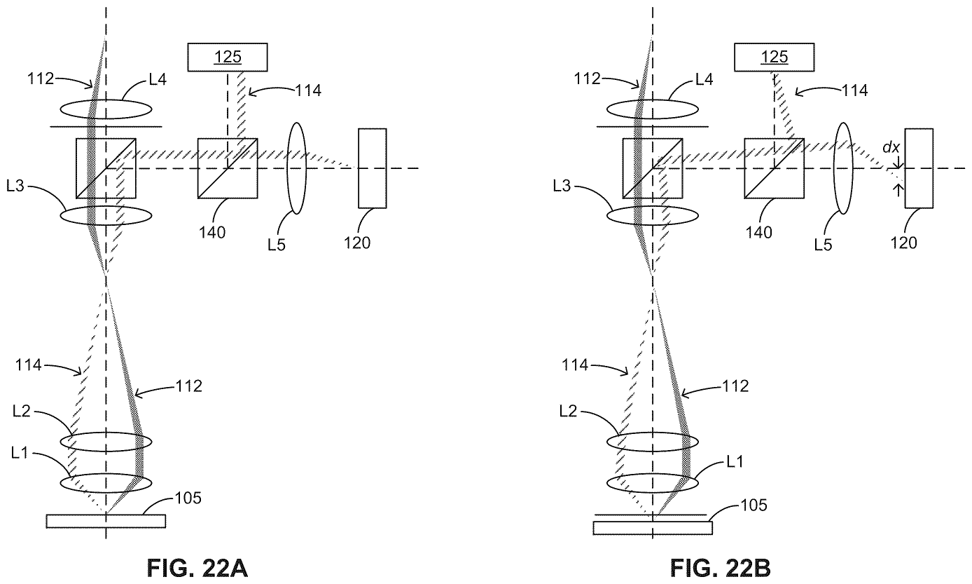

In a second configuration, shown in FIG. 21A-FIG. 22B, two focus detectors, a first focus detector 120 and a second focus detector 125, are used to detect substrate height and tilt, respectively. A beam splitter 140 splits the reflected light, directing it to both the tilt focus detector 120, positioned in an infinite conjugate plane of the scanning system, and the height focus detector 125, positioned in a conjugate focal plane of the scanning system. The position at which the reflected light encounters the tilt detector depends on the tilt of the substrate relative to an object plane of the scanning system, and the position at which the reflected light encounters the height detector depends on the height of the substrate relative to the object plane. In FIG. 21A, the substrate is parallel to the object plane, and the reflected light encounters the tilt detector at a reference position, such as near the center of the sensor. Upon tilting the substrate relative to the object plane, as illustrated in FIG. 21B, the reflected light is shifted laterally (e.g., by a distance dy) on the tilt detector 125 compared to the reference position in FIG. 21A. The position of the reflected light on the height detector 120 does not move in this case because the height of the substrate where the illumination encounters the substrate is unchanged. In FIG. 22A, when the substrate is positioned at the object plane of the scanning system, the reflected light encounters the height detector 120 at a reference position, such as near the center of the sensor. Upon shifting the substrate up or down relative to the object plane, as illustrated in FIG. 22B, the reflected light is shifted laterally (e.g., by a distance dx) on the height detector 120 compared to the reference position in FIG. 22A. The position of the reflected light on the tilt detector 125 does not move in this case because the substrate remains flat at the location where illumination encounters the substrate.

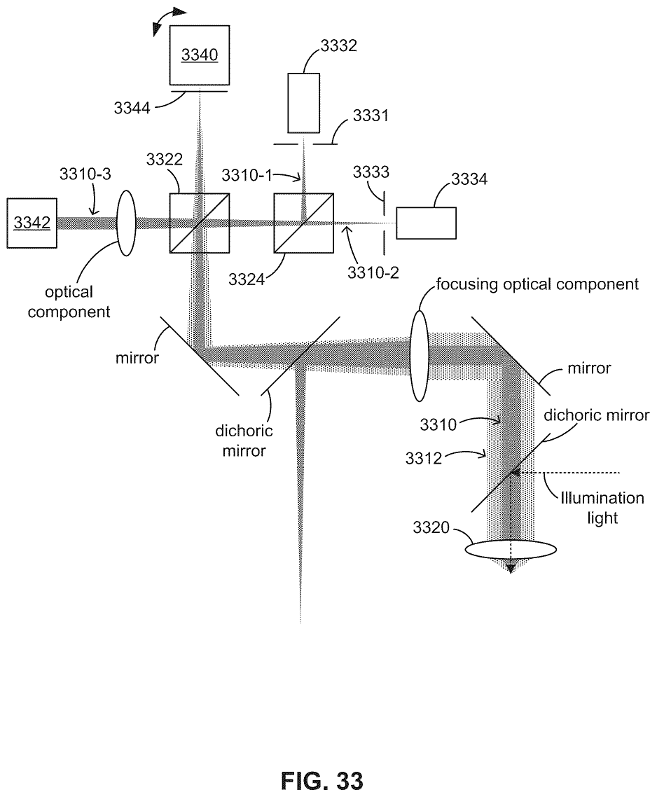

An example of a substrate scanning system with an autofocus system to detect substrate tilt is shown in FIG. 33. Autofocus illumination 3310 (shown as a dark shaded beam) is directed through an objective to the substrate. In this configuration, the autofocus illumination is collimated at the pupil plane of the objective, providing simple alignment of on-axis autofocus illumination. The autofocus illumination is reflected back through the objective 3320 to a wavelength-selective beam splitter 3322, which transmits emission light 3312 (shown as a light shaded beam) from the substrate and reflects a portion of the autofocus illumination 3310. The reflected portion of the autofocus illumination passes through a beam splitter 3324 which splits the autofocus illumination 3310 and sends one portion 3310-1 through a first pinhole 3331 to a first photodiode 3332 and the other portion 3310-2 through a second pinhole 3333 to a second photodiode 3334. The two photodiode and pinhole pairs (e.g., a first pair of confocal pinhole 3331 and photodiode 3332, and a second pair of confocal pinhole 3333 and photodiode 3334) are configured to detect changes in z-position of the substrate. The transmitted portion 3310-3 of the autofocus illumination from the wavelength-selective beam splitter is reflected off of a filter 3344 (e.g., reflected by the filter 3344 or reflected by the filter 3344) in front of the imaging detector 3340 and is directed to a quadrant detector 3342. The quadrant detector 3342 is configured to detect changes in tilt angle of the substrate.

### Example 6

### Astigmatic Autofocus System for Detecting Substrate Height

An astigmatic autofocus system can be used for detecting substrate height. An exemplary autofocus system to detect substrate height, as illustrated in FIG. 14, uses an infrared light emitting diode (LED) as a focus illumination source 110. The infrared light emitted by the LED follows a focus light path 112 and illuminates a region of a surface 105 (e.g., a planar sample, a substrate supporting a sample, or a wafer). The substrate reflects the infrared light, and the reflected light follows a reflected light path 114 to a quadrant detector 1401 positioned after a focus lens 150 to measure the height of the substrate. The autofocus system is part of a scanning system for scanning the substrate.

The quadrant detector and focus lens are positioned such that the shape of the reflected light on the quadrant detector depends on the height of the substrate relative to the object plane of the scanning system. As shown in FIG. 14, when the substrate is positioned below the object plane the shape of the reflected light is elongated into quadrats A and D of the detector, as seen at 1410 and 1412. When the substrate is in focus, the reflected light is evenly distributed between the four quadrants of the detector, as seen at 1414. When the substrate is positioned above the object plane, the shape of the reflected light is elongated into quadrats B and C of the detector, as seen at 1416 and 1418.

The defocus distance can be quantified from an intensity ratio (F) of the intensities measured by each of the four quadrants (A, B, C, D). The intensity ratio is calculated as follows:

$$F = \frac{( A + D ) - ( B + C )}{( A + D ) + ( B + C )}$$

The intensity ratio (F) is then used to determine the defocus distance according to the function plotted in FIG. 23. The height of the substrate is adjusted based on the determined defocus distance so that the substrate is in focus.

### Example 7

### Substrate Mapping for Predictive Focus Correction

A substrate may be mapped to enable predictive focus correction. A circular substrate supporting a sample to be scanned is positioned on a scanning system. The scanning system includes an objective positioned with the object plane of the scanning system at or near the surface of the substrate such that a magnified image of a region of the substrate surface is projected onto an imaging detector and one or more focus detectors. The scanning system also includes an autofocus system with an infrared illumination source that illuminates the substrate through the objective and one or more focus detectors. The autofocus system is any of the autofocus systems described in EXAMPLE 5 or EXAMPLE 6.

Once positioned on the scanning system, the substrate is rotated in the plane of the substrate surface about a central axis normal to the substrate surface. While rotating, the substrate surface moves relative to the objective so that the region of the substrate surface that is projected onto the detectors changes while rotating, thereby scanning the substrate. The objective moves inward toward the rotational axis during the scan in order to scan different radial distances of the substrate. The substrate undergoes a mapping scan to generate a map of the substrate surface. During the mapping scan, substrate height, substrate tilt, or both are measured at different regions of the substrate using the autofocus system. A map of the substrate including substrate height values, substrate tilt values, or both at corresponding locations on the substrate, such as the map shown in FIG. 24, is generated. FIG. 24 illustrates a map of substrate generated by scanning the substrate using a focus detection system. The color heat map represents height variations across the substrate surface. The slope of the height variations across the substrate surface can then be used to create a tilt map across the substrate. Since the substrate is not perfectly flat, the height and tilt of the substrate differ at different regions on the substrate.

The substrate map is used to predictively correct the focus of the substrate during an imaging scan. The substrate is rotated during the imaging scan, and the focus position of the substrate is adjusted according to the height or tilt provided in the substrate map for the substrate region corresponding region of the substrate being imaged.

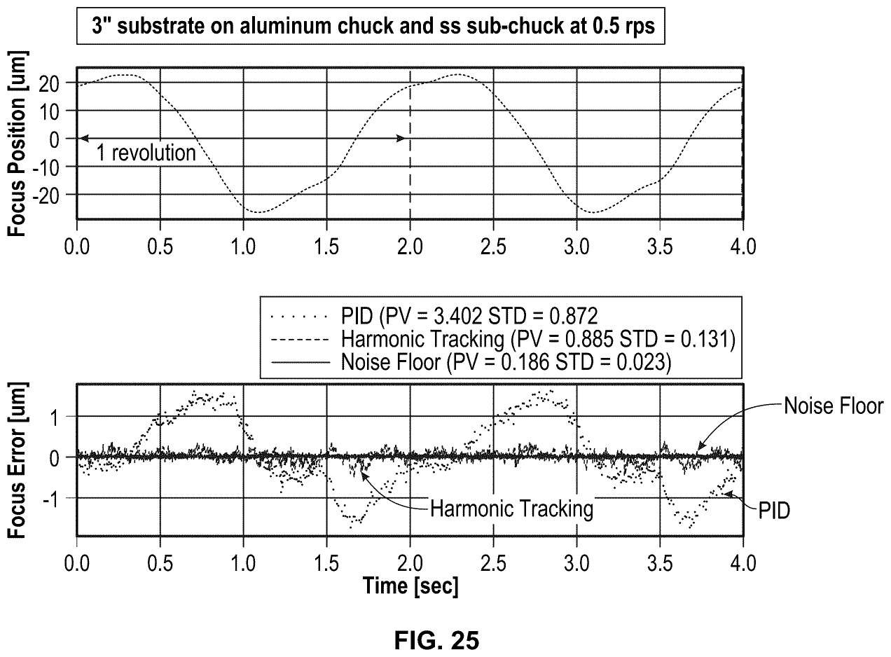

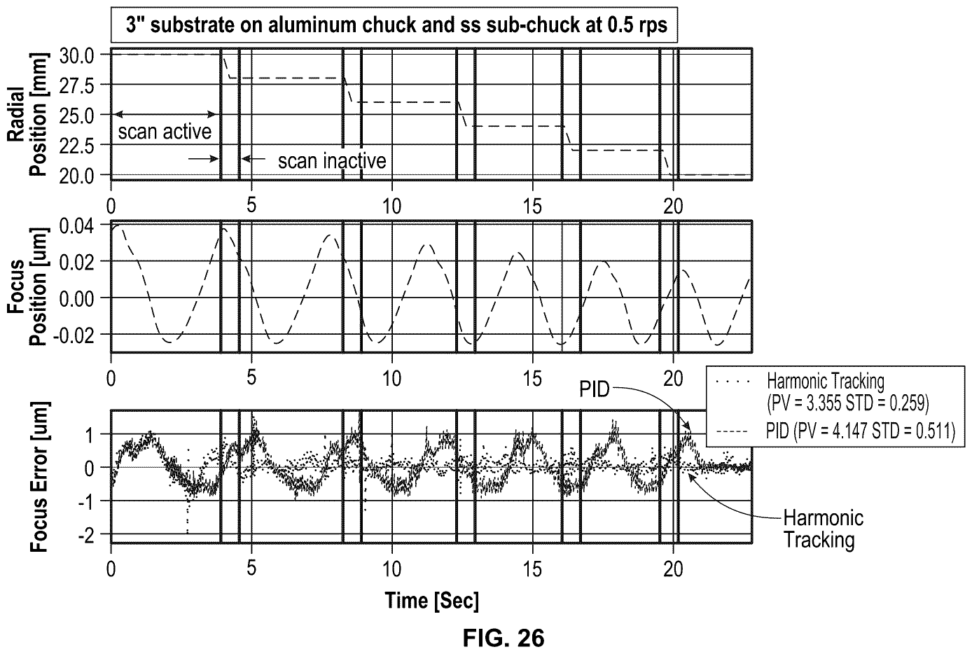

An example of substrate focus position during a scan is provided in FIG. 25. The focus position of the substrate (top panel) changes as the substrate is rotated at 0.5 revolutions per second (RPS). A proportional-integral-derivative (PID) controller is used to control the substrate height based on the substrate map. The residual focus error following correction is also shown (bottom panel). Another example of substrate focus position during a scan is provided in FIG. 26. During the scan, the objective moves radially inward to scan the substrate, as seen by the radial position (top panel). The focus position of the substrate (middle panel) changes as the substrate is rotated at 0.5 revolutions per second (RPS) and as the objective moves radially inward. The residual focus error following correction is also shown (bottom panel).

### Example 8

### Dynamic Focus Compensation

Dynamic focus compensation can be performed during substrate scanning. A circular substrate supporting a sample to be scanned is positioned on a scanning system. The scanning system includes an objective positioned with the object plane of the scanning system at or near the surface of the substrate such that a magnified image of a region of the substrate surface is projected onto an imaging detector and one or more focus detectors. The scanning system also includes an autofocus system with an infrared illumination source that illuminates the substrate through the objective and one or more focus detectors. The autofocus system is any of the autofocus systems described in EXAMPLE 5 or EXAMPLE 6.

As the substrate is scanned, an autofocus system, such as an autofocus system described in EXAMPLE 5 or EXAMPLE 6, is used to detect the position the substrate relative to the object plane of the scanning system, or a map generated as described in EXAMPLE 7 is used to predict the position the substrate relative to the object plane of the scanning system, or both. The focus of the substrate is dynamically adjusted while scanning based on the measured substrate position so that the substrate stays in focus on the imaging detector while scanning. Focus adjustment is performed by moving an element or combination of elements in the imaging light path such that the object plane of the scanning system coincides with the substrate surface and the substrate is in focus on the imaging detector.

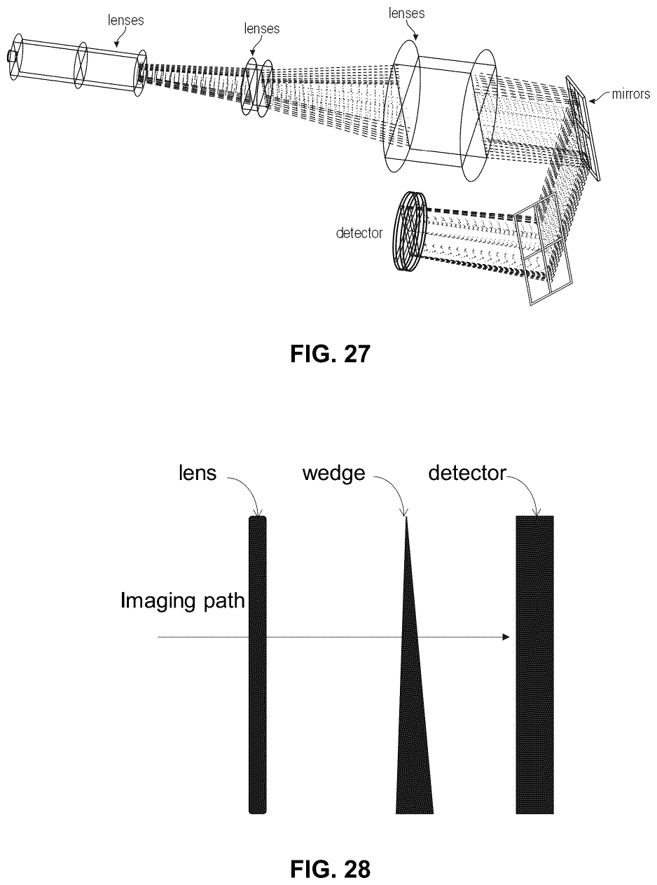

Substrate height errors are corrected by shifting an element along the imaging light path, illustrated in FIG. 27. In some configurations, the height of a stage (z-stage) supporting the substrate is adjusted to change the height of the substrate relative to the objective. In some configurations, the height of the objective is adjusted to change the height of the objective relative to the substrate. In some configurations, the imaging detector is moved parallel to the imaging light path, changing the effective height of the object plane relative to the substrate. In some configurations, a lens is moved parallel to the imaging light path, changing the effective height of the object plane relative to the substrate. In some configurations, a mirror is moved parallel to the imaging light path, altering the length of the imaging light path and changing the effective height of the object plane relative to the substrate. In some configurations, a wedge is positioned in the imaging light path, as shown in FIG. 28. The wedge has a constant refractive index, that bends the light path different amounts depending on where the light passes through the wedge. Rotating the wedge about the optical axis (e.g., the Z-axis) changes the amount of variation in the length of imaging light path, altering the effective height of the object plane relative to the substrate to compensate for tilt.

Substrate tilt errors are corrected by rotating, shifting, or bending an element in the imaging light path, illustrated in FIG. 27. In some configurations, the tilt angle of a stage supporting the substrate is adjusted to change the tilt angle of the substrate relative to the object plane of the scanning system. In some configurations, the imaging detector is tilted relative to the imaging light path, changing the effective tilt angle of the object plane relative to the substrate, as illustrated in FIG. 17. In some configurations, a lens is tilted relative to the imaging light path, changing the effective tilt angle of the object plane relative to the substrate. In some configurations, a mirror or a combination of mirrors, such as the mirrors illustrated in FIG. 27, are tilted, shifted, or both in the imaging light path, changing the effective tilt angle of the object plane relative to the substrate.

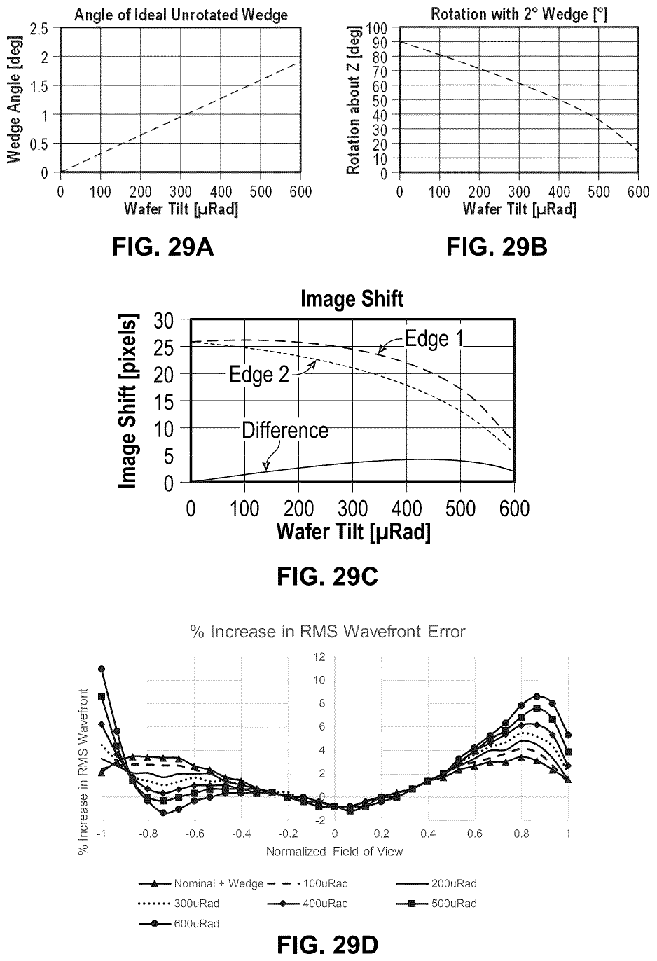

In some configurations, a wedge is positioned in the imaging light path, as shown in FIG. 28. The wedge has a constant refractive index, that when rotated (e.g., rotated in a plane perpendicular to the imaging path), changes the optical path length along the imaging field of view. The effect of wedge rotation to compensate for substrate tilt is illustrated in FIG. 29A-FIG. 29D. FIG. 29A illustrates the ideal wedge angle (in degrees) needed to compensate for a given substrate tilt angle (in micro Radians). As shown in FIG. 29B, changes in effective angle along the field of view can be achieved by rotating a wedge with a fixed angle (e.g., a 2° wedge) in the light path, providing an effect similar to changing the wedge angle. Rotating the wedge results in a small amount of image shift on the imaging detector, as shown in FIG. 29C. The image performance, measured by the percentage increase in the root mean square (RMS) wavefront error across the image field of view, is maintained with the wedge in place (Nominal+wedge) and at different substrate tilt angles (100 μRad, 200 μRad, 300 μRad, 400 μRad, 500 μRad, or 600 μRad) compared to the system without the wedge (Nominal), as shown in FIG. 29D.

A focus tracking control system, as illustrated in FIG. 30, is used to control the focus of the substrate. The control system uses a feedback loop to detect the height of the substrate relative to the objective, determine the amount of correction needed, correct the focus, re-measure the substrate relative to the objective, iterating until the substrate is in focus. The control system includes an inner control loop (focus control sub-system) to linearize the z-stage for substrate height control and an outer control look to generate a substrate height trajectory. In the outer loop, an autofocus sensor senses the height of the substrate and the objective height. The substrate height and objective height are used to determine a focus error, which is provided to the focus controller. The focus controller determines a new position based on the focus error and provides a command to the stage controller to adjust the position of the stage to the new position. The controller instructs the linear motor of the stage to move the stage in the z-direction. The position of the stage is detected by the stage controller to determine if the stage is at the desired position.

A first example of an autofocus system with closed loop focus detection is shown in FIG. 34A. The optical elements are configured as described with reference to FIG. 33. This system provides on-axis autofocus detection and correction, which provides simple alignment. Sensitivity may be adjusted by adjusting the size of the pinholes (“Confocal pinhole 1” or “Confocal pinhole 2”) positioned in front of the photodiodes. The defocus detection module of the system illustrated in FIG. 32A includes two channels. Each channel has a confocal pinhole and a detector behind it. Two confocal pinholes are above and below the plane that is conjugate to the focal plane, respectively. When the difference between two channels is zero, the substrate is on focus. If there is a defocus, one channel has a bigger signal. A tilt angle of the substrate is detected by the quadrant detector. The tilt angle of the substrate is corrected by the angular position of the imaging detector (“TDI camera”) relative to the optical path. The filter in front of the camera reflects the autofocus illumination and rotates with the camera, so that the angle of incidence of the reflected autofocus illumination on the quadrant detector depends on the angle of the optical path relative to the imaging detector. The filter and the imaging detector pivot about a point located at the detector sensor, which introduces an x-y shift and angle change of the autofocus illumination reflected by the filter. A lens positioned the autofocus light path in front of the quadrant detector removes the x-y shift component and leaves tilt angle information, enabling the quadrant detector to measure tilt angle of the substrate independent of x-y shifts.

A second example of an autofocus system with closed loop focus detection is shown in FIG. 34B. This system provides off-axis autofocus detection and correction. This system implements two quadrant detectors, one quadrant detector for z-position detection 3990 and a second quadrant detector 3992 for tilt angle detection. Quadrant detector 3990 is configured to detect the global defocus (e.g., the center of the field of view), while the quadrant detector 3992 is configured to measure the tilt angle of the object plane, corresponding to the tilt angle of the substrate, with respect to the camera. The filter in front of the camera allows the imaging light to pass through while reflecting the autofocus illumination. The filter rotates with the camera, providing closed-loop detection of tilt angle.

### Example 9

### Line-Scan Camera Multi-Clocking

This example describes line-scan camera multi-clocking. A circular substrate supporting a sample to be scanned is positioned on a scanning system. The substrate is rotated about a central rotational axis normal to the substrate surface, and a line-scan camera is used to image a substrate while it is rotating. The line-scan camera images a radially oriented, elongated region of the substrate, as illustrated in FIG. 18C. Matching a clock rate of the line-scan camera to a linear velocity of the substrate surface produces a clear image. However, the linear velocity of the substrate relative to the line-scan camera depends on the radial distance from the axis of rotation and varies across the elongated region imaged by the line-scan camera. To compensate for the differences in linear velocity across the elongated region, the pixel rows of the line-scan camera are operated at different clock rates. Pixel rows imaging portions of the elongated region located farther from the rotation axis are operated at faster clock rates to compensate for the faster linear velocity of these parts of the region, and pixel rows imaging portions of the elongated region located closer to the rotation axis are operated at slower clock rates. As the substrate is scanned, the elongated region being imaged moves radially, and the clock rates are adjusted to compensate for the resulting differences in linear velocity.

Here are some example implementations:
(A1) In one aspect, an optical system comprises: (a) an objective lens in optical communication with a surface, (b) a focus illumination source positioned to emit a focus light through the objective lens to a region on the surface, (c) the surface positioned to reflect the focus light as a reflected light along a reflected light path through the objective lens, (d) a focus detector in optical communication with a region of the surface, (e) an actuator configured to move the surface, and (f) one or more processors operatively coupled to the actuator and the focus detector. The one or more processors are individually or collectively configured to: i) direct the actuator to rotate the surface about a rotational axis substantially normal to the surface such that the region in optical communication with the focus detector moves across the surface while the surface is rotating, ii) based at least in part on signals received from the focus detector, determine a z-distance of the surface at the region relative to an object plane of the optical system, a tilt angle of the surface at the region relative to the object plane, or both the z-distance and the tilt angle, and iii) generate a map of the surface comprising z-distance variations, tilt angle variations, or both.
(A2) The optical system of A1, where the focus detector is positioned in an i) in an infinite conjugate plane of the optical system for determining the tilt angle of the surface, and ii) in a conjugate plane of the optical system for determining the z-distance of the surface.
(A3) The optical system of any of A1 and A2, where a location at which the reflected light encounters the focus detector is a function of the tilt angle of the surface relative to an object plane of the optical system.
(A4) The optical system of any of A1-A3, where the focus detector comprises a wavefront error detector, a camera, a photodiode, or a combination thereof.
(A5) The optical system of any of A1-A4, where the optical system is configured to adjust the object plane to coincide with the z-distance of the surface at a corresponding region of the surface, the tilt angle of the surface at the corresponding region of the surface, or both as the corresponding region is being imaged.
(A6) The optical system of any of A1-A5, further comprising an imaging detector in optical communication with the surface along an imaging light path. The imaging detector is positioned at a plane conjugate to the object plane.
(A7) The optical system of A6, where the imaging detector is configured to move relative to the imaging light path to correct for the z-distance, the tilt angle, or both.
(A8) The optical system of any of A6 and A7, further comprising a mirror positioned in the imaging light path, The mirror is configured to move relative to the imaging light path to correct for the z-distance, the tilt angle, or both.
(A9) The optical system of any of A1-A8, where location at which the reflected light encounters the focus detector is a function of the tilt angle of the surface relative to an object plane of the optical system.
(A10) The optical system of any of A1-A9, where the focus detector is positioned such that the location at which the reflected light encounters the focus detector is displaced by at least 1.5 μm per 100 μRad change in the tilt angle.
(A1 l) The optical system of any of A1-A9, where the focus detector is positioned such that the location at which the reflected light encounters the focus detector is displaced by at least 2 μm per 100 μRad change in the tilt angle.
(A12) The optical system of any of A1-A9, where the focus detector is positioned such that the location at which the reflected light encounters the focus detector is displaced by at least 2.5 μm per 100 μRad change in the tilt angle.
(A13) The optical system of any of A1-A12, further comprising a focus beam splitter, a focus lens, and a second focus detector. The focus beam splitter is positioned in the reflected light path between the objective lens and the focus detector, and the focus beam splitter is positioned to split the reflected light into the reflected light path directed to the focus detector and a split reflected light path directed to a second focus detector. The focus lens is positioned in the split reflected light path between the focus beam splitter and the second focus detector. The second focus detector is positioned in the split reflected light path at a focal plane of the focus lens.
(A14) The optical system of A13, where a position at which the split reflected light path encounters the second focus detector is a function of a z-distance between the surface and the object plane at the region of the surface illuminated by the focus light.
(A15) The optical system of any of A1-A14, further comprising a second focus illumination source positioned to illuminate a second region of the surface with a second focus light through the objective lens, or an illumination beam splitter positioned to split the focus light into a first focus light and a second focus light. The first focus light illuminates the region of the surface, and the second focus light illuminates the second region of the surface. The focus detector is positioned in the second reflected light path to receive the second reflected light. The focus detector is positioned at a focal plane of a focus lens. A first location at which the reflected light encounters the focus detector is a function of a first z-distance from the region to an object plane of the optical system. A second location at which the second reflected light encounters the focus detector is a function of a second z-distance from the second region to the object plane. A distance between the first location and the second location is a function of the tilt angle.
(A16) The optical system of A15, where the illumination beam splitter is a polarizing beam splitter selected from the group consisting of a polarizing beam splitter cube, a Wollaston prism, and a birefringent wedge.
(A17) The optical system of any of A15-A16, where the focus light path and the second focus light path are angled relative to one another.
(A18) The optical system of any of A15-A17, further comprising the focus lens positioned in the reflected light path and the second reflected light path between the objective lens and the focus detector. The focus detector is positioned at a focal plane of the focus lens. The focus detector is a quadrant detector comprising a first quadrant, a second quadrant, a third quadrant, and a fourth quadrant. The optical system further comprises a cylindrical optical element positioned in a focus light path of the focus light between the objective lens and the focus illumination source or in the reflected light path between the objective lens and the focus lens. The relative intensities of the reflected light respectively detected by the first quadrant, the second quadrant, the third quadrant, and the fourth quadrant are functions of a z-distance between the surface and an object plane of the optical system at the region.
(A19) The optical system of any of A1-A18, where the optical system further comprises a rotational stage positioned to support the surface and rotate the surface about a rotational axis normal to the surface.
(A20) The optical system of any of A1-A19, further comprising an excitation light source positioned to illuminate the surface with excitation light.
(A21) The optical system of any of A1-A20, further comprising an imaging detector positioned at a conjugate object plane of the optical system, wherein the imaging detector is configured to image the surface by collecting imaging light following an imaging light path from the surface, through the objective lens, to the imaging detector.
(A22) The optical system of A21, where the imaging detector is positioned to image the surface while the surface is rotating.
(A23) The optical system of A22, where the imaging detector is configured to move relative to the imaging light path to correct for a focus variation detected by the focus detector.
(A24) The optical system of A23, where the focus variation is the tilt angle, the z-distance, or both.
(A25) The optical system of A24, further comprising a mirror positioned in the imaging path. The mirror is configured to move relative to the imaging light path to correct for a focus variation detected by the focus detector.
(B1) A method of detecting a tilt angle of a surface comprises providing an optical system that comprises an objective lens, a focus illumination source, and a focus detector positioned in an infinite conjugate plane of the optical system. The method further comprises: (a) positioning the surface in the optical system in a focus light path, (b) illuminating a region of the surface with a focus light emitted by the focus illumination source along the focus light path through the objective lens to the region, (c) producing a reflected light by reflecting the focus light off of the region of the surface along a reflected light path through the objective lens to the focus detector, (d) detecting the reflected light with the focus detector, (e) determining a position of the reflected light on the focus detector, wherein the position is a function of the tilt angle of the surface relative to an object plane of the optical system, and (f) determining the tilt angle of the surface relative to an object plane of the optical system based on the position of the reflected light on the focus detector.
(B2) The method of B1, where the optical system further comprises a focus beam splitter, a focus lens, and a second focus detector positioned at a focal plane of the focus lens. The method further comprises splitting the reflected light with the focus beam splitter into the reflected light and a split reflected light. The split reflected light is directed along split reflected light path through the focus lens. The method also further comprises detecting the split reflected light with the second focus detector and determining a z-distance of the surface relative to the object plane based on the position of the split reflected light on the second focus detector.
(B3) The method of B2, where the position of the split reflected light on the focus detector moves in response to a change in the z-distance of the surface relative to the object plane.
(B4) The method of any of B1-B3, where the position of the reflected light on the focus detector moves in response to a change in the tilt angle of the surface relative to the object plane.
(C1) A method of detecting tilt angle of a surface comprises providing an optical system that comprises an objective lens, a focus illumination source, a focus lens, and a focus detector positioned at a focal plane of the focus lens. The method comprises (a) positioning the surface in the optical system in a focus light path and a second focus light path, (b) illuminating a region of the surface with a focus light emitted by the focus illumination source along the focus light path through the objective lens to the region, (c) producing a reflected light by reflecting the focus light off of the region of the surface along a reflected light path through the objective lens to the focus detector, (d) detecting the reflected light with the focus detector, and (e) determining a first position of the reflected light on the focus detector. The first position is a function of a first z-distance of the surface at the region relative to an object plane of the optical system. The method further comprises (f) illuminating a second region of the surface with a second focus light along the second focus light path through the objective lens to the second region, (g) producing a second reflected light by reflecting the second focus light off of the second region of the surface along a reflected light path through the objective lens to the focus detector, (h) detecting the second reflected light with the focus detector, and (i) determining a second position of the second reflected light on the focus detector. The second position is a function of a second z-distance of the surface at the second focus relative to the object plane. The method further comprises (j) determining the tilt angle of the surface relative to the object plane based on the first position and the second position.
(C2) The method of any of B1-B4 or C1, further comprising correcting the tilt angle by adjusting the object plane to coincide with the tilt angle of the surface.
(D1) A method of detecting z-position of a surface comprises providing an optical system that comprises an objective lens, a focus illumination source, a cylindrical optical element, a focus lens, and a focus detector positioned at a focal plane of the focus lens. The focus detector is a quadrant detector comprising a first quadrant, a second quadrant, a third quadrant, and a fourth quadrant. The method further comprises: (a) positioning the surface in the optical system in a focus light path, (b) illuminating a focus of the surface with a focus light emitted by the focus illumination source along the focus light path through the objective lens to the focus, (c) producing a reflected light by reflecting the focus light off of the focus of the surface along a reflected light path through the objective lens to the focus detector, (d) introducing an astigmatism to the focus light or the reflected with the cylindrical optical element, (e) detecting the reflected light with the focus detector, and (f) determining relative intensities of the reflected light on the first quadrant, the second quadrant, the third quadrant, and the fourth quadrant. The relative intensities are a function of a z-distance of the surface relative to an object plane of the optical system.
(D2) The method of D1, where relative intensities of the reflected light detected by the first quadrant, the second quadrant, the third quadrant, and the fourth quadrant change in response to a change in a z-distance of the surface relative to an object plane of the optical system.
(D3) The method of any of C1-C4, D1, and D2, where the method further comprises correcting the z-distance, the first z-distance, or the second z-distance by adjusting the object plane to coincide with the z-distance, the first z-distance, or the second z-distance of the surface.
(D3) The method of any of C4 and D3, where adjusting the object plane comprises moving an element positioned an imaging path from the surface to an imaging detector of the optical system.
(D4) The method of D3, where the element is the imaging detector.
(D5) The method of D3, where the element is the surface.
(D6) The method of D3, where the element is a mirror.
(D7) The method of D6, further comprising bending the element to adjust the object plane to coincide with the tilt angle of the surface.
(D8) The method of D3, where the element is a lens.
(D9) The method of D7, where the lens is the objective lens.
(D10) The method of D3, where the element is a wedge.
(D11) The method of D3, where the element comprises an index of refraction gradient.
(D12) The method of D3-D111, further comprising tilting the element relative to the imaging path to adjust the object plane to coincide with the tilt angle of the surface.
(D13) The method of D3-D12, further comprising rotating the element relative to the imaging path to adjust the object plane to coincide with the tilt angle of the surface.
(D14) The method of D3-D13, further comprising translating the element relative to the imaging path to adjust the object plane to coincide with the tilt angle of the surface.
(E1) A method of focusing a scanning system on a surface comprises: (a) providing a surface to the scanning system, (b) determining a z-distance of the surface at a region of the surface relative to an object plane of the scanning system, a tilt angle of the surface at the region relative to the object plane, or both the z-distance and the tilt angle, and (c) adjusting the object plane to coincide with the z-distance of the surface from the object plane, the tilt angle of the surface, or both the z-distance and the tilt angle by moving an element positioned in an imaging path from the surface to an imaging detector of the scanning system.
(E2) The method of E1, where the element is the imaging detector.
(E3) The method of E1, where the element is the surface.
(E4) The method of E1, where the element is a mirror.
(E5) The method of E4, further comprising bending the element to adjust the object plane to coincide with the z-distance of the surface, the tilt angle of the surface, or both.
(E6) The method of E1, where the element is a lens.
(E7) The method of E6, where the lens is an objective lens.
(E8) The method of E1, where the element is a wedge.
(E9) The method of E1, where the element comprises an index of refraction gradient.
(E10) The method of any of E1-E9, further comprising moving the element along the imaging path to adjust the object plane to coincide with the z-distance of the surface.
(E11) The method of any of E1-E10, further comprising tilting the element relative to the imaging path to adjust the object plane to coincide with the tilt angle of the surface.
(E12) The method of any of E1-E11, further comprising rotating the element relative to the imaging path to adjust the object plane to coincide with the z-distance of the surface, the tilt angle of the surface, or both.
(E13) The method of any of E1-E12, further comprising translating the element relative to the imaging path to adjust the object plane to coincide with the z-distance of the surface, the tilt angle of the surface, or both.
(E14) The method of any of E1-E3, further comprising generating a map of the surface. Generating the map comprises determining variations in the z-distance across the surface, variations in the tilt angle across the surface, or both. The map comprises z-distance values across the surface, tilt angle values across the surface, or both z-distance values and tilt angle values.
(E15) The method of any of E1-E14, where determining the z-distance, the tilt angle, or both comprises illuminating the region with a focus light emitted from a focus illumination source.
(E16) The method of E15, where determining the z-distance, the tilt angle, or both further comprises reflecting the focus light off the surface as a reflected light along a reflected light path to a focus detector.
(E17) The method of E16, where determining the z-distance, the tilt angle, or both further comprises determining a position of the reflected light on the focus detector, an intensity of the reflected light on the focus detector, or a shape of the reflected light on the focus detector, or a combination thereof. The position, the intensity, the shape, or the combination thereof is a function of the z-distance, the tilt angle, or both.
(E18) The method of any of claims E1-E17, further comprising illuminating the region of the surface with an excitation light emitted by an excitation light source and imaging the surface with the imaging detector by detecting an imaging light directed from the surface along the imaging path. The imaging light comprises fluorescence emission stimulated by the excitation light.
(E19) The method of any of E1-E20, where the surface is rotating during the imaging.
(F1) A method of scanning a surface comprises providing a scanning system that comprises an objective lens, an imaging detector, and a focus detector in optical communication with a region of the surface. The method further comprises: (a) positioning the surface in the scanning system, (b) rotating the surface about a rotational axis normal to the surface such that the region in optical communication with the focus detector moves across the surface while the surface is rotating, (c) determining a z-distance of the surface at the region relative to an object plane of the scanning system, a tilt angle of the surface at the region relative to the object plane, or both the z-distance and the tilt angle using the focus detector, (d) correlating the z-distance, the tilt angle, or both to a region on the surface, (e) generating a map of z-distance variations, tilt angle variations, or both, corresponding to regions across the surface, and (f) imaging the surface with the imaging detector while the surface is rotating, thereby scanning the surface.
(F2) The method of F1, where the scanning system comprises the optical system of any of A1-A31.
(F3) The method of F1, where the focus detector is a wavefront error detector.
(F4) The method of any of F1-F2, further comprising dynamically adjusting the object plane to coincide with the z-distance of the surface at a corresponding region of the surface, the tilt angle of the surface at the corresponding region of the surface, or both as the corresponding region is being imaged.
(F5) The method of F4, where dynamically adjusting the object plane comprises moving an element positioned an imaging path from the surface to an imaging detector.
(F6) The method of F4, where the element is the imaging detector.
(F7) The method of F4, where the element is the surface.
(F8) The method of F4, wherein the element is a mirror.
(F9) The method of F8, further comprising bending the element to adjust the object plane to coincide with the z-distance of the surface, the tilt angle of the surface, or both.
(F10) The method of F4, where the element is a lens.
(F11) The method of F4, where the element is a wedge.
(F12) The method of F11, where the element comprises an index of refraction gradient.
(F13) The method of any of F5-F12, further comprising moving the element along the imaging path to adjust the object plane to coincide with the z-distance of the surface.
(F14) The method of any of F5-F13, further comprising tilting the element relative to the imaging path to adjust the object plane to coincide with the tilt angle of the surface.
(F15) The method of any of F5-F14, further comprising rotating the element relative to the imaging path to adjust the object plane to coincide with the z-distance of the surface, the tilt angle of the surface, or both.
(F16) The method of any of F5-F15, further comprising translating the element relative to the imaging path to adjust the object plane to coincide with the z-distance of the surface, the tilt angle of the surface, or both.
(G1) A scanning system for scanning a surface comprises: (a) a rotational stage positioned to hold the surface and rotate the surface about a rotational axis normal to the surface, (b) objective lens positioned to magnify the surface, (c) imaging detector positioned to image the surface through the objective lens, (d) and imaging optics positioned to direct imaging light along an imaging path from the surface to the imaging detector. The imaging optics comprise an element positioned to distort a wavefront comprising the imaging light.
(G2) The scanning system of G1, where the element bends the wavefront.
(G3) The scanning system of any of G1 and G2, where the element changes a focus of the imaging light.
(G4) The scanning system of G3, where the focus is changed non-uniformly across the wavefront.
(G5) The scanning system of any of G1-G4, where a shape of the wavefront after the element matches a shape of the imaging detector.
(G6) The scanning system of any of G1-G5, where the element comprises a bent mirror.
(G7) The scanning system of any of G1-G6, where the element comprises a gradient index window.
(G8) The scanning system of any of G1-G7, where the element comprises a microlens array.
(G9) The scanning system of any of G1-G8, where the element comprises a field flattener.
(H1) A method of imaging a surface comprises providing a scanning system that comprises an objective lens and an imaging detector. The imaging detector is a line-scan detector comprising a first row of pixels and a second row of pixels. The method further comprises: (a) positioning the surface on the scanning system in an imaging light path from the surface to the imaging detector, and (b) imaging an elongated region of the surface through the objective lens with the imaging detector. The elongated region comprises a first region positioned at a first radius relative to a rotational axis normal to the surface and a second region positioned at a second radius relative to the rotational axis. The method further comprises (c) rotating the surface about the rotational axis such that the elongated region moves across the surface while the surface is rotating. The first region moves at a first linear velocity relative to the surface, and the second region moves at a second linear velocity relative to the surface. The method further comprises: (d) matching a first trigger rate of the first row of pixels to the first linear velocity, (e) matching a second trigger rate of the second row of pixels to the second linear velocity, (f) detecting the first region with the first row of pixels, and (g) detecting the second region with the second row of pixels, thereby imaging the elongated region with the imaging detector.
(H3) The method of H1, where the first radius is longer than the second radius, the first linear velocity is faster than the second linear velocity, and the first trigger rate is faster than the second trigger rate.
(I1) A method for focus tracking comprises providing a surface that is configured to rotate with respect to an objective lens. The surface is substantially planar. The method further comprises: (b) providing a light beam through the objective lens to illuminate a region of the surface, and (c) during rotation of the surface, directing light reflected from the region of the surface to (i) a detector through a lens and (ii) an incident location on a sensor. The reflected light is directed to the sensor in the absence of traveling through the lens. The method further comprises (d) determining, from the incident location of the reflected light on the sensor, an amount of tilt of the surface with respect to the objective lens.
(I2) The method of I1, where the providing (b) further comprises splitting the light beam into a first light beam and a second light beam. The first light beam illuminates a first region of the surface, and the second light beam illuminates a second region of the surface, wherein the first and second regions do not overlap.
(I3) The method of I2, where: (i) the first light beam enters the objective lens at an angle that is rotated X degrees from an axis of the objective lens, wherein X is greater than 0, and (ii) the second light beam enters the objective lens at an angle that is rotated Y degrees from the axis of the objective lens, wherein Y is less than 0.

(I4) The method of I3, where the absolute value of X is the same as the absolute value of Y.
(I5) The method of any of I2-I4, where the directing (c) further comprises directing light reflected from the first region of the surface and light reflected from the second region of the surface to a first incident location and a second incident location, respectively, on the sensor. The determining (d) further comprises determining an amount of tilt of the surface from the difference between the first incident location and the second incident location.
(J1) A method of surface scanning comprises (a) providing a surface that is configured to rotate with respect to an objective lens. The surface is substantially planar. The method further comprises (b) while rotating the surface, providing a light beam through the objective lens to illuminate the surface. At a first time point, the light beam illuminates a first region of the surface, and at a second time point, the light beam illuminates a second region of the surface. The method further comprises (c) determining, for each of the first and second time points: i) a respective z-distance of the respective region relative to a focal plane of the objective lens and ii) a respective tilt angle of the respective region relative to the focal plane.
(J2) The method of J1, where the determining (c) comprises comparing characteristics of light reflected from the respective region of the surface to reference characteristics.
(J3) The method of any of J1 or J2, further comprising providing a map of z-distances and tilt angles for the surface.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. An optical system, comprising:
an objective lens in optical communication with a surface;
a focus illumination source positioned to emit a focus light through the objective lens to a region on the surface;
the surface positioned to reflect the focus light as a reflected light along a reflected light path through the objective lens; and
a focus detector in optical communication with a region of the surface, wherein the focus detector is positioned in the reflected light path to receive the reflected light;
an actuator configured to move the surface; and
one or more processors operatively coupled to the actuator and the focus detector, individually or collectively configured to (i) direct the actuator to rotate the surface about a rotational axis substantially normal to the surface such that the region in optical communication with the focus detector moves across the surface while the surface is rotating, (ii) based at least in part on signals received from the focus detector, determine a z-distance of the surface at the region relative to an object plane of the optical system, a tilt angle of the surface at the region relative to the object plane, or both the z-distance and the tilt angle, and (iii) generate a map of the surface comprising z-distance variations, tilt angle variations, or both.

2. The optical system of claim 1, wherein the focus detector is positioned in an i) in an infinite conjugate plane of the optical system for determining the tilt angle of the surface, and ii) in a conjugate plane of the optical system for determining the z-distance of the surface.

3. The optical system of claim 1, wherein a location at which the reflected light encounters the focus detector is a function of the tilt angle of the surface relative to an object plane of the optical system.

4. The optical system of claim 1, wherein the focus detector comprises a wavefront error detector, a camera, a photodiode, or a combination thereof.

5. The optical system of claim 1, wherein the optical system is configured to adjust the object plane to coincide with the z-distance of the surface at a corresponding region of the surface, the tilt angle of the surface at the corresponding region of the surface, or both as the corresponding region is being imaged.

6. The optical system of claim 1, further comprising an imaging detector in optical communication with the surface along an imaging light path, wherein the imaging detector is positioned at a plane conjugate to the object plane.

7. The optical system of claim 6, wherein the imaging detector is configured to move relative to the imaging light path to correct for the z-distance, the tilt angle, or both.

8. The optical system of claim 6, further comprising a mirror positioned in the imaging light path, wherein the mirror is configured to move relative to the imaging light path to correct for the z-distance, the tilt angle, or both.

9. The optical system of claim 1, wherein a location at which the reflected light encounters the focus detector is a function of the z-distance of the surface relative to an object plane of the optical system.

10. The optical system of claim 3, wherein the focus detector is positioned such that the location at which the reflected light encounters the focus detector is displaced by at least 1.5 μm per 100 μRad change in the tilt angle.

11. The optical system of claim 3, wherein the focus detector is positioned such that the location at which the reflected light encounters the focus detector is displaced by at least 2 μm per 100 μRad change in the tilt angle.

12. The optical system of claim 3, wherein the focus detector is positioned such that the location at which the reflected light encounters the focus detector is displaced by at least 2.5 μm per 100 μRad change in the tilt angle.

13. The optical system of claim 1, further comprising:
a focus beam splitter, wherein the focus beam splitter is positioned in the reflected light path between the objective lens and the focus detector, and wherein the focus beam splitter is positioned to split the reflected light into the reflected light path directed to the focus detector and a split reflected light path directed to a second focus detector;
a focus lens positioned in the split reflected light path between the focus beam splitter and the second focus detector; and
the second focus detector positioned in the split reflected light path at a focal plane of the focus lens.

14. The optical system of claim 13, wherein a position at which the split reflected light path encounters the second focus detector is a function of a z-distance between the surface and the object plane at the region of the surface illuminated by the focus light.

15-18. (canceled)

19. The optical system of claim 1, further comprising a rotational stage positioned to support the surface and rotate the surface about a rotational axis normal to the surface.

20. The optical system of claim 1, further comprising an excitation light source positioned to illuminate the surface with excitation light.

21. The optical system of claim 1, further comprising an imaging detector positioned at a conjugate object plane of the optical system, wherein the imaging detector is configured to image the surface by collecting imaging light following an imaging light path from the surface, through the objective lens, to the imaging detector.

22. The optical system of claim 21, wherein the imaging detector is positioned to image the surface while the surface is rotating.

23. The optical system of claim 22, wherein the imaging detector is configured to move relative to the imaging light path to correct for a focus variation detected by the focus detector.

24. The optical system of claim 23, wherein the focus variation is the tilt angle, the z-distance, or both.

25. The optical system of claim 23, further comprising a mirror positioned in the imaging light path, wherein the mirror is configured to move relative to the imaging light path to correct for a focus variation detected by the focus detector.

26-100. (canceled)
